(19) United States
(12) Patent Application Publication
(10) Pub. No.: US 2026/0037808 A1
(43) Pub. Date: Feb. 5, 2026

(54) ARTIFICIAL NEURAL NETWORK WITH DYNAMIC TRANSFER LEARNING CAPABILITY AND OPTOGENETIC IMPLEMENTATION

(71) Applicant: UVic Industry Partnerships Inc., Victoria (CA)

(72) Inventors: Brosnan Yuen, Victoria (CA); Xiaodai Dong, Victoria (CA); Tao Lu, Victoria (CA)

(73) Assignee: UVic Industry Partnerships Inc., Victoria (CA)

(21) Appl. No.: 19/288,943

(22) Filed: Aug. 1, 2025

Related U.S. Application Data
(60) Provisional application No. 63/679,029, filed on Aug. 2, 2024.

(51) Int. Cl. G06N 3/082; G06N 3/084

(52) U.S. Cl. CPC G06N 3/082; G06N 3/084

(57) ABSTRACT

Training large neural networks on big datasets requires significant computational resources and time. Transfer learning reduces training time by pre-training a base model on one dataset and transferring the knowledge to a new model for another dataset; while current choices of transfer learning algorithms are limited, biological neural networks (BNNs) are adept at rearranging themselves to tackle completely different problems using transfer learning. Taking advantage of BNNs, an artificial neural network (ANN) with dynamic transfer learning capability is transferable to any other network architecture and can accommodate many datasets. The ANN includes artificial neurons and artificial glial cells distributed within an N-dimensional space; connections are formed between pairs of artificial neurons that meet certain criteria. In an optogenetics implementation, machine learning models such as the disclosed ANN are implemented on real BNNs to decrease power consumption.

### CROSS-REFERENCE TO RELATED APPLICATION

This application claims the benefit of U.S. Provisional Application No. 63/679,029, filed Aug. 2, 2024, entitled “3D RAY TRACED BIOLOGICAL NEURAL NETWORK LEARNING MODEL,” which application is incorporated herein by reference in its entirety for all purposes.

### FIELD

The field generally relates to artificial neural networks that mimic biological neural networks.

### BACKGROUND

With the growing scale of modem datasets and the increasing complexity of neural network architectures, training neural networks often demands significant computational resources and time. Transfer learning reduces training time by pre-training a base model on one dataset and transferring the knowledge to a new model for another dataset. By reusing pretrained weights, advantages such as faster convergence, lower data requirements, and the ability to deploy functional models on less powerful hardware can be achieved. Transfer learning has demonstrated success across domains such as image classification and natural language processing, where shared representations help address differences between datasets and objectives.

Despite these advantages, many transfer learning approaches impose rigid structural constraints on the models involved. For example, when the input or output dimensions of a new dataset differ from those of the base model, layers are often added, removed, or reinitialized frequently discarding pretrained weights that could otherwise be retained. Moreover, numerous frameworks rely on fixed blocks or module patterns, limiting the flexibility to reshape architectures without significant manual effort. Activation functions and layer interfaces are often static, requiring extensive retraining to adapt to new data characteristics. As a result, current solutions are not well-suited for transferring knowledge across datasets of varying sizes, dimensions, and complexities.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIGS. 1a-e illustrate an overview of an example artificial neural network.

FIGS. 2a-f illustrate characterization of an example artificial neural network.

FIGS. 3a-f illustrate comparisons of various algorithms on the Alcala Tutorial 2017 dataset with tenfold testing.

FIGS. 4a-f illustrate the evolution of an example artificial neural network on the Alcala Tutorial 2017 dataset with tenfold testing.

FIGS. 5a-c illustrate example transfer learning algorithms executed on the EEG dataset using fifty-fourfold testing and motor imagery.

FIGS. 6a-f provide a visualization of an example raytracing method.

FIG. 7 illustrates an example system using optogenetics for activating neurons with red light and inhibiting neurons with blue light, with calcium imaging for detecting neuronal activity.

FIG. 8 illustrates an example optogenetics hardware setup using neurons, a fluorescence activation light source, a pixel array, a fluorescence filter, and a camera.

FIG. 9 illustrates an example graph of the number of neuron activations versus pulse width and irradiance.

FIG. 10 illustrates an example graph of the number of neuron activations versus energy.

FIG. 11 illustrates an example graph of the signal to noise ratio of activation versus pulse width and irradiance.

FIG. 12 is a block diagram of an example computing system implementing an artificial neural network.

FIG. 13 is a flowchart of an example computer-implemented method for implementing an ANN.

FIG. 14 is a flowchart of an example computer-implemented method for performing transfer learning using an ANN.

FIG. 15 is a flowchart of an example method for training live biological neurons to emulate the behavior of a machine learning model.

FIGS. 16a-b illustrate fluorescence microscopy images captured using a commercial microscope and the disclosed optogenetics hardware setup.

FIG. 17 is a block diagram of an example computing system in which described embodiments can be implemented.

### DETAILED DESCRIPTION

### I. Introduction

In artificial neural networks (ANNs), many models are trained for a narrow task using a specific dataset. They face difficulties in solving problems that include dynamic input/output data types and changing objective functions. Whenever the input/output tensor dimension or the data type is modified, the machine learning models need to be rebuilt and subsequently retrained from scratch. Furthermore, many machine learning algorithms that are trained for a specific objective, such as classification, may perform poorly at other tasks, such as reinforcement learning or quantification.

Even if the input/output dimensions and the objective functions remain constant, the algorithms do not generalize well across different datasets. For example, a neural network trained on classifying cats and dogs does not perform well on classifying humans and horses despite both of the datasets having the exact same image input. Moreover, neural networks are highly susceptible to adversarial attacks. A small deviation from the training dataset, such as changing one pixel, could cause the neural network to have significantly worse performance. This problem is known as the generalization problem, and the field of transfer learning can help to solve it.

Transfer learning solves the problems presented above by allowing knowledge transfer from one neural network to another. A common way to use supervised transfer learning is obtaining a large pre-trained neural network and retraining it for a different but closely related problem. This significantly reduces training time and allows the model to be trained on a less powerful computer. Many researchers used pre-trained neural networks such as ResNet-5011 and retrained them to classify malicious software. Another application of transfer learning is tackling the generalization problem, where the testing dataset is completely different from the training dataset. For example, every human has unique electroencephalography (EEG) signals due to them having distinctive brain structures. Transfer learning solves the generalization problem by pretraining on a general population EEG dataset and retraining the model for a specific patient.

As a result, the neural network is dynamically tailored for a specific person and can interpret their specific EEG signals properly. Labeling large datasets by hand is tedious and time-consuming. In semi-supervised transfer learning, either the source dataset or the target dataset is unlabeled. That way, the neural networks can self-learn which pieces of information to extract and process without many labels.

For comparing the advantages and disadvantages of the related works, Supplementary Table 1 in the Supplementary Material Section S.2 below showcases the features of each research article. Among them are transfer learning with neural AutoML, two-stage evolutionary neural architecture search, and a self-adaptive mutation neural architecture search algorithm based on blocks. Most of the neural evolution algorithms in the literature use discrete blocks or layers to construct networks. Architectures using discrete blocks are highly restrictive because only a select few layers are compatible with the existing layers. If the optimal architecture uses blocks that are incompatible with the current blocks, then the current network cannot be transferred into the optimal architecture. Moreover, when the input/output dimension changes, the input/output layer is deleted and replaced with a new layer that matches the new dimensions. Deleting old layers impedes transfer learning because the old weights are not transferred to the new network. This increases training time as the new layers are trained from scratch.

On the other hand, biology-inspired ANNs take advantage of neuron positions to generate new neural connections and offer far more flexibility in solving unseen problems/datasets. In place of having separable discrete layers and organized connections, NeuCube arranges neurons in a cube lattice and randomly creates neural connections based on relative neuron distances. Neurons close together have a higher probability of forming new connections, while neurons further apart have a lower probability. Moreover, the algorithm also generates long-distance connections, which reduces the degree of separation between any two neurons and improves performance. Going further, HyperNEAT and DES-HyperNEAT use both absolute and relative neuron positions to determine neural connectivity and the overall architecture. For every combination of two neurons, their three-dimensional (3D) positions are fed into a CPPN that predicts the values of the weights. The flexible connectivity enables HyperNEAT to handle changing input and output dimensions, while also growing and shrinking hidden neurons at will. However, NeuCube and HyperNEAT do not support the ability to join and merge multiple neural networks together. This prohibits the ability to scale to very large neural networks by joining multiple smaller neural networks together. Furthermore, those implementations do not support sparse matrices, which deliver the same performance but with less training time and memory usage in very large networks. Moreover, their activation functions are fixed and are not flexible enough to suit different datasets. Incorporating neuroplasticity mechanisms from real BNNs could solve these problems.

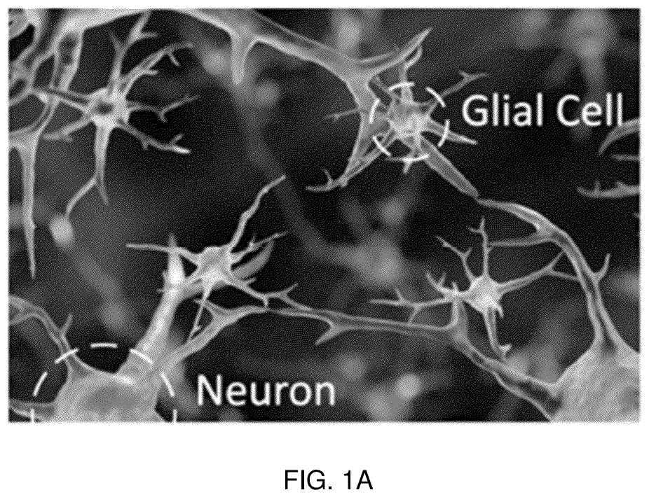

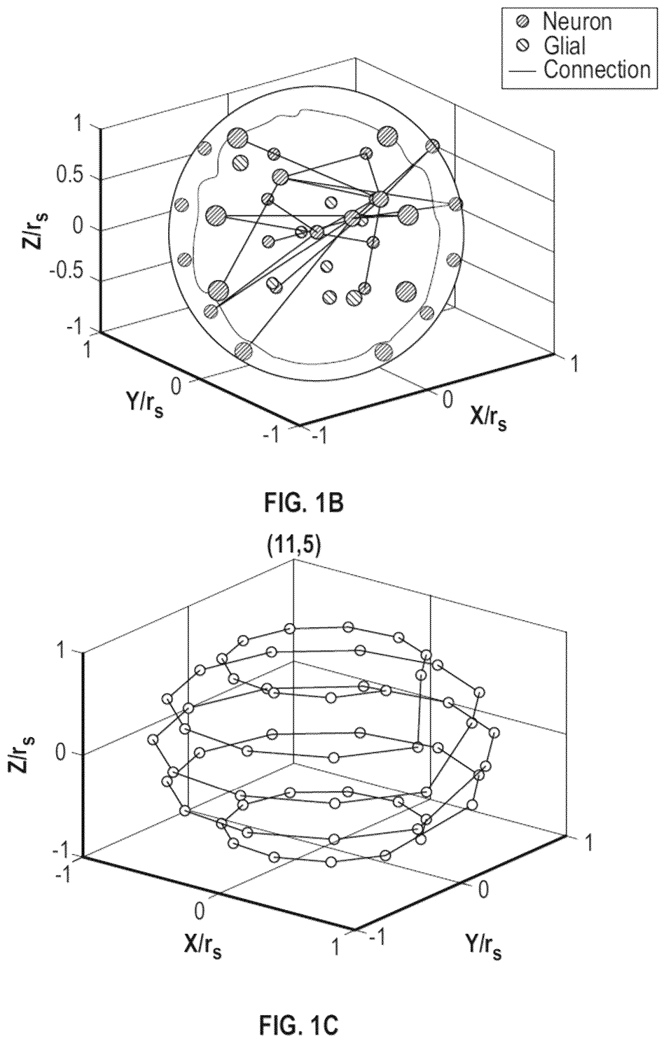

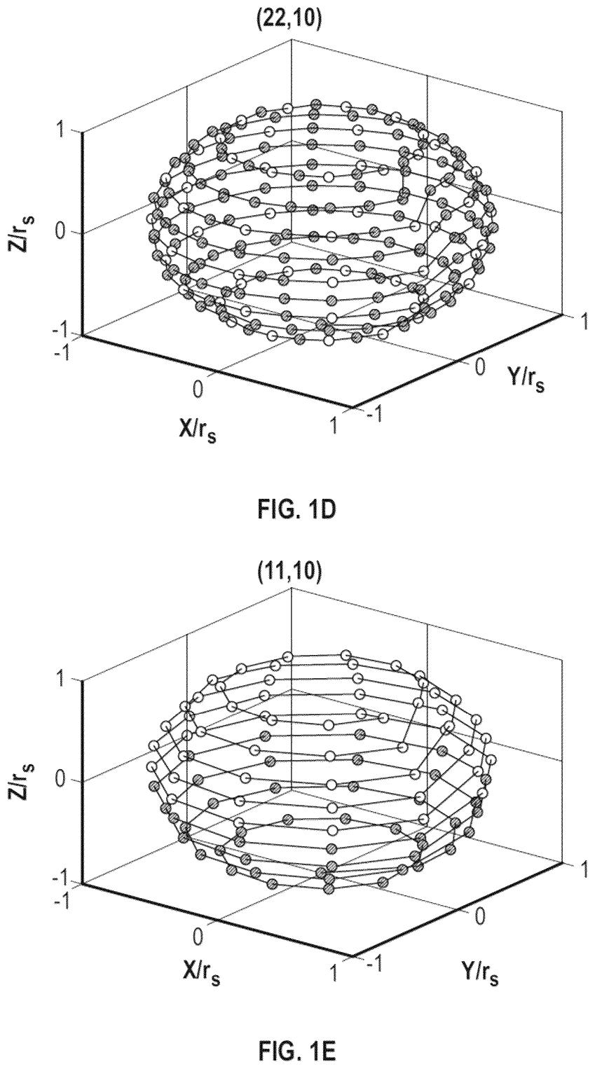

Real BNNs consist of two primary classes of cells: glial cells and neurons. Neurons are made out of axons, axon branches, synapses, dendrites, and soma. As an example, FIG. 1a shows a typical central nervous system. The red, blue, and green colors correspond to glial cells, neurons, and axons, respectively, where the axons carry electrical and neurotransmitter signals from one neuron to another. Each neuron only has one axon, but it can split into multiple axon branches, which allows the neurons to output neurotransmitters and electrical signals to multiple neurons. In order to form a new neural connection, the axon branches move towards neurotransmitters emitted by other neurons until it connects to a dendrite. Afterward, the axon can send signals through the synapses on the dendrites to reach the somas of the other neurons. However, glial cells or dead neurons could block the paths of axons, preventing them from attaching to other dendrites. The cell body of the neuron is called the soma, and it collects the net charge of the neurotransmitters and electrical signals from the dendrites. If the soma's voltage exceeds a threshold, the soma fires a pulse exiting from the axon. The main purpose of the glial cells is to insulate neurons from each other and the extracellular fluid. This prevents signals from leaking into the extracellular fluid or firing unintended neurons. A more detailed explanation is provided below in the Supplementary Material Section S.1.

### II. Overview of Disclosed Technologies

Biological neural networks (BNNs) are adept at rearranging themselves to tackle completely different problems using transfer learning. Taking advantage of BNNs, technologies are described herein for designing and implementing dynamic ANN that is transferable to any other network architecture and can accommodate many datasets. This approach uses raytracing to connect neurons in an N-dimensional space, allowing the network to grow into any shape or size.

The technologies described herein include a method for designing a dynamic neural network that mimics a BNN by using raytracing to connect neurons in a N-dimensional space which allows the network to grow into any shape or size, be transferable to any other network architecture, and accommodate many datasets. The method includes creating a virtual N-dimensional space (e.g., a 3D neural network sphere) containing two types of uniformly distributed cells (hidden neurons and glial cells) with randomly assigned positions and then removing any intersecting cells. In biology, neurons transmit signals to one or multiple other neurons and glial cells insulate neurons from each other and block non line of sight connections. The method can further include assigning output neurons to the center of the N-dimensional space and assigning input neurons at the surface of the N-dimensional space while maintaining input feature order, keeping them equally spaced apart, and having them occupy the same solid angle to be able to connect to hidden neurons without bias. New unidirectional neural connections are then raytraced between neurons that have line-of-sight using the positions and radii of cells. In some examples, the neural connections in the network are encoded into a sparse weighted adjacency matrix which enables the neural network to transform into any architecture without needing to resize the matrix.

In some examples, a multiple input multiple output version of the universal activation function can be deployed to every neuron to enable the activation functions to evolve during knowledge transfers.

The initial neural network can be trained with a forward pass that uses the weighted adjacency matrix to calculate the neural network's output, a backward pass that produces the gradient of the weights, and a gradient descent algorithm that optimizes the parameters of the neural network.

The neural network can be applied to transfer learning. Towards this end, the neural network can be transferred to any arbitrary architecture, and potential changes in the size or dimensions of the dataset can be dealt with by removing unused neurons and connections and adding new neurons before raytracing new connections. In particular, different scenarios can be handled as follows.

If the model is transferred to a new dataset with increased dimensions, then input and output neurons are added. In an example where the N-dimensional space is a 3D sphere, if the number of hidden neurons and glial cells also needs to increase to accommodate increased complexity of the dataset, the network sphere radius is increased to retain a low cell collision rate, the old cells are relocated to the new network sphere while keeping polar and azimuthal angles fixed, and the new cells are added to the expanded sphere.

If the model is transferred to a new dataset with densified input dimensions, new neurons are evenly inserted in-between old neurons while preserving old connections and without having to move old neurons.

If the model is transferred to a new dataset that requires fewer neurons and connections, neural connections are deleted with a bias towards those having the smallest absolute valued weights, some neural connections are redistributed across other neurons, and unused neurons are removed to improve efficiency and accuracy.

If the model is transferred to a new dataset that concatenates the old dataset, old neurons are migrated to the north of the network sphere with connections to hidden neurons retained and new neurons are added to the south of the new network sphere without changing data order.

The technologies described herein further include techniques and apparatus for implementing a BNN that emulates the behavior of an ANN using optogenetics. For example, the technologies described herein include a system (e.g., machine) incorporating optogenetics that can be used to train biological neurons for use in machine learning models. The system can include biological neurons tagged with optogenetic adeno-associated viruses (AAVs) to control neuron firing, and biosensor AAVs or fluorescent dyes to produce fluorescence in response to neurons firing based on the level of ions (e.g., Calcium(2+) (Ca2+) ions, or other ions). Biosensor AAVs produce fluorescence (e.g., green fluorescence) in response to the binding of ions; a similar effect can alternatively be achieved using fluorescent dyes.

The system can further include a pixel array, a fluorescence activation light source, a band pass filter, and a high-speed camera. The pixel array can be configured to shine light of a first wavelength (e.g., red) to promote excitatory response from the neurons and light of a second wavelength (e.g., blue) to inhibit response from the neurons. The fluorescence activation light source can be configured to constantly illuminate the entire neural network so that the activation light can be absorbed by biosensor AAVs or fluorescent dyes and re-emitted as fluorescence (e.g., green fluorescence) which can be observed by a high-speed camera. For example, a green band pass fluorescence emission filter can be placed in front of the high-speed camera to block the activation light, first, and second wavelengths of light, only allowing fluorescent green light to pass through and reducing the signal-to-noise ratio of camera images. The fluorescence activation light source can be a UV light source with an activation filter, or a source of another type of light that activates fluorescence. Additionally, a dichroic mirror that reflects the activation light toward the sample and transmits the fluorescent light toward the microscope can also be deployed. As shown, the dichroic mirror can be arranged at a 45° angle relative to the path of light from the pixel array. The high-speed camera can be placed behind the fluorescence filter to observe the fluorescence produced by neurons firing.

As another example, the technologies described herein include a method that uses optogenetics to train biological neurons for use in machine learning models to perform a variety of tasks. The method can include calibrating the high-speed camera by determining its viewport position, rotation, and scale by reading the position of multiple ArUco markers with unique evenly spaced positions on a 2D grid displayed by the pixel array, and calculating its lens distortion using the edges of the checkerboard image displayed by the pixel array.

The method can further include detecting the position of the biological neurons and their axons using the high-speed camera, training an ANN in a simulation, and optimizing the weights of the ANN so that they can be transferred to the BNN and used as targeted output for the BNN.

In the example, the ANN weights can be translated (e.g., transferred) to the BNN by illuminating equivalent neurons in the BNN that correspond to positive weights in the ANN with photons of a first wavelength (e.g., red), and illuminating equivalent neurons in the BNN that correspond to negative weights in the ANN with photons of a second wavelength (e.g., blue). The camera can be used to instruct the pixel array to send input data as photons to each neuron's specific location using photon intensity and pulse width modulation, where: (i) lower values can be encoded as lower photon intensities and short pulse widths with lower probability of causing a neuron to fire, and (ii) higher values can be encoded as higher photon intensities and longer pulse widths that have a higher probability of causing a neuron to fire.

The method can further include gathering output from the neurons with a high-speed camera by measuring light (e.g., green light) that is produced by fluorescence from the biosensor AAVs or fluorescent dye detecting ions (e.g., Ca2+ ions) that are released when a neuron fires. BNN weights can be adjusted by comparing the neuron output with the targeted output and illuminating neurons that were expected to fire but did not with the photons of the first wavelength and neurons that were expected to not fire but did with photons of the second wavelength. The BNN weights can further be optimized by applying a gradient descent algorithm to optimize the intensities of the photons of the first and second wavelengths.

a. Proposed Algorithm for Simulating BNNs

In accordance with disclosed techniques, an ANN that mimics certain aspects of a BNN can be implemented to solve limitations in transfer learning. While a BNN includes an arrangement of physical neurons, and thus is limited to two-dimensional (2D) space or 3D space, an ANN is a computer model and thus can be defined in an N-dimensional space. The N-dimensional space (e.g., virtual space or hyperspace) can be a one-dimensional (1D) space, a 2D space, a 3D space, or a space having a higher dimension. In examples where the N-dimensional space is a 3D space, the 3D space can be irplemenited as a bounded volume such as a sphere, cube, torus, ellipsoid, tetrahedron, etc. While the disclosed ANN is alternatively referred to as a raytraced BNN (RayBNN) herein, it will be appreciated that the RayBNN is technically an ANN (i.e., a neural network implemented on a computing system), rather than a real BNN implemented using live biological neurons. Further, it will be appreciated that references to biological terms such as neurons and glial cells in the context of the disclosed ANN can be understood as referring to artificial versions or representations of the biological entities (e.g., neurons refer to artificial neurons and glial cells refer to artificial glial cells). Furthermore, it will be appreciated that neurons and glial cells

In some examples, such as the example depicted in FIGS. 1b-e, the RayBNN is defined in a 3D sphere. In particular, FIG. 1b illustrates a simulated RayBNN defined in a 3D sphere. The blue, red, and green colors in FIG. 1b correspond to neurons, glial cells, and axons, respectively, where the axons carry electrical and neurotransmitter signals from one neuron to another. The axons are alternatively referred to herein as connections or neural connections. In the example, the RayBNN is constructed by uniformly distributing hidden neurons and glial cells within a 3D neural network sphere, such that the hidden neurons and glial cells do not intersect. After setting up the positions of the hidden neurons and glial cells, the positions of input and output neurons are assigned. Some datasets have images as inputs. In those cases, the input neurons are evenly placed onto the sphere surface in order to preserve the relative distances between pixels. On the other hand, the output neurons are all fixed at the origin, similar to the architecture of a human brain. Naturally, this allows output neurons to pool and aggregate information from hidden neurons as the neural connections condense at the center of the sphere. To retain the order of the input data, input neurons are assigned to the sphere surface as described in the “Cell location assignment and distribution analysis” section herein.

FIG. 1c illustrates the location of input neurons at the surface of the network sphere. A two-dimensional (2D) ordered data such as images can be mapped to the neurons with order preserved. The blue line connects the neurons into a one-dimensional (1D) array if the data is 1D.

As shown in FIG. 1c, the input neurons are arranged at the surface so that the order of one-dimensional (1D), two-dimensional (2D), and 3D data features will be retained through direct mapping. Further, each neuron occupies the same solid angle at the sphere surface so that all input neurons can connect to hidden neurons underneath without bias. Moreover, the sphere architecture enables output synchronization, as the distance between any input neuron and output neuron is the same.

FIG. 1d illustrates the transfer of input neurons to a new network sphere where the dimension of the data is densified. The red dots are the new input neurons, and the location of the old neurons (black dots) are not changed. When the model is transferred to a new dataset with densified input dimensions, new neurons (red dots) can be inserted in between old neurons, as shown in FIG. 1d, without the need to move the old neurons. This is suitable for, e.g., transferring learning to higher-resolution images.

On the other hand, if the increased data feature is to be concatenated to the previous data features, then as shown in FIG. 1e, the disclosed algorithm can migrate old neurons toward the north of the sphere while the new neurons are added to the south without changing the data feature order. In particular, FIG. 1e shows that if the new dataset concatenates the old dataset, then the old neurons migrate to the north while new neurons are created in the south of the new network sphere. Notably, all neurons occupy the same solid angle and access the hidden neurons underneath without bias.

Unidirectional connections between neurons that have line-of-sight are created using raytracing algorithms discussed in the “Forming neural connections via raytracing” section. Glial cells, just like in real BNNs, are functioned as objects to block connections between neurons that are too far apart, which reduces overfitting in the learning model. The weight of every unidirectional neural connection is stored inside a sparse matrix, which enables the RayBNN to transform into any architecture without needing to resize the matrix. Additionally, a universal activation function (UAF) outlined in the “Universal activation function” section is deployed to every neuron to enable the activation functions to evolve during the knowledge transfers.

Using the advantages of the RayBNN, the network can be adapted and transferred to any arbitrary architecture. For example, large neural networks take a long time to train. To solve the problem, a small neural network (i.e., with a quick training time) is first trained and then the knowledge obtained during training of the small neural network is transferred to a much larger network, reducing training time. During the transfer, the number of neurons increases. As a result, more neurons are added to the 3D network sphere, and new neural connections are raytraced while preserving the old connections. The network sphere size may increase accordingly to keep the neuron collision rate unchanged. Moreover, the UAF adapts its activation functions to suit more neural connections and neurons. On the other hand, if the new dataset requires fewer neurons and connections. The RayBNN can delete neural connections biased towards those having the smallest absolute valued weights because they have the least impact. Some of the neural connections can be redistributed across other neurons. Afterward, unused neurons are pruned to improve efficiency and accuracy.

The RayBNN is very similar to real-life BNN in view of its 3D physical cell locations, line-of-sight neural connectivity, signal propagation delays, glial cells, cell growth, cell death, neural network merges, and neural network bifurcations. Firstly, both the RayBNN and the real-life BNN are physically constrained by the radius of the entire neural network, cell radii, and cell density. For a neural network radius, there is a finite amount of cells within the volume because the cells cannot be closer than two cell radii. Due to those physical constraints, both the RayBNN and the real-life BNN have line-of-sight neural connections that can be blocked by glial cells or other neurons. Subsequently, the RayBNN has a signal propagation delay that is similar to a real-life BNN because it takes time for information to travel from one neuron to another. Real-life BNN has glial cells to inhibit or electrically isolate neurons from each other to prevent infinite signal loops or neuron overfiring. With the same idea, glial cells are implemented in the RayBNN to reduce neural connections and prevent overfitting of the network. Similar to a real-life BNN, the RayBNN can dynamically grow or shrink by adding new neurons or deleting neurons. Moreover, the RayBNN can join or merge multiple neural networks along multiple axes. Accordingly, a higher degree of connectivity between blocks is achieved as compared to traditional ANNs, and better integrations are achieved.

b. Hyperparameter Tuning and Model Characterization

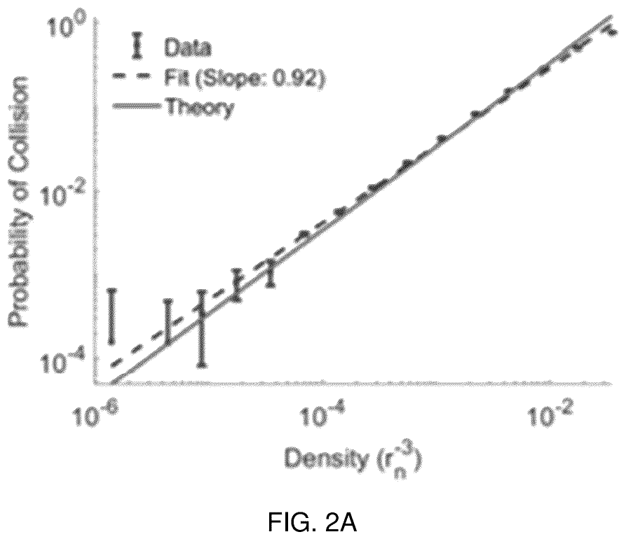

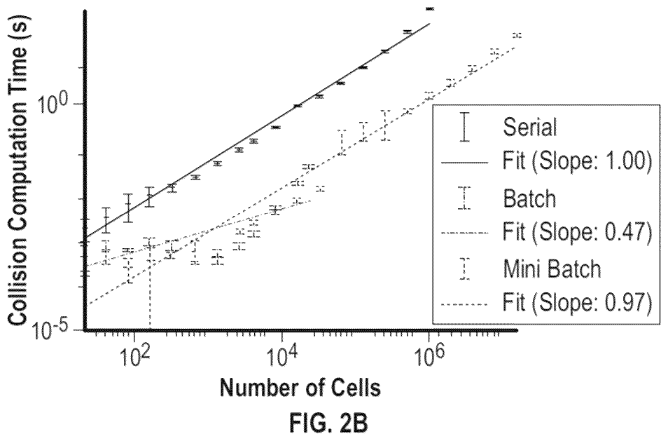

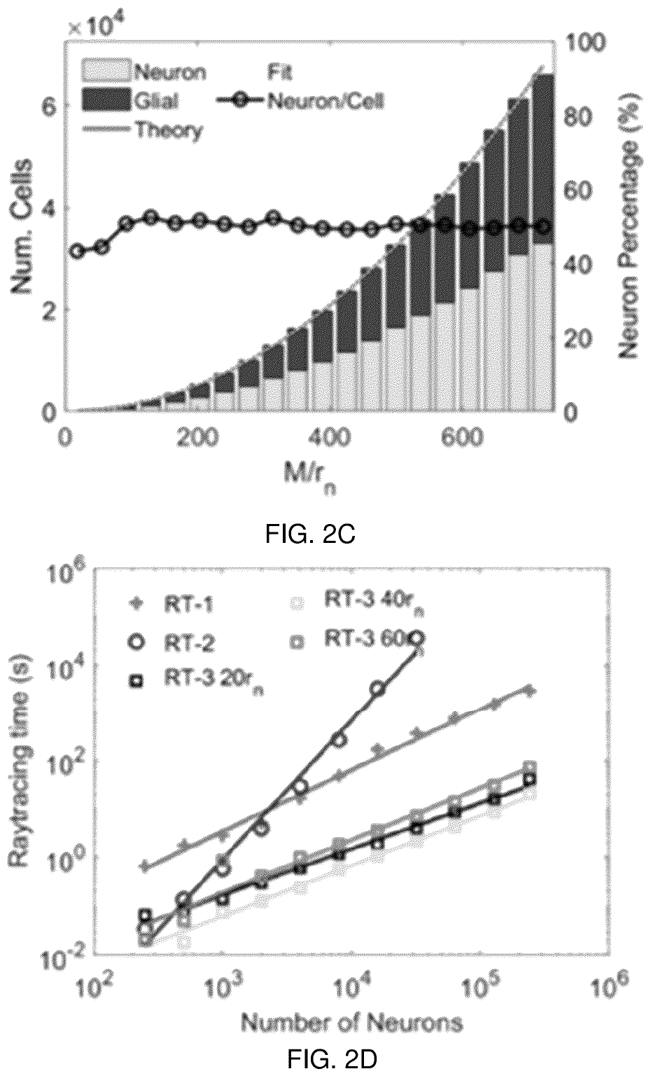

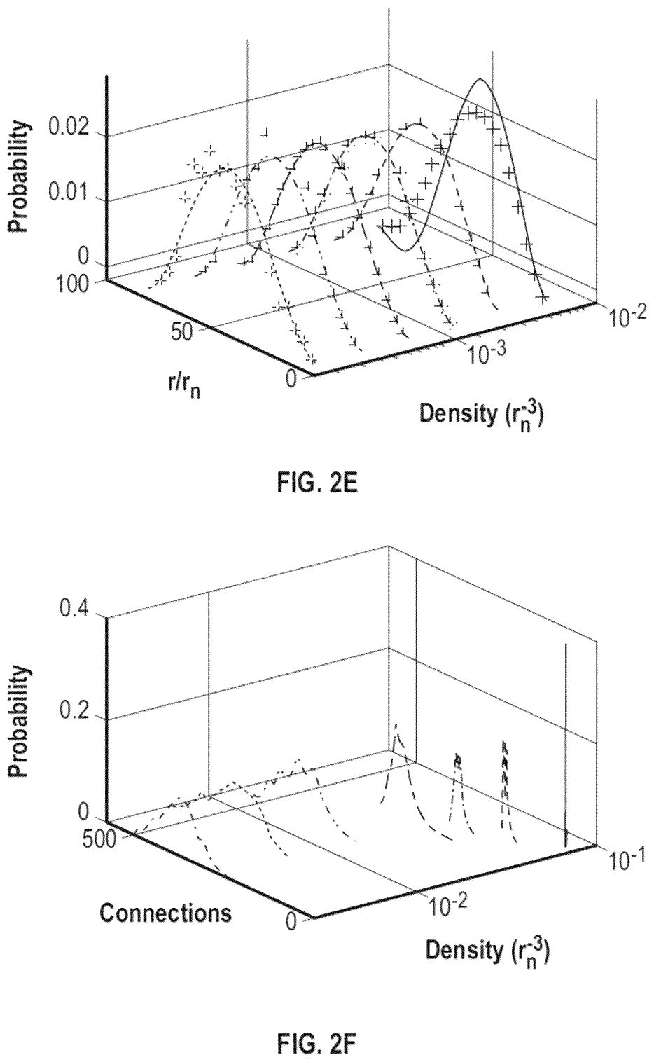

The disclosed model does not allow two cells (neurons or glial cells) to intersect each other, and deleting them is costly. Therefore, the model is characterized in FIGS. 2a-f by first determining the cell density (η) to keep the probability of a cell collision (P_{c}) low. Afterward, given the pre-determined number of cells based on the dataset complexity, the network sphere radius (rₛ) is calculated using the selected cell density and cells are located within the sphere radius, where the uniform distribution of cells is verified. Subsequently, neural connections are raytraced and the probability density functions of the connection lengths P_{nc}(r) and the number of connections per neuron (N_{c}) are plotted.

For the disclosed model, P_{c}<1%. To achieve this, 240,000 neurons and an equal number of glial cells are first adopted and the sphere radius is varied to plot the collision probability vs. cell density as blue dots with error bars in FIG. 2a, which illustrates the probability of a cell collision versus the density of the sphere. The log least-square fitting of the data (blue dashed line) results in a slope of 1.06, indicating the almost linear dependency between the probability and the density, which is also confirmed analytically (Eq. (7), red solid line in the plot) in the “Cell collision detection and analysis” section. As shown, to reduce P_{c} below the 1% threshold, the cell density η that takes into account both neuron and glial cells cannot exceed

$$2.83 \times {10}^{- 4} {r}_{n}^{- 3} ,$$

leading to a minimum network sphere radius of r_{s,min}=739.81rₙ, where rₙ is the radius of a neuron/glial cell. These values are in close agreement with the theoretical predicted maximum density

$$η < \frac{3 {P}_{c}}{32 π {r}_{n}^{3}} = 2.98 \times {10}^{- 4} {r}_{n}^{- 3}$$

and minimum sphere radius rₛ>726.8rₙ, according to Eq. (7).

FIG. 2b illustrates the collision detection time versus the total number of cells in the sphere. In particular, the computation times of three collision detection algorithms are compared. Shown as red dots with error bars, the computation time for the serial algorithm, of which one cell is checked at a time, grows linearly with the number of cells in the sphere according to the least-square fitting (red solid line with a slope of 1.00). It takes 40 s for all 480,000 cells, which is slow. The batch algorithm, shown as the green dots with error bars, in which every cell is checked at the same time, is much faster. The least-square fitting (green solid line with a slope of 0.47) confirms that the computation time only grows at a rate proportional to the square root of cell number (N). However, it requires O(N²) memory to set up a N×N matrix, which crashes for large amounts of cells. To solve this, a mini-batch algorithm (blue dots with error bars) is implemented that takes less memory and checks 480,000 cells in 0.68 s, although it has the same growth rate (blue solid line with a slope of 0.97) as the serial method.

Using the calculated rₛ, all cells are assigned uniformly to the neural network sphere according to the procedure described in the “Cell location assignment and distribution analysis” section. FIG. 2c illustrates the number of cells as a function of distance from the sphere center. In particular, the histograms in FIG. 2c show the number of neurons (green bars) and glial cells (blue bars) as functions of distance from the network sphere center. The perfect parabolic fitting to cell histograms (yellow dashed line) shows the number of cells quadratically increases with distance. The quadratic dependency is in agreement with the theoretic prediction of Eq. (4), which is shown as the red solid line in the plot and confirms the cells are uniformly distributed across the network sphere. Moreover, neuron percentage is almost constant at 50% other than expected fluctuations in low count bins because there are equal numbers of neurons and glial cells. Therefore, it is confirmed that the algorithm did distribute cells uniformly within the sphere.

After generating the positions of cells, raytracing algorithms are employed to create neural connections between neurons. In the “Forming neural connections via raytracing” section, three raytracing algorithms for creating connections are presented, referred to as RT-1, RT-2, and RT-3. FIG. 2d illustrates raytracing time as a function of the number of neurons in the network. The red, blue, black, green, and magenta lines represent RT-1, RT-2, RT-3 20rₙ, RT-3 40rₙ, and RT-3 60rₙ, respectively. As shown in FIG. 2d, RT-1 (red plus markers) does not scale well because it requires a large number of rays per neuron in order to establish connections between neurons unblocked by glial cells. Using 10,000 rays per neuron in the current 480,000-cell network, it takes 2891 seconds to generate connections for neurons they hit. The least-square fitting of the log of raytracing time and the number of neurons (red line) shows a slope of 1.27, suggesting its computational complexity of O(N^{1.27}). On the other hand, as expected, RT-2 (blue circles) is also slow as it requires 36,663 s for 32,000 neurons and needs O(N³) comparisons according to the least-square fitting (blue solid line, with a slope of 2.88). To reduce the number of comparisons, RT-3 (black squares) that only connect all neurons within a fixed sphere radius rR_{T} are adopted. The black, green, and pink squares in the plot are the results for a radius of 20rₙ, 40rₙ, and 60rₙ, respectively. As shown from the least-square fittings (solid lines with the same color), although RT-3 has the same complexity as RT-1, it runs much faster due to the reduced number of comparisons per neuron. In particular, at r_{RT}=40rₙ, these distance-limited rays significantly reduce raytracing time to 20 s for all 240,000 neurons.

FIG. 2e illustrates the probability distribution of the neural connection length at various densities is shown as plus markers. The solid lines of the same color are the theoretic results. The plus markers in FIG. 2e show the probability of forming a neural connection compared to the neural connection length normalized to rₙ using RT-3 as a raytracing method. In this figure, the RT-3 radius is 40rₙ and has a diameter of 80rₙ. Consider a single neuron that is the starting point for a ray. When the ray moves further away from the starting neuron, the number of cells for the ray to terminate increases exponentially. This is reflected in FIG. 2e, where the probability of forming a neural connection increases quadratically as the neural connection length increases linearly. The quadratic relationship holds until the neural connection length reaches close to the network radius, where the probability of forming a neural connection peaks. Afterward, the probability decays because the neurons outside of the 40rₙ radius sphere are prohibited to connect. Moreover, the probability of forming a neural connection is zero when the neural connection length is greater than the diameter of the neural network sphere. At sufficiently low density, the neuron length distribution is nearly unchanged by the density. The probability distribution is further confirmed from theoretic analysis under low-density approximation detailed in the “Neural connection length probability distribution function” section and displayed as solid lines with the same color. As shown, at a low density of

$$1.6 \times {10}^{- 4} {r}_{n}^{- 3}$$

(red color), the simulation data (plus markers) displays large fluctuation due to low cell counts inside the cluster sphere, and at the largest density of

$$0.0205 {r}_{n}^{- 3}$$

(purple line), the theoretical model does not match the probability well as the low-density approximation is no longer satisfied. Meanwhile, at the densities in between, the theoretic model is in close agreement with the simulation.

FIG. 2f illustrates the probability distribution of the number of neural connections per neuron. In particular, FIG. 2f shows that the number of neural connections also changes with the density. When the density is low at

$$5 \times {10}^{- 3} {r}_{n}^{- 3}$$

(blue solid line), the number of neural connections per neuron is 400. As the density increases to

$$0.01 {r}_{n}^{- 3}$$

(red solid line),

$$0.02 {r}_{n}^{- 3}$$

(yellow solid line), and

$$0.04 {r}_{n}^{- 3}$$

(purple solid line), the number of connections per neuron drops to 300, 200, 150, and finally at

$$0.08 {r}_{n}^{- 3}$$

(dark red line) to around 15 connections per neuron. This is due to glial cells and the other neurons blocking the number of connections when the neural network is very dense.
c. Alcala Dataset

The proposed BNNs are useful for many different types of transfer learning applications and datasets. Objectively, the aim is to reduce training time by transferring weights from a smaller neural network to a larger network. For a simple ID example, the Alcala Tutorial 2017 dataset for wireless indoor localization is used. The objective is to predict the positions of wireless devices given the received signal strength intensity (RSSI) of the Wi-Fi access points (APs). Each AP provides one input RSSI feature, where a value of −99 dBMn indicates the AP is far away, while a value of −1 dBn indicates the AP is nearby. Furthermore, an RSSI value of +100 dBm implies the AP is not detected at all. The neural networks have to use the RSSI values and the APs' positions to predict the X and Y positions of the wireless devices.

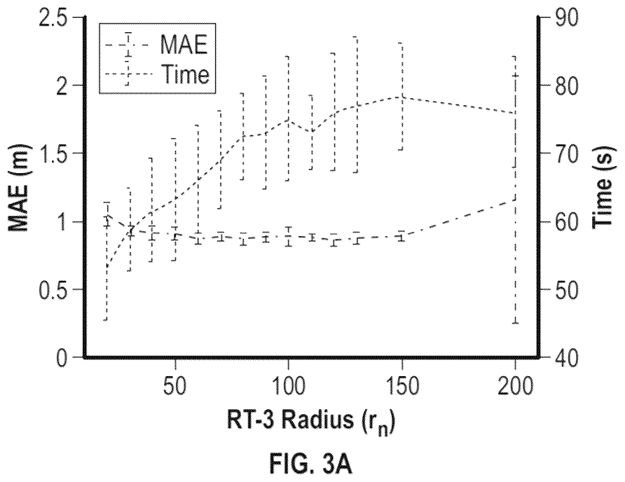

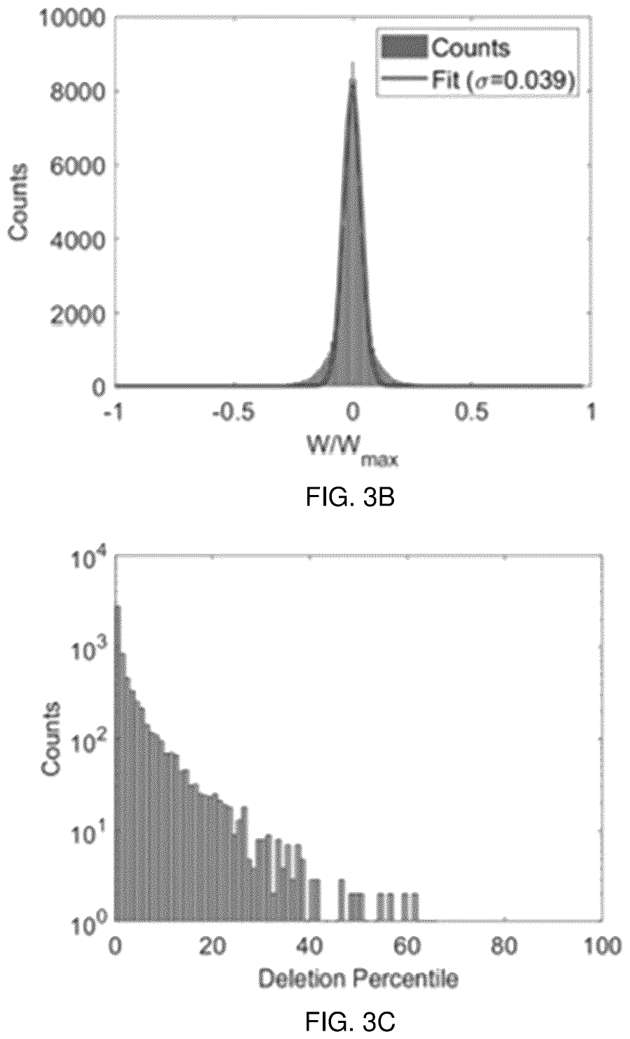

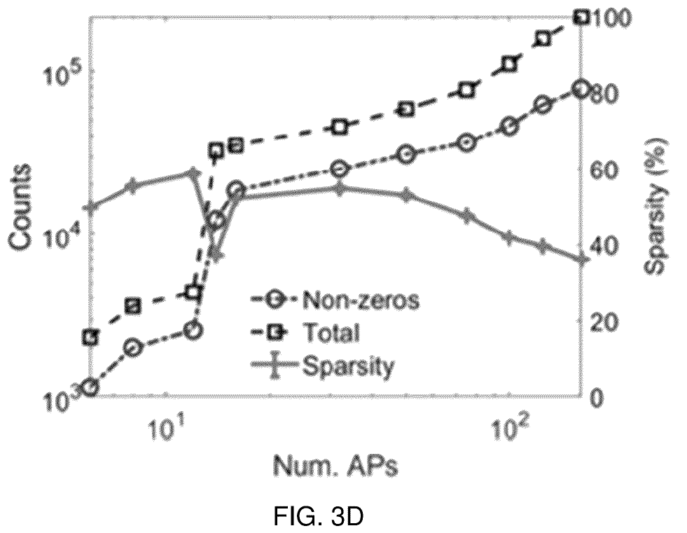

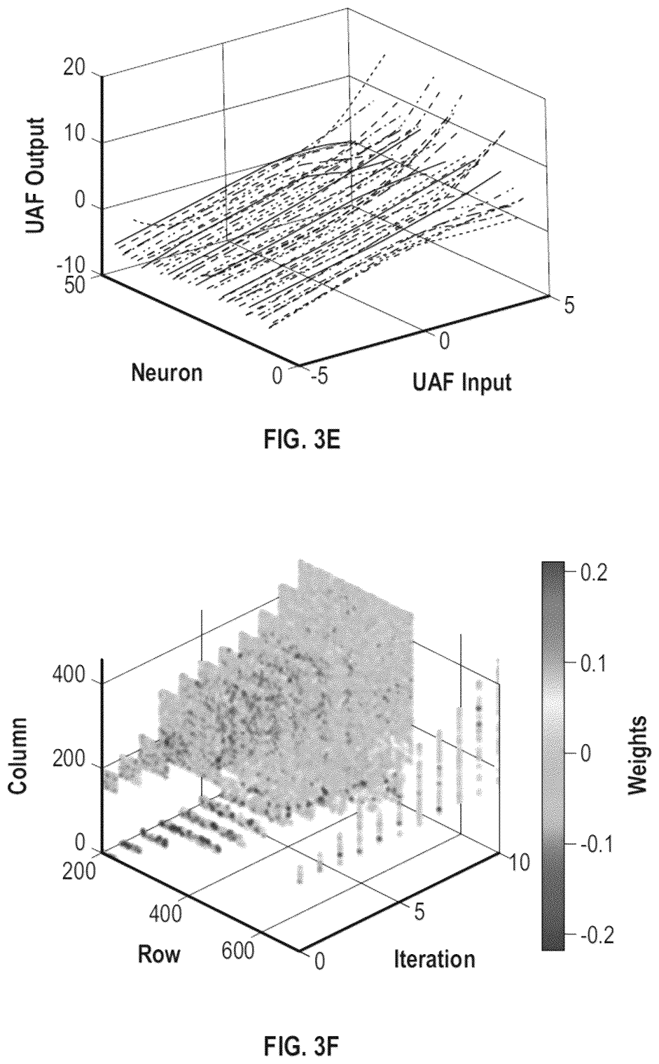

To simulate this, six APs were used as the initial training dataset and the initial RayBNN was built upon it. The initial RayBNN has six input neurons and two output neurons. Although the number of hidden neurons can be determined through a standard hyperparameter tuning process, it is empirically set to 40 here. Correspondingly, an equal number of glial cells is assigned to mimic a real BNN, although it can also be tuned if necessary. With the prescribed algorithm in the “Cell collision detection and analysis” section, the network sphere is set to rₛ=42rₙ to keep the collision rate below 1% Consequently, through the RT-3, 1800 connections are created with a total of 5300 trainable parameters. After training, the dimension of the new training dataset was increased empirically to eight APs and the trained model was transferred to the new dataset. As every AP provides one input feature, the number of neural network inputs of the new dataset increases along with the model complexity. Therefore, the network was increased to eight input neurons. Following the same procedure as the previous iteration, the network was also increased to 50 hidden neurons and 50 glial cells, while the network sphere was adjusted to rₛ=45rₙ, accordingly. Meanwhile, 5700 new connections were also created before training, leading to the total number of parameters to 11,000. As shown in the red circles with a solid red line in FIG. 3a, which illustrates trainable parameters, this process continued until the network reached the maximum input feature size of 162.

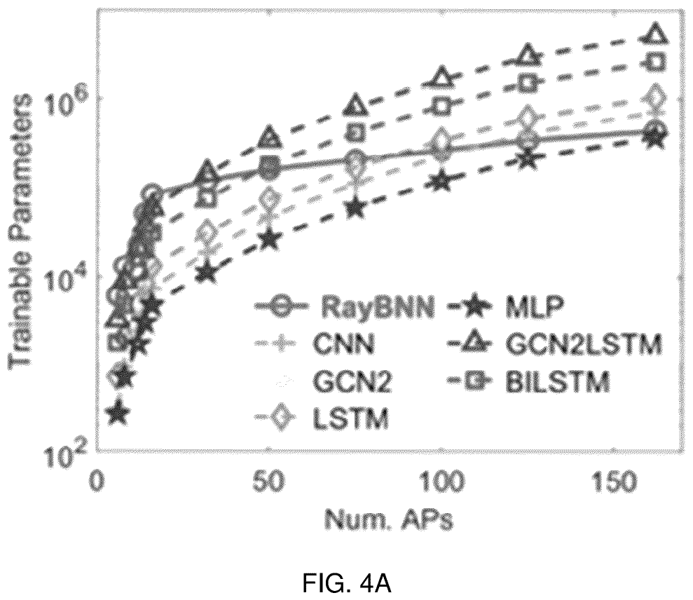

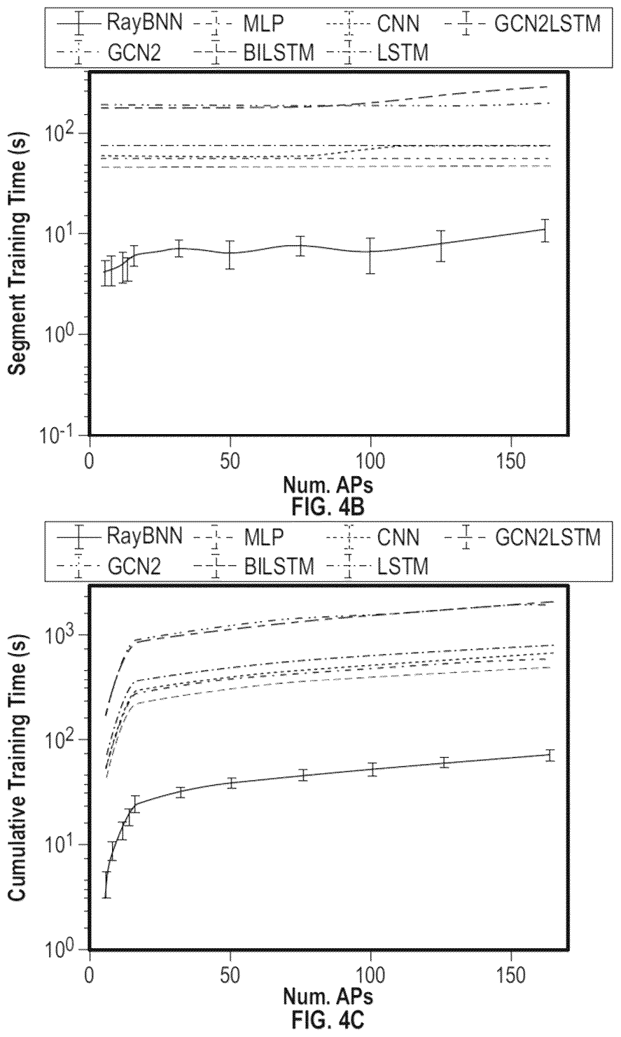

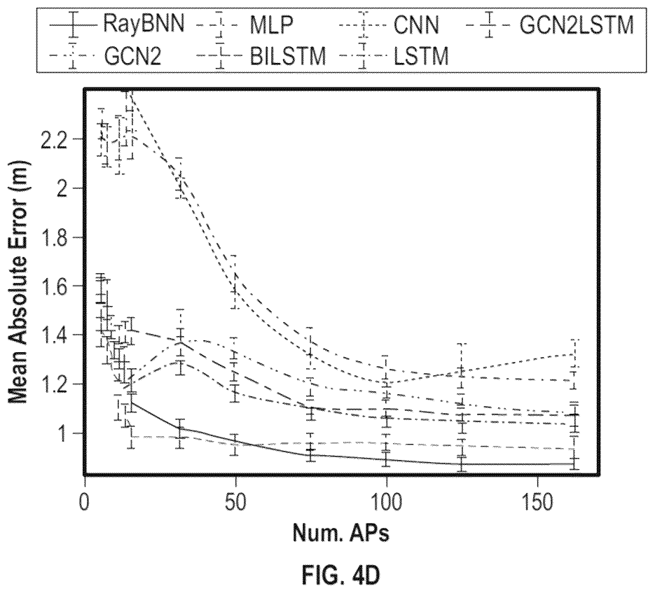

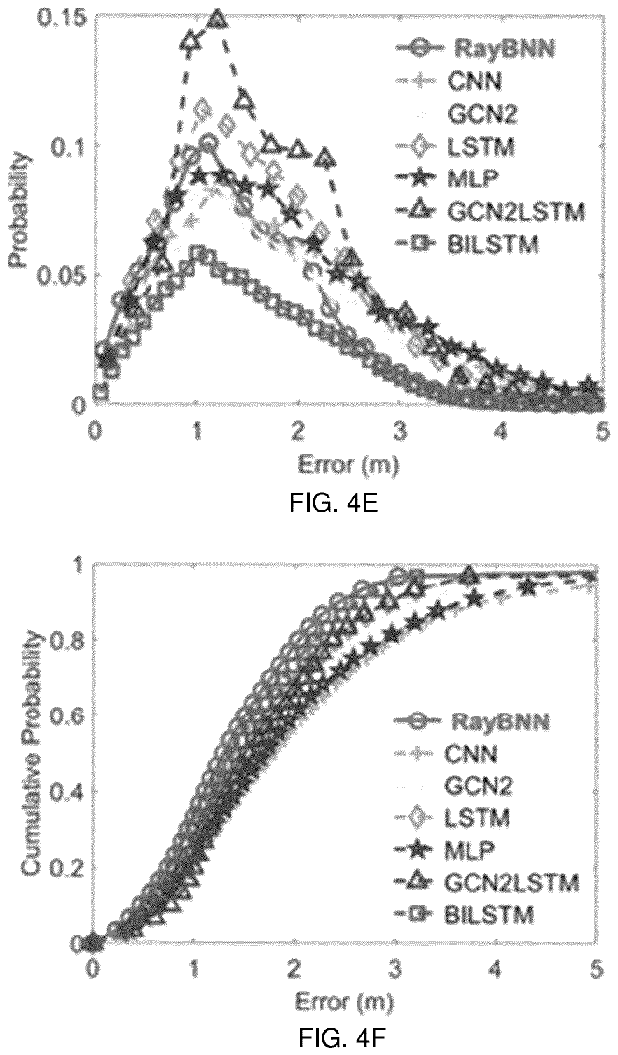

After training the RayBNN for the Alcala dataset, the network characteristics were plotted as shown in FIGS. 4a-f. FIG. 4a illustrates MAE versus the RT-3 radius. The RT-3 radius controls the maximum neural connection length and indirectly limits the neural connectivity/number of connections. To find the lowest MAE and fastest training time, the RT-3 radius is swept in FIG. 4a. As shown in the figure, the MAE reaches a minimum of 60rₙ with a training time of 70 s.

FIG. 4b displays the probability density function of the values in the weighted adjacency matrix. The least-square fit to Gaussian indicates the probability density function roughly follows zero-mean Gaussian with the standard deviation normalized to the maximum weight value in magnitude σ=0.039, where the majority of the weights are centered around the normalized mean of μ=−0.002. FIG. 4c illustrates an absolute value percentile plot of the deleted weights; according to the distribution of deleted values in FIG. 4c, probabilistically deleting 5% of the smallest weights removes many zero-valued weights at a high probability, while also deleting large valued weights at a low probability. FIG. 4d illustrates the sparsity of the weighted adjacency matrix; overall, as shown in FIG. 4d, the weighted adjacency matrix is quite sparse, with the sparsity dropping to below 40% at 162 APs, Therefore, implementation of a sparse matrix enhances memory usage efficiency substantially.

FIG. 4e illustrates plots of activation functions across different neurons In particular, a snapshot of 300 neuron activation functions is pictured in FIG. 4e; an animation of UAF evolution can be found in Supplementary Movie 1, “RayBNN evolution” [S33]. Similar to the weights, the old activation functions are reused and adapted to the new problem every time transfer learning is invoked. This reduces training time as the old activation functions are pre-trained for the new problem.

FIG. 4f illustrates a heat map of the weighted adjacency matrix. In particular, FIG. 4f displays the evolution of the weighted adjacency matrix across multiple knowledge transfers. Unlike the other transfer learning methods, the BNN does not delete the input layer or the output layer. Instead, it expands the weighted adjacency matrix with new weights while keeping the old weights every time the neural network is transferred to a new dataset or the input/output dimension changes.

In order to compare the performance to the BNNs, CNN, GCN2, LSTM, MLP, GCN2LSTM, and BiLSTM models were trained with the same method as above. Details of the model configurations can be found in the “Details of other models for comparison” section. As shown in FIG. 3a, the trainable parameters of the RayBNN (red circle with solid line) increase at a much lower rate compared to other methods, possibly due to the efficient deletion of redundant neurons and connections to keep the network compact. Individual segment training times are shown in FIG. 3b, whereas FIG. 3c shows cumulative training time across a number of APs/inputs. Consequently, at the final learning stage with all 162 APs included, the RayBNN demonstrated an 11.4 s segment training time and 73.2 s cumulative training time off (red solid lines with error bars in FIGS. 3b and 3c). In contrast, the second fastest algorithm, BILSTM, reaches 48.0 s in segment training and 506s in cumulative training time (purple lines in FIGS. 3b and 3c), which are more than 4× and 7× slower than RayBNN. Accordingly, the proposed RayBNN is far faster in transferring knowledge from one problem to another similar problem.

The RayBNN does not only run faster, but it also is more accurate in determining location. The neural network performances on the Alcala Tutorial 2017 dataset are shown in FIG. 3d. In particular, FIG. 3d illustrates the mean absolute value (MAE) of the various algorithms across different numbers of Aps. When the number of APs/inputs increases, the MAE decreases due to the neural networks having more information about the wireless device's location. Among all models, RayBNN reaches the lowest MAE of 0.89 m at 162 APs, while the MAE of the rest models varies between 0.95 to 1.33 in. For the specific 162 AP result, the probability distribution function of the localization error is plotted in FIG. 3e and the cumulative distribution function (CDF) of the localization error is plotted in FIG. 3f. For RayBNN, the most probable error is 1.1 m, and at 80% CDF, errors are below 2 m. Notably, both are among the lowest in all models,

d. EEG Motor-Imagery Dataset

In EEG datasets, the objective is to retrieve information from the subject's brain using multiple electrodes placed on the subject's head/brain. However, every human has a unique set of EEG signals that is completely different from every other person. This is due to having distinct brain structures and electrode placements. As a consequence, most algorithms are unable to perfectly generalize across different subjects, especially if they have not seen the subject's specific waveforms before.

Table 1 shows the algorithms' performances on a 210-GB EEG dataset. In this dataset, there are 54 different subjects and each subject has two experimental sessions for classifying and detecting motor-imagery (MI) tasks, event-related potential (ERP), and steady-state visually evoked potential (SSVEP) tasks. Fifty-fourfold subject-independent testing is used to evaluate the models in Table 1, with a confidence interval of o. For each fold, one subject is selected for the testing dataset, while the other 53 subjects are selected for the training dataset to remove any overlap between the training dataset and the testing dataset. Moreover, there are no duplicate samples between the testing datasets in each fold. That way, the algorithms are evaluated on their ability to generalize across subjects. Accuracy, precision, recall, F₁ score, and area under curve receiver operating characteristic (AUC ROC) are recorded for the various algorithms.

TABLE 1
Performances of the algorithms in the EEG motor-imagery dataset

| Model | Accuracy | Precision | Recall | F₁ score | ROC AUC |
|---|---|---|---|---|---|
| CSP-LDA | 0.624 ± 0.092 | 0.638 ± 0.097 | 0.624 ± 0.092 | 0.609 ± 0.103 | 0.646 ± 0.121 |
| CSP-LR | 0.625 ± 0.092 | 0.639 ± 0.097 | 0.625 ± 0.092 | 0.610 ± 0.103 | 0.646 ± 0.121 |
| Xdawn-MDM | 0.712 ± 0.112 | 0.732 ± 0.106 | 0.712 ± 0.112 | 0.701 ± 0.123 | 0.770 ± 0.129 |
| Xdawn-LR | 0.827 ± 0.087 | 0.835 ± 0.083 | 0.827 ± 0.087 | 0.826 ± 0.089 | 0.891 ± 0.083 |
| Deep4Net | 0.836 ± 0.108 | 0.851 ± 0.094 | 0.836 ± 0.108 | 0.831 ± 0.121 | 0.914 ± 0.086 |
| Xdawn- | 0.836 ± 0.085 | 0.844 ± 0.081 | 0.836 ± 0.085 | 0.834 ± 0.086 | 0.920 ± 0.071 |
| Deep4Net- | | | | | |
| MLP | | | | | |
| Deep4Net- | 0.846 ± 0.104 | 0.849 ± 0.103 | 0.846 ± 0.104 | 0.845 ± 0.104 | 0.906 ± 0.094 |
| RayBNN | | | | | |
| Xdawn- | 0.856 ± 0.085 | 0.861 ± 0.082 | 0.856 ± 0.085 | 0.856 ± 0.086 | 0.926 ± 0.068 |
| Deep4Net- | | | | | |
| RayBNN | | | | | |

Common spatial pattern (CSP) is widely used for extracting EEG features by decomposing the multivariate EEG signal into component eigenvalues and eigenvectors. After extracting the features, they are fed into linear discriminant analysis (LDA) or logistic regression (LR) for classification. As shown in Table 1, CSP-LDA is not very good at generalizing across different subjects for this specific dataset and has a very low mean accuracy of 62.4%. CSP-LR has a slightly better accuracy of 62.5%. On the other hand, researchers have used the Xdawn algorithm from the pyRiemann python package to extract features from EEG signals. Xdawn projects the high-dimensional Riemann manifold source space to the tangent space, which allows each class to be discerned more easily than the source space. Subsequently, the minimum distance to mean (MDM) algorithm is used to produce the final classification result. Each class has a centroid, and the data samples closest to a specific centroid will be assigned to that specific class. The combination of Xdawn and MDM (Xdawn-MDM) performs significantly better than CSP algorithms, as its accuracy of 71.2% is much higher. Furthermore, using Xdawn-LR increases the accuracy to 82.7%.

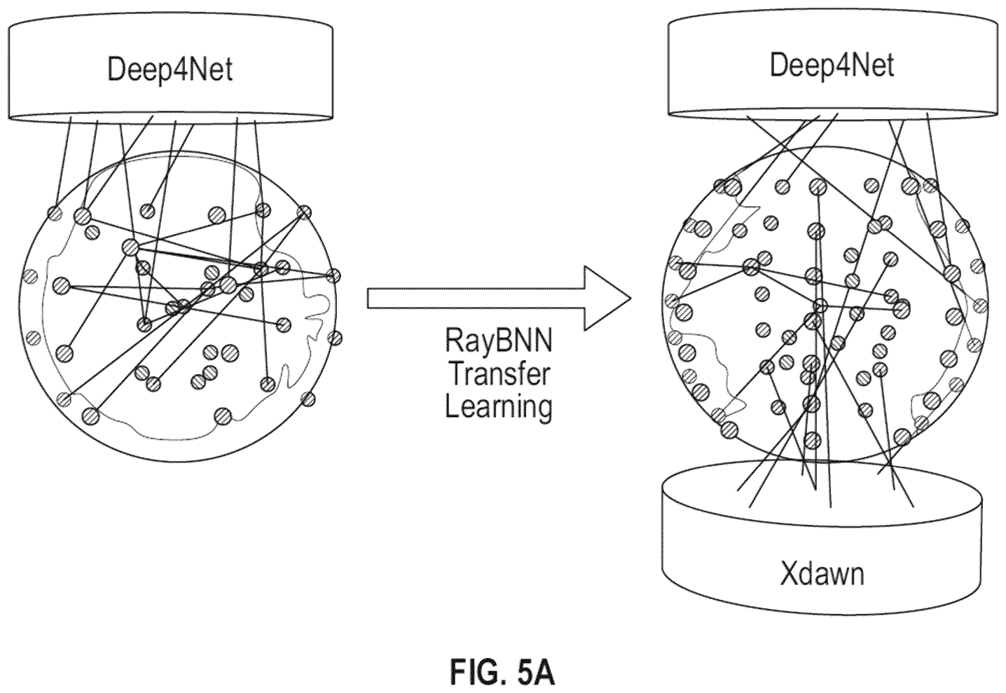

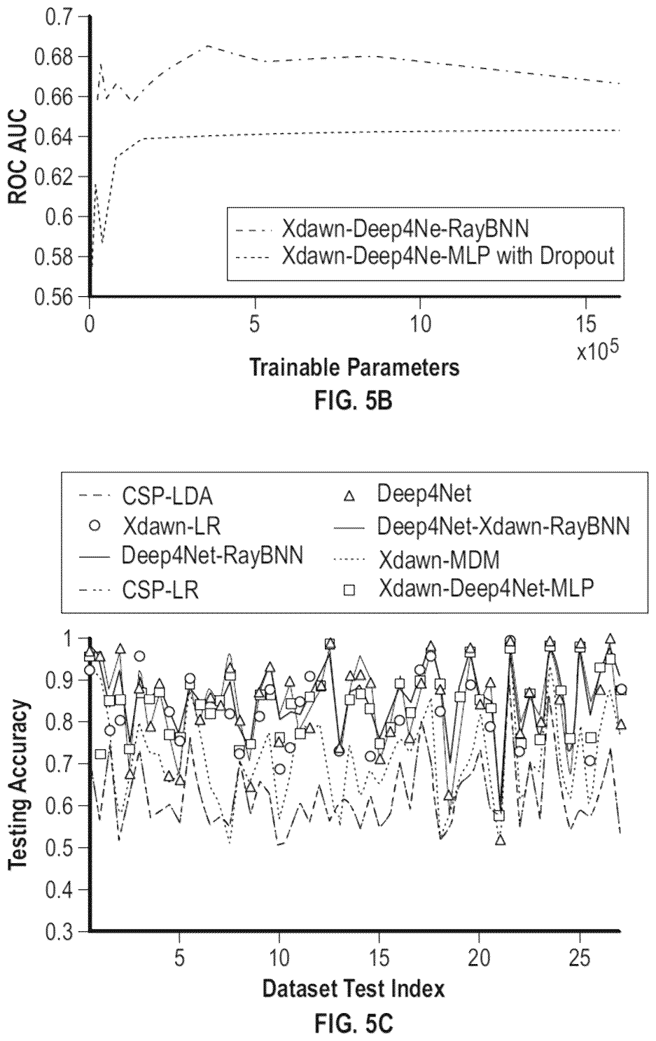

Deep4Net was developed as the state of the art CNN model for classifying EEG signals, of which is made out of five blocks. Each block has a 2D convolutional layer, batch normalization layer, max pooling layer, and dropout layer. Moreover, the model does not have any fully connected layers but uses a logsoftnmax function as its final layer. Deep4Net's 83.6% accuracy is higher than Xdawn's accuracy because the convolutional layers can denoise and extract more features than the Xdawn algorithm. To outperform the state of the art, RayBNN was incorporated together with Deep4Net, as shown in FIG. 5a. In particular, FIG. 5a illustrates RayBNN transfer learning for an EEG dataset. Since Deep4Net's final layer aggregates data and loses a lot of information, outputs were extracted from Deep4Net's second last layer and fed into RayBNN's input neurons. For RayBNN's architecture, there are 1400 input neurons, 1000 hidden neurons, and 600,000 neural connections. Subsequently, RayBNN produces the final classification result for the EEG dataset. For the Deep4Net-RayBNN combination, it has an accuracy of 84.6% which is higher than standalone Deep4Net and Xdawn-Deep4Net-MLP. As there is no optimal feature extraction algorithm for all subjects, an ensemble of Xdawn-Deep4Net-RayBNN was created as shown in FIG. 5a. This is done by first training the Deep4Net-RayBNN combination and transferring the network to the Xdawn-Deep4Net-RayBNN ensemble. The transfer learning flexibility of RayBNN allows it to dynamically accept the 1400-element output from Deep4Net and the 990-element output from Xdawn to predict the final EEG classification result. For this specific case, the RayIBNN has 2390 input neurons, 1000 hidden neurons, and 600,000 neural connections. Overall, the Xdawn-Deep4Net-RayBNN ensemble has the highest accuracy of 85.6%, with precision, recall, F₁ score, and AUC ROC being higher than the rest of the algorithms.

FIG. 5b shows a comparison between the Xdawn-Deep4Net-RayBNN and its Xdawn-Deep4Net-MLP counterpart for one of the testing folds in the EEG dataset. The MLP has a dropout rate of 50% and the RayBNN has a sparsity of ˜50%. As the number of trainable parameters increases, the ROC AUC also increases. However, the ROC AUC eventually reaches a limit, even though the number of trainable parameters keeps increasing. As shown in the figure, RayBNN performs much better than MLP due to having neural connection pruning and deleting redundant neurons.

FIG. 5c illustrates the EEG dataset and OpenBMI toolbox for three 13C1 paradigms. In particular, FIG. 5c shows the performances of the algorithms on an individual subject basis. The Xdawn algorithm performs better for some subjects than the Deep4Net. Conversely, Deep4Net performs better for some subjects than the Xdawn algorithm. Due to the fact RayBNN uses both Xdawn and Deep4Net, it has the advantages of both and produces the highest accuracy for most of the test index. For the training time of the various algorithms, the CSP-LDA algorithm has a training time of 15,73±0 91 s and CSP-LR has 15.51 ±0.97 s. Moreover, Xdawn-MDM and Xdawn-LR have 19.21±1.2 s and 19.05±1.6 s, respectively. On the other hand, Deep4Net has a training time of 7271±231 s, which is drastically higher. Subsequently, Xdawn-Deep4Net-MLP, Deep4Net-RayBNN, Xdawn-Deep4Net-Ray3NN have 7324 ±235 s and 7306±233 s and 7326±235 s, respectively due to the incorporation of Deep4Net.

Table 2 shows the statistical testing of each EEG algorithm in comparison to Xdawn-Deep4Net-RayBNN. In particular, Table 2 shows paired t-tests with right tail p values of the accuracy using fifty-fourfold testing. The accuracy is calculated for each individual algorithm and fold. To compare, two algorithms are selected and the difference in accuracy is computed for each fold. The paired t-test was applied to the differences to get the p values. The null hypothesis assumes the difference between the algorithms has a mean equal to zero. As all p values are equal or less than 1 7968×10⁻³, the null hypothesis was rejected; the Xdawn-Deep4Net-RayBNN was determined to statistically outperform all of the other algorithms.

TABLE 2
Statistical testing of the EEG algorithms

| Comparison | p value |
|---|---|
| Xdawn-Deep4Net-RayBNN vs Xdawn-Deep4Net- | 1.2725 × 10⁻⁴ |
| MLP | |
| Xdawn-Deep4Net-RayBNN vs Deep4Net | 1.7968 × 10⁻³ |
| Xdawn-Deep4Net-RayBNN vs Xdawn-LR | 2.2429 × 10⁻⁶ |
| Xdawn-Deep4Net-RayBNN vs Xdawn-MDM | 1.0220 × 10⁻¹⁶ |
| Xdawn-Deep4Net-RayBNN vs CSP-LR | 2.3756 × 10⁻²⁴ |
| Xdawn-Deep4Net-RayBNN vs CSP-LDA | 2.2413 × 10⁻²⁴ |

### III. DISCUSSION

In some examples described herein, neurons are randomly positioned in a 3D sphere. As shown in FIG. 2e, the probability density function of the neuron lengths is a continuous Gaussian curve. This gives a lot of flexibility for creating many different neural connections and neural network structures. Alternatively, neurons may be arranged in a patterned fashion. For example, when neurons are arranged on a set of concentric sphere surfaces and only allow neural connections between neighboring surfaces, then the RayBNN topology becomes equivalent to a conventionally layered neural network. Overall, there are many possible periodic or chaotic arrangements for neurons and glial cells. It is possible that certain arrangements, along with certain connection rules, will lead to better performance than the state of the art in a set of applications. It is also feasible to optimize the position of neurons and glial cells through training. Therefore, implementing them and exploring their characteristics will be exciting research in the future. In particular, one may study it with the knowledge transformed from group theory and solid state physics where various spatial topologies of atoms and molecules in solid have been extensively investigated.

The network's physical shape could be another exploration factor as it heavily influences the neural connection length and, in turn, also influences the propagation delay of information. For example, a neural network's overall shape could be a 3D cube, a torus, an ellipsoid, a tetrahedron, etc., each with its own advantages and disadvantages. In the case of a 3D cube or tetrahedron, the signal paths from the surface of the shape to the center are very different compared to a 3D sphere. As a result, some signals may reach the center of a cube faster, while others might take a longer time since they traveled a longer path. For applications needing synchronization, 3D cube and tetrahedron networks might not be optimal. For other applications requiring joining or merging neural networks, 3D cube, and tetrahedron networks can be easily joined together to significantly scale up a neural network for large datasets. In the case of an ellipsoid, the shape changes the number of hidden neurons that each input neuron can access, as it now becomes surface location dependent. Such bias toward a certain subset of input data features may be advantageous to train datasets whose data features are not equally important. It may be possible to evolve the network shape toward an ergodic optimal according to the nature of the dataset, just like how the human brain evolves from a sphere.

A RayBNN transfer learning model that is similar to real-life BNNs was created via techniques disclosed herein. In the world of machine learning, a traditional ANN is usually planar with well-structured neural network layers. The RayBNN, like real-life BNNs and unlike traditional ANNs, assigns 3D positions to neurons and glial cells in a neural network sphere. The neurons are interconnected stochastically without well-defined layers, allowing for more efficient information flow and learning transfers. Although still in its infant stage, the RayBNN has already outperformed conventional models in indoor localization, on both speed and accuracy. It also tops the state of the art in large EEG dataset analysis and predictions and demonstrates its capacity for seamless integration with conventional deep neural networks, which brings additional power to it. Note that up to date, the human brain still out-performs artificial intelligence (AI) in many aspects, such as using symbolic logic to derive mathematical proofs, handling numerous incompatible data structures, and achieving multiple different objectives at the same time. It is expected that with the continuing development, the RayBNN will outperform other AI models in these areas due to its inherent similarity to BNN.

As a human brain consumes much less power than current AI models, techniques are described herein for using live biological neurons, or in particular, optogenetically-modified neurons, to implement the RayBNN so that the network can be trained and the input/output be read in/out optically, which may lead to a better AI hardware but with much lower power. The resemblance between the RayBNN and real-life BNN s makes RayBNN a unique platform for the studies of human and animal intelligence and behavior. With further development, the RayBNN neuromorphic device may be miniaturized so that it can be trained and implemented in patients for neural disease treatments.

### IV. Methods

An overview of the RayBNN is displayed in Algorithm 1. Firstly, 3D positions are assigned to glial cells and neurons, as described in the “Cell location assignment and distribution analysis” section, because they will form the physical structure of the neural network. As cell positions are randomly assigned, some of those neurons and glial cells might intersect or clip into each other. Those intersecting cells are removed following the methods and analysis in the “Cell collision detection and analysis” section. Secondly, new neural connections are raytraced using the positions and radii of cells. The “Forming neural connections via raytracing” section lists the specialized raytracing algorithms for creating neural connections. Thirdly, every neural connection in the network is encoded into a sparse weighted adjacency matrix, as shown in the “Mapping neural connections into the weighted adjacency matrix” section. Meanwhile, details on implementing UAF to each neuron are discussed in the “Universal activation function” section. Subsequently, the forward pass uses the weighted adjacency matrix to calculate the neural network's output, as described in the “RayBNN forward pass” section. In contrast, the backward pass produces the gradient of the weights, and the gradient descent algorithms apply it to update the weighted adjacency matrix, as described in the “Backpropagation” section. During transfer learning, the dataset changes, which modifies the number of neurons and neural connections. If required, neural connections are deleted as described in the “Deleting neural connections” section and unused neurons are removed as described in the “Deleting redundant neurons” section.

Algorithm 1 - Overview algorithm for RayBNN

```
function RayBNN(Model, λ, Dataset):
  // Initialization
  Data ← Dataset(λ);
  Model(λ).initNetworkSphere(Data);
  Model(λ).raytraceConnections( );
  Model(λ).createWAdj( );
  while true do
    // Training the Model
    Loss ← ∞;
    while !isPlateau(Loss) do
      Model(λ).forwardPass(Data);
      Model(λ).backwardPass(Data);
      Loss ← Model(λ).crossValidation(Data);
    end while
    // Transfer Learning
    Model(λ+1) ← Model(λ);
    λ ← λ + 1;
    Data ← Dataset(λ);
    Model(λ).delConnections( );
    Model(λ).delUnusedNeurons( );
    Model(λ).addNeurons( );
    Model(λ).raytraceConnections( );
  end while
```

a. Cell Location Assignment and Distribution Analysis

### 1. Hidden Neurons and Glial Cells' Location Assignment

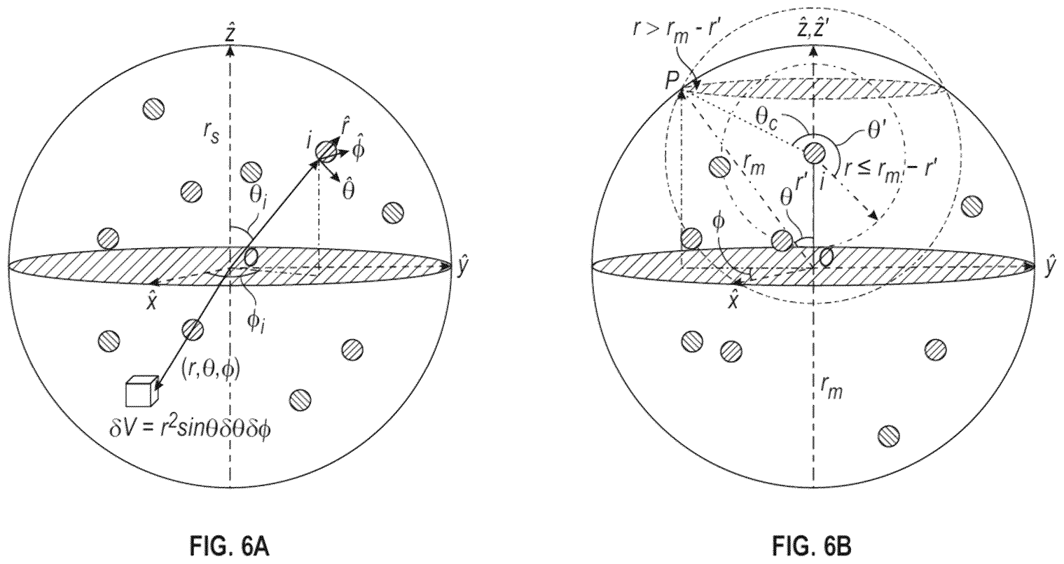

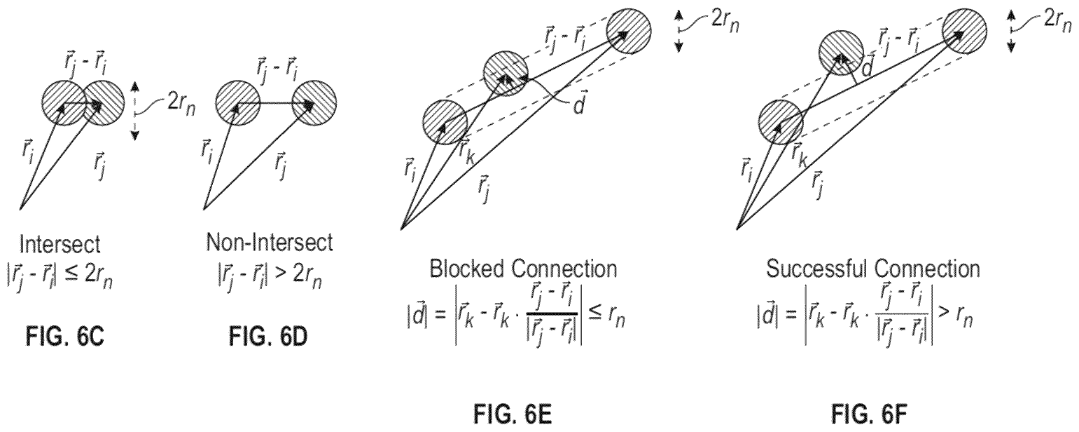

FIG. 6a is an illustration of the global spherical coordinate (\hat{r}, \hat{θ}, \hat{ϕ}) centered at the origin of the network sphere with radius rₛ. A small cube located at a position of (r, θ, ϕ) has a differential volume of δV=r² sin θδθδϕ. Both neurons (green balls) and glial cells (red balls) are uniformly distributed within the network sphere, leading to a parabolic cell density distribution along the radial direction.

In the disclosed model, both hidden neurons and glial cells are uniformly distributed in a network sphere of radius rₛ. To achieve that, a global spherical coordinate (\hat{r}, \hat{θ}, \hat{ϕ}) centered at the sphere origin is set up with the unit vectors pointing to the radial, polar and azimuthal directions. FIG. 6a is an illustration of the global spherical coordinate (\hat{r}, \hat{θ}, \hat{ϕ}) centered at the origin of the network sphere with radius rₛ. A small cube located at a position of (r, θ, ϕ) has a differential volume of δV=r² sin θδθδϕ. Both neurons (green balls) and glial cells (red balls) are uniformly distributed within the network sphere, leading to a parabolic cell density distribution along the radial direction.

Within the sphere, every small volume δV=r₂ sin θδrδθδϕ centered at (r, θ, ϕ) should contain the same number of cells, except for statistical fluctuations. Therefore, to assign the location of a cell i, three random numbers [symbol] ᵣ, [symbol] _{θ}, and [symbol] _{ϕ} are first generated, each uniformly distributed within 0 to 1. Then the position of the cell (rᵢ, θᵢ, ϕᵢ) can be assigned following the formula below:

$${r}_{i} = {ℛ}_{r}^{1 / 3} {r}_{s} \qquad ( 1 )$$

$${θ}_{i} = {cos}^{- 1} [ 2 \times ( {ℛ}_{θ} - 0.5 ) ] \qquad ( 2 )$$

$${ϕ}_{i} = 2 π \times {ℛ}_{ϕ} \qquad ( 3 )$$

To verify that the location assignment of cells is uniform within the sphere at a constant density

$${η}_{T} = \frac{{N}_{T}}{{r}_{s}^{3} 4 π / 3}$$

with N_{T}=Nₙ+N_{g} being the total number of neuron (Nₙ) and glial (N_{g}) cells, the population density function of cells n_{T}(r) on a sphere surface of radius r and concentric to the network sphere is analyzed, which is found to be

$${n}_{T} ( r ) = {η}_{T} 4 π {r}^{2} = \frac{3 {N}_{T}}{{r}_{s}^{3}} {r}^{2} . \qquad ( 4 )$$

The parabolic relation of the population distribution is confirmed in FIG. 2c as discussed in the previous section.

### 2. Input and Output Neurons Assignment

In the model, all output neurons are assigned to the center of the network sphere, while input neurons are at the surface of the sphere. In many cases, the features of input data are correlated and ordered. Therefore, the input neurons at the sphere surface should also maintain the same order and be equally spaced apart. For example, an image may contain (Nₓ, N_{y}) pixels and their 2D order should not change. To accommodate that, the input neuron assignment scheme is developed as follows. First, a

$${N}_{x} \times 1 vector {\vec{V}}_{θ} = {[ {v}_{θ}^{1} , … , {v}_{θ}^{i} , … , {v}_{θ}^{{N}_{x}} ]}^{T} and a$$

$${N}_{y} \times 1 vector {\vec{V}}_{θ} = {[ {v}_{ϕ}^{1} , … , {v}_{ϕ}^{j} , … , {v}_{ϕ}^{{N}_{y}} ]}^{T}$$

are created such that all elements are equally spaced between 0 and 1, as shown in Eq. (5),

$$\{ \begin{matrix}{v}_{θ}^{i} = \frac{i + 1}{{N}_{x} + 1} ( i = 0 , … , {N}_{x} - 1 ) \\ {v}_{ϕ}^{j} = \frac{j + 1}{{N}_{y} + 1} ( j = 0 , … , {N}_{y} - 1 )\end{matrix} \qquad ( 5 )$$

Shown as the black dots in FIG. 1c, the location of the input neuron that corresponds to the (i, j) pixel of the image can then map to the sphere according to Eq. (6).

$$\{ \begin{matrix}{r}_{i , j} = {r}_{s} \\ {θ}_{i , j} = {cos}^{- 1} [ 2 \times ( {v}_{θ}^{i} - 0.5 ) ] \\ {ϕ}_{i , j} = 2 π {v}_{ϕ}^{j}\end{matrix} \qquad ( 6 )$$

Note that since each input neuron occupies the same solid angle

$$δΩ = \frac{4 π}{{N}_{x} {N}_{y}}$$

and thus the same area of the sphere surface, it will have unbiased access to the hidden neurons as they are uniformly distributed under the surface. Meanwhile, the order and correlation of the pixels in the original image are preserved. Moreover, the input neurons can be easily mapped to 1D data so that the order of the needed features are preserved. For example, to map a 1D, N_{1D}-point EEG data to the 2D sphere surface, \vec{V}_{θ} and \vec{V}_{ϕ} should be built with NₓN_{y}=┌\sqrt{N_{1D}}┐ and then the 2D neuron location should be flattened into a 1D vector \vec{A} with a helix pattern \vec{A}=[(0,0), (0,1), . . . , (0, N_{y}−1), (1,0), (1,1), . . . , (1, N_{y}−1), . . . ]^{T} showing as the blue line in FIG. 1c.

To map 3D ordered data such as RGB images to the input neurons, red, blue, and green pixels can be assigned to the same location. When a hidden neuron tries to create a connection to the location where the three neurons are, it will randomly pick one of them to connect,

The input neuron location assignment can be further simplified if the input features are not ordered. In this case, the neurons can be randomly assigned on the surface with the exact method to assign hidden neurons except that their radial coordinates will be fixed at rₛ,

b. Cell Location Re-Assignment Upon Population Growth.

When transferring knowledge between datasets, the dimensions of the datasets might change. This is reflected in the number of input and output neurons. If the dimension increases, then more neurons are added to the input and output neurons. In addition, the number of hidden neurons and glial cells may also increase to accommodate the increasing complexity of the new dataset. In this case, the network sphere will increase to rₛ′ to retain the low collision rate. To achieve that, all of the old cells are first relocated to the new network sphere by simply changing their radial position to

$${r}_{i}^{′} = \frac{{r}_{s}^{′}}{{r}_{s}} {r}_{i}$$

while keeping the polar and azimuthal angles fixed. The new cells are then added to the expanded sphere using the same procedure described above. Similarly, one may increase the input neurons on the sphere surface in an ordered pattern depending on the way the new dataset is formed. For example, if the dataset is transferred from low-resolution images to higher resolution, one may simply densify \vec{V_{θ}} and \vec{V_{ϕ}} by inserting new elements evenly within each vector. In this way, new neurons shown as the red dots in FIG. 1d can be located according to the new vector elements while old input neurons can stay at their original locations without the need to reconnect. On the other hand, if the new dataset concatenates new features to the previous dataset, then the old neurons can simply move toward, e.g., north of the sphere as shown in FIG. 1e by recalculating

$${θ}_{i}^{′} = {cos}^{- 1} [ 2 \times ( κ {v}_{θ}^{i} - 0.5 ) ]$$

with the connections to hidden neurons retained. Here 0<κ≤1 is a densification factor that determines how much space in the south needs to be emptied for the new neurons. Meanwhile, the new input neurons can be added, e.g., on the south of the sphere in the space emptied from the old neurons.

### 1. Cell Collision Detection and Analysis

During the cell location assignment, some cells may collide. In the disclosed model, all colliding cells are deleted during the assignment. As deleting cells is computationally costly, the collision rate is kept below 1%. This requires that the network sphere radius must be larger than the minimum radius r_{s,min} to keep the cell density sparse,

FIG. 6c illustrates that two neurons i and j intersect if their distance |\vec{r}ⱼ−\vec{r}ᵢ|≤2rₙ; FIG. 6d illustrates that neurons do not intersect if |\vec{r}ⱼ−\vec{r}ᵢ|>2rₙ. Accordingly, as shown in FIGS. 6c and 6d, a collision occurs to a cell at rᵢ if the center of another cell is within 2rₙ distance. Further, cells are uniformly distributed within the sphere and rₛ>2rₙ. Therefore, in a new spherical coordinate (\hat{r}′, \hat{θ}′, \hat{ϕ}′) centered at cell i, neglecting the cells that are within 2rₙ of the network sphere surface, the population density function at r′ is expected to have the same form as Eq. (4),

$${n}_{T} ( {r}^{′} ) = \frac{3 {N}_{T}}{{r}_{s}^{3}} {r}^{′2} .$$

Therefore, the collision probability can be written as

$${P}_{c} = {\int }_{0}^{2 {r}_{n}} {n}_{T} ( {r}^{′} ) {dr}^{′} = 8 {N}_{T} \frac{{r}_{n}^{3}}{{r}_{s}^{3}} = \frac{32 π}{3} {η}_{T} {r}_{n}^{3} \qquad ( 7 )$$

as long as P_{c}<<1. Therefore, at a preset minimum collision threshold P_{c,th}, the cell density must satisfy

$${η}_{T} < \frac{3 {P}_{c , th}}{32 π {r}_{n}^{3}} \qquad ( 8 )$$

while the sphere radius

$${r}_{s} > {( \frac{8 {N}_{T}}{{P}_{c , th}} )}^{\frac{1}{3}} {r}_{n} \qquad ( 9 )$$

Eq. (7) can also be explained as follows. In a network sphere of radius rₛ and volume

$${V}_{s} = \frac{4 π}{3} {r}_{s}^{3} ,$$

if the density of cells is sufficiently sparse so that the number of cells that intersect each other is much fewer than the total number of cells. Cell intersection occurs only when a cell falls within the volume

$${V}_{n} = \frac{4 π}{3} {( 2 {r}_{n} )}^{3}$$

occupied by any other cell. Therefore, the probability to place a single cell into the network sphere and intersect with any other cells is

$${P}_{c} = {N}_{T} {V}_{n} / {V}_{s} = \frac{32 π}{3} η {r}_{n}^{3} .$$

Since there are N_{T} cells, the total number of intersect cells will be N_{c}=N_{T}P_{c}, resulting in the collision rate

$$\frac{{N}_{c}}{{N}_{T}} = {P}_{c} ,$$

which is consistent with Eq. (7).
c. Forming Neural Connections Via Raytracing

Three different raytracing (RT) algorithms for connecting neurons together were implemented. In RT algorithm 1 (RT-1): randomly generated rays, each neuron randomly outputs K rays of random angles and of infinite lengths. Typically, K should be larger than the number of connections each neuron would make. In this example, K=10,000 to ensure sufficient neural connections. For a network of Nₙ neurons, there are KNₙ randomly generated rays. If a ray intersects a glial cell, then it is removed. If a ray intersects multiple neurons, then one new neural connection is created from the current neuron to the closest intersected neuron, while the neurons past it are not connected. The algorithm for detecting the intersection is as follows. It generates rays of random lengths and directions. Subsequently, the disclosed algorithm checks the generated rays to see if they intersect any other cells, or equivalently, if there is a cell's distance to any ray is within rₙ. If a ray intersects a neuron and not a glial cell, then the ray is inserted into a queue. Meanwhile, duplicate neural connections occupying the same space are removed from the queue. In total, RT-1 requires KNₙ(Nₙ+N_{g}) comparisons, and it is inefficient because some rays intersect the same object multiple times and other rays do not intersect anything. Duplicates of the same connections are removed using a deduplication algorithm.

To make the algorithm more efficient, the RT algorithm 2 (RT-2): directly connected rays was created, where each neuron is directly connected to every other neuron in the neural network via a finite-length ray. Thus,

$${N}_{n}^{2}$$

rays are generated, and they are compared to Nₙ+N_{g} neurons and glial cells. Again, rays that intersect glial cells are removed and rays that intersect multiple neurons will end at the closest neuron. RT-2 also uses the same ray intersection algorithm and deduplication algorithm. In total, there are

$${N}_{n}^{2} ( {N}_{n} + {N}_{g} )$$

comparisons, which is inefficient for large sizes of neurons as the complexity increases to

$$O ( {N}_{n}^{3} ) .$$

Building upon the previous algorithm and assuming far-reaching connections can be ignored, an RT algorithm 3 (RT-3): distance-limited directly connected rays is proposed. Firstly, a random cell is selected as a pivot. A segment is constructed by only selecting cells within a fixed sphere radius (rₘ) of the pivot, which has approximately Nₘ neurons and N_{gm} glial cells. Afterwards, the RT-2 is applied to the segment to generate new neural connections and the process repeats by selecting new pivots. New neural connections from each segment are concatenated and deduplicated to remove multiples of the same connection. Each segment has

$${N}_{m}^{2}$$

rays that are compared to Nₘ+N_{gm} cells, therefore there are

$${N}_{m}^{2} ( {N}_{m} + {N}_{g m} )$$

comparisons per segment. Assuming the network is divided into K segments, the total number of comparisons is approximately

$$K {N}_{m}^{2} ( {N}_{m} + {N}_{g m} ) .$$

As the total number of neurons is much greater than the number of neurons in a segment Nₙ>>Nₘ, this speeds up RT-3 by a factor of

$${( {N}_{n} )}^{2} / {KN}_{m}^{2} ≫ 1$$

over RT-2. It is also ensured that all output neurons are connected to all input neurons by traversing the network backward and checking all neural connections.

### 1. Neural Connection Length Probability Distribution Function

In this subsection, the neural connection length probability is derived using RT-3. Here, for simplicity, it can be assumed that each cluster in RT-3 is spherical in shape with radius rₘ. FIG. 6b illustrates the probability of neural connection calculation setup for RT-3. The origin O of the cluster spherical coordinate (\hat{r}, \hat{θ}, \hat{ϕ}) is located at the center of the cluster sphere with a radius of rₘ. A local spherical coordinate of neuron i (\hat{r}′, \hat{θ}′, \hat{ϕ}′) is at the neuron center. Both coordinates are aligned so that \hat{z} and \hat{z}′ are parallel to the line between i and O. When a sub-cluster sphere centered at i is within the cluster sphere (r≤rₘ−r′, blue dashed sphere), all neurons on that sub-cluster sphere surface may be accessible for neuron i to form connections. If rₘ−r′<r≤rₘ+r′, the sub-cluster sphere intersects the cluster sphere (red dashed sphere). Only neurons on the sub-cluster sphere surface within the cluster sphere are accessible by neuron i. When r >rₘ+r′, the sub-cluster surface is outside the cluster sphere and none of the neurons on its surface are accessible by neuron i.

As shown in FIG. 6b, a cluster spherical coordinate (\hat{r}, \hat{θ}, \hat{ϕ}) whose origin is at the center of the cluster sphere (O) and a local spherical coordinate (\hat{r}′, \hat{θ}′, \hat{ϕ}′) whose origin is at a neuron i that is r′<rₘ away from the cluster center are adopted. Further, the \hat{z} axis of both coordinates is aligned such that the position of neuron i can be written as (r′,0,0) in the cluster coordinate.

FIG. 6e illustrates that neurons i and j cannot form a connection if the distance of a third cell k to the connection |\vec{d}|≤rₙ. FIG. 6f illustrates that a connection will be formed if |\vec{d}|≤rₙ. Note that cell k must be in-between neurons i and j, or (\vec{r}ₖ−\vec{r}ᵢ)·(\vec{r}ⱼ−\vec{r}ᵢ)>0 and (\vec{r}ₖ−\vec{r}ⱼ) (\vec{r}ᵢ−\vec{r}ⱼ)>0. Accordingly, as shown in FIGS. 6e and 6f, a connection between neuron i and another neuron j that is r distance away will not form if there is a cell k to block the line of sight. Therefore, if the cell density is sufficiently sparse, the probability of not forming a connection should equal the number of cells in the cylinder that connects these two neurons and have a circular cross-section of radius rₙ, leading to the probability of making a successful connection to be

$$p ( r ) = 1 - π {r}_{n}^{2} {η}_{T} r \qquad ( 10 )$$

Therefore, the conditional probability of neuron i forming a connection of length r is

$${P}_{n c} ( r \vert {r}^{′} ) = {n}_{n} ( r ) \times p \qquad ( 11 )$$

where nₙ(r)=n_{T}(r), the population density of neurons r distance away from neuron i is half of the total population density as there are equal numbers of neurons and glial cells. Note that for r<rₘ−r′ (blue dashed sphere in FIG. 6b), all connecting neurons are within the cluster. Following the derivation in the previous section,

$${n}_{n c} ( r \vert {r}^{′} ) = 4 π {η}_{n} {r}^{2} ( 1 - π {r}_{n}^{2} {η}_{T} r ) \qquad ( 12 )$$

On the other hand, if rₘ−r′<r<rₘ+r′ (red dashed sphere in FIG. 6b), only a portion of neurons having the same distance r are inside the cluster while those outside cannot make connections. The portion of the qualified neuron can be estimated using the solid angle of the crust that is inside the cluster, from which is obtained

$${n}_{n c} ( r \vert {r}^{′} ) = \frac{2 π {\int }_{{θ}_{c}}^{π} sin {θ}^{′} d {θ}^{′}}{4 π} 4 π {η}_{n} {r}^{2} ( 1 - π {r}_{n}^{2} {η}_{T} r ) \qquad ( 13 )$$

$$= π {η}_{n} \frac{r [ {r}_{m}^{2} - {( r - {r}^{′} )}^{2} ] ( 1 - π {r}_{n}^{2} {η}_{T} r )}{{r}^{′}} \qquad ( 14 )$$

Finally, N_{c}(r|r′)=0 for r≥rₘ+r′ since no qualified neurons are in the cluster. Further, following the Bayesian Theorem, the connection length probability is

$$\begin{matrix}{P}_{nc} ( r ) = {\int }_{0}^{{r}_{m}} {dr}^{′} {P}_{nc} ( r \vert {r}^{′} ) {P}_{n} ( {r}^{′} ) \\ = K ( 1 - π {r}_{n}^{2} {η}_{T} r ) \{ {\int }_{0}^{{r}_{m} - r} {dr}^{′} {r}^{2} {r}^{′2} + {\int }_{{r}_{m} - r}^{{r}_{m}} {dr}^{′} \frac{{rr}^{′} [ {r}_{m}^{2} - {( r \vert {r}^{′} )}^{2} ]}{4} \} \\ = {Kr}^{2} ( 1 - π {r}_{n}^{2} {η}_{T} r ) {( r - 2 {r}_{m} )}^{2} ( r + 4 {r}_{m} )\end{matrix} \qquad ( 15 )$$

where

$${P}_{nc} ( r \vert {r}^{′} ) = \frac{{n}_{nc}}{{N}_{nc}}$$

is the probability density of forming a connection of length r condition of the neuron i is at r′ and

$${P}_{n} ( {r}^{′} ) = \frac{{n}_{n} ( {r}^{′} )}{{N}_{n}}$$

being the probability of neuron i is at r′. N_{nc} is the total number of connections within the cluster, K is a normalization factor such that ∫₀^{2r}^{ₘ} P_{nc}(r)dr=1. In this example, η_{T} is sufficiently small such that P_{nc}(r)≈Kr²(r−2rₘ)²(r+4rₘ) which is independent to the density. The density independence at low density was confirmed in FIG. 2e.
d. Mapping Neural Connections into the Weighted Adjacency Matrix

After generating the neural connections via the raytracing algorithms, they are mapped into the N×N weighted adjacency matrix W. The total neuron capacity N∈N⁺ controls how many neural connections are reserved in memory. In every case, the neuron capacity is greater than the number of neurons

$$N > {N}_{n}^{λ} , ∀ λ$$

to allow adding/deleting neurons without resizing/reallocating the weighted adjacency matrix W. Here, the superscript λ stands for the λ-th evolution of transfer learning. Each individual matrix element {wᵢⱼ, {i, j}∈1, . . . , N}represents the weight of a unidirectional raytraced connection from i-th neuron to j-th neuron. Following that, the weights wᵢⱼ are initialized with the Xavier weight initialization algorithm.

Storing the entire weighted adjacency matrix together with the zero element weights takes too much memory space and is computationally expensive for matrix multiplication. To solve this problem, W is stored in compressed sparse row (CSR) matrix format, where the value vector \vec{W}ᵥₐₗᵤₑ only stores the non-zero elements. While CSR matrices are used for computing forward pass and backward pass as mentioned in the “RayBNN Forward Pass” and “Backpropagation” subsections, COOrdinate format (COO) matrices are used to add and delete new weights/neural connections. More information on the sparse matrix format can be found in the Supplementary Material in Subsections S.3.A and S.3.B.

Some neural connections hamper the performances of the neural networks by overriding certain values and network states. For example, input neurons that connect to other input neurons hamper the data flow because they override current input values with the previous input values from the previous time step. Deleting these values from the weighted adjacency matrix W(0: N_{I}−1, : )=0 severs the neural connections from the input neurons to themselves and fixes the problem. Similar to the problem above, output neurons that connect to other output neurons produce incorrect neural network outputs because they override the current output values. Again, the problem can be solved by deleting weights connecting output neurons to other output neurons W(: , N−N_{O}−1: N−1)=0.

When a neuron connects to itself, this is called a self-loop. For datasets requiring memory-less neural networks, self-loops may degrade the performance of the neural network because there could be a positive feedback cycle that goes to positive infinity. Self-loops can be removed by setting the diagonals of the weighted adjacency matrix to zero diag(W)=0.

e. Universal Activation Function

There are many different activation functions in machine learning, and it is difficult to determine the optimal activation function for a certain application. To solve the problem, the universal activation function (UAF) was adopted to dynamically evolve the UAF to the best activation function. An example of UAF is presented in the Supplementary Material in Section S.4. Here, a unique UAF is applied to the output of every neuron in the network by modifying the single input single output version of the UAF to a multiple input multiple output version of the UAF. After the modification, each neuron in the network has five unique parameters that specifically control its own specific UAF.

For example, the gradient descent algorithm could tune the parameters such that the UAF evolves to the LeakyReLU function for some neurons, while evolving to the Tanh function for other neurons. The single input, single output version of the UAF ƒ_{UAF}(x)

$${f}_{UAF} ( x ) = ln ( 1 + {e}^{A ( x + B ) - \vert C \vert {x}^{2}} ) - ln ( 1 + {e}^{D ( x - B )} ) + E \qquad ( 16 )$$

takes in an input ∀x∈ [symbol] and produces an output based on the trainable parameters ∀A,B,C,D,E ∈

[symbol]

In this article, the UAF is further extended to multiple input/multiple output cases.

$$\vec{X} = [ \begin{matrix}{x}_{0} \\ {x}_{1} \\ {x}_{2} \\ ⋮ \\ {x}_{N - 1}\end{matrix} ] , \hat{Y} = [ \begin{matrix}{y}_{0} \\ {y}_{1} \\ {y}_{2} \\ ⋮ \\ {y}_{N - 1}\end{matrix} ] \qquad ( 17 )$$

$${C}_{eff} = [ \begin{matrix}{A}_{0} & {B}_{0} & {C}_{0} & {D}_{0} & {E}_{0} \\ {A}_{1} & {B}_{1} & {C}_{1} & {D}_{1} & {E}_{1} \\ {A}_{2} & {B}_{2} & {C}_{2} & {D}_{2} & {E}_{2} \\ ⋮ & ⋮ & ⋮ & ⋮ & ⋮ \\ {A}_{N - 1} & {B}_{N - 1} & {C}_{N - 1} & {D}_{N - 1} & {E}_{N - 1}\end{matrix} ] \qquad ( 18 )$$

$${y}_{i} = {f}_{UAF} ( {x}_{i} , {A}_{i} , {B}_{i} , {C}_{i} , {D}_{i} , {E}_{i} ) \qquad ( 19 )$$

$$\hat{Y} = {\vec{f}}_{UAF} ( \vec{X} , {C}_{eff} ) \qquad ( 20 )$$

where N is the length of the input vector \vec{X}∈ [symbol] ^{N×1} and the output vector Ŷ∈ [symbol] ^{N×1} C_{eff}∈ [symbol] ^{N×5} is a matrix filled with coefficients ℄Aᵢ, Bᵢ, Cᵢ, Dᵢ, Eᵢ∈ [symbol] that describes the shapes of the individual activation functions, \vec{f}_{UAF} is applied element-wise to the input vector \vec{X} that contains input variables ∀xᵢ∈ [symbol] and produces the output vector f that contains the output values ∀yᵢ∈ [symbol] .
   f. RayBNN Forward Pass

When the weighted adjacency matrix is finally configured, the output states of the neural network are obtained at every time step t. The neural network contains many external and internal states, of which record the output values of individual neurons. The input state vector contains information that will be placed into the input neurons, while the output state vector contains information extracted from the output neurons. On the other hand, the internal state vector keeps track of every single active neuron inside the neural network. At every time step t, the forward pass algorithm places the input state vector into the input neurons. Simultaneously, the algorithm updates the current internal state vector using the previous internal state vector and the input state vector, while extracting the output state vector from the output neurons.

Now for the mathematical description of the forward pass algorithm. The input state vector \vec{X}^{t}∈ [symbol] ^{N}^{_{I}}^{×1} and the output state vector Ŷ^{t}∈ [symbol] ^{N}^{_{O}}^{×1} are created

$${\vec{X}}^{t} = [ \begin{matrix}{x}_{0}^{t} \\ {x}_{1}^{t} \\ {x}_{2}^{t} \\ ⋮ \\ {x}_{{N}_{I} - 1}^{t}\end{matrix} ] , {\hat{Y}}^{t} = [ \begin{matrix}{y}_{0}^{t} \\ {y}_{1}^{t} \\ {y}_{2}^{t} \\ ⋮ \\ {y}_{{N}_{O} - 1}^{t}\end{matrix} ] \qquad ( 21 )$$

with N_{I} number of input elements and N_{O} number of output elements respectively. Note that each input \vec{X}^{t} is synchronized with output \vec{Y}^{t} for training purposes. Meanwhile, the neuron bias vector \vec{H}∈ [symbol] ^{N×1} and the internal state vector \vec{S}^{t} ∈ [symbol] ^{N×1} are initialized

$$\vec{H} = [ \begin{matrix}{h}_{0} \\ {h}_{1} \\ {h}_{2} \\ ⋮ \\ {h}_{N - 1}\end{matrix} ] , {\vec{S}}^{t} = [ \begin{matrix}{s}_{0}^{t} \\ {s}_{1}^{t} \\ {s}_{2}^{t} \\ ⋮ \\ {s}_{N - 1}^{t}\end{matrix} ] \qquad ( 22 )$$

to have the same neuron size N. Typically, the bias vector \vec{H} is initialized with random normal numbers that are later trained by the gradient descent algorithms. However, the state vector at time t=0 is always initialized with all zero elements \vec{S}⁰=\vec{0} to ensure the initial neuron state is blank.

At every time step t, a temporary state vector \vec{Q}^{t}∈ [symbol] ^{N×1}

$${\vec{Q}}^{t} ← {\vec{S}}^{t} \qquad ( 23 )$$

is created using the current state vector \vec{S}^{t}. Following that, the input vector \vec{X}^{t} is placed into elements index 0 to index N_{I}−1 of the temporary state vector \vec{Q}^{t}

$${\vec{Q}}^{t} ( 0 \text{:} {N}_{I} - 1 ) ← {\vec{X}}^{t} \qquad ( 24 )$$

so that the input neurons' values are updated with the current input vector. As the objective is to propagate the input information throughout the hidden neurons, the state of every neuron that is directly connected to the current set of neurons is updated. This is done by computing the next state vector \vec{S}^{t+1}

$${\vec{S}}^{t + 1} ← {\vec{f}}_{UAF} ( W {\vec{Q}}^{t} + \vec{H} , {C}_{eff} ) \qquad ( 25 )$$

where the weighted adjacency matrix W multiplies the temporary state vector \vec{Q}^{t}. Afterward, the bias vector \vec{H} is added to the resulting vector, and the result goes through the activation function \vec{ƒ}_{UAF}.

In order to ensure the input information reaches the output neurons, the process above is repeated U total time steps to yield a time sequence of state vectors {\vec{S}⁰, \vec{S}¹, \vec{S}², . . . , \vec{S}^{U-1}}. U=I_{T}+k is the total number of processing steps, where I_{T} is the number of input vectors in the time series and k is the programmed propagation delay between sending an input vector and receiving an output vector. Typically, the value k is greater than or equal to the mean traversal depth from the input neurons to the output neurons. Higher values of k allow the neural network to perform more complex computational tasks at the cost of more computational time and larger memory usage. Now, the output vectors are extracted from the output neurons. For example, an output vector Ŷ^{t} at time t is constructed using elements index N−N_{O} to index N−1 of the state vector \vec{S}^{t+k} at time t+k

$${\hat{Y}}^{t} ← {\vec{S}}^{t + k} ( N - {N}_{O} \text{:} N - 1 ) \qquad ( 26 )$$

where each output vector Ŷ^{t} corresponds to an input vector \hat{X}^{t}.

For a simple example, imagine a state vector \vec{S}⁰ that has all zeros

$${\vec{S}}^{0} = [ \begin{matrix}0. \\ 0. \\ 0. \\ ⋮ \\ 0.\end{matrix} ] \qquad ( 27 )$$

and is used to update \vec{Q}⁰←\vec{S}⁰ together with input vector \vec{Q}^{t}(0: 1)←\vec{X}⁰.

$${\vec{X}}^{0} = [ \begin{matrix}- 2.1 \\ 0.3\end{matrix} ] , {\vec{Q}}^{0} = [ \begin{matrix}- 2.1 \\ 0.3 \\ 0. \\ 0.\end{matrix} ] \qquad ( 28 )$$

The next state vector \vec{S}¹ is computed using \vec{Q}⁰ and W assuming the UAF is an identity function and \vec{H} is all zeros.

$$W = [ \begin{matrix}0.2 & 1.5 & - 0.1 & 0.9 \\ - 0.8 & 0.0 & 0.6 & - 1.0 \\ 1.0 & - 0.7 & 3.2 & 1.2 \\ - 2.0 & - 0.5 & 0.7 & 0.1\end{matrix} ] \qquad ( 29 )$$

$${\vec{S}}^{1} = [ \begin{matrix}0.2 & 1.5 & - 0.1 & 0.9 \\ - 0.8 & 0.0 & 0.6 & - 1.0 \\ 1.0 & - 0.7 & 3.2 & 1.2 \\ - 2.0 & - 0.5 & 0.7 & 0.1\end{matrix} ] [ \begin{matrix}- 2.1 \\ 0.3 \\ 0.0 \\ 0.0\end{matrix} ] \qquad ( 30 )$$

Following that, the output vector \vec{Y}⁰ is extracted from the state vector \vec{S}¹.

$${\vec{S}}^{1} = [ \begin{matrix}0.03 \\ 1.68 \\ - 2.31 \\ 4.05\end{matrix} ] , {\vec{Y}}^{0} = [ \begin{matrix}- 2.31 \\ 4.05\end{matrix} ] \qquad ( 31 )$$

g. Backpropagation

Gradient descent algorithms are used to optimize the parameters of the RayBNN. However, they require the gradients of the weights and biases. A modified backpropagation algorithm, made specifically for CSR matrices, is used to compute those gradients. Firstly, the overall loss function J is computed

$$J = \frac{1}{{I}_{T}} {\sum }_{t = 0}^{{I}_{T}} L ( {\hat{Y}}^{t} , {\vec{Y}}^{t} ) \qquad ( 32 )$$

using the loss function L, the neural network prediction Ŷ, and the actual output \vec{Y}. Secondly, the CSR-weighted adjacency matrix W is flattened into a 1D weight vector \vec{W}, where the elements are in row-major order. This allows for updating of certain elements in the weighted adjacency matrix W without updating all elements. The gradient of the loss function with respect to the weights

$$\frac{\partial J}{\partial \vec{W}}$$

is found by evaluating the partial derivative of the loss function

$$\frac{\partial L}{\partial {\hat{Y}}^{t}}$$

at (Ŷ^{t}, \vec{Y}^{t}) in accordance with Eq. (33),

$$\frac{\partial J}{\partial \vec{W}} = \frac{1}{{I}_{T}} {\sum }_{t = 0}^{{I}_{T}} [ \frac{\partial L}{\partial {\hat{Y}}^{t}} {\vert}_{( {\hat{Y}}^{t} , {\vec{Y}}^{t} )} ⊙ \frac{\partial {\hat{Y}}^{t}}{\partial \vec{W}} ] \qquad ( 33 )$$

and evaluating the partial derivative of the activation function \vec{ƒ}_{UAF} with respect to input vector \vec{X}. Note that ⊙ represents element-wise tensor/matrix/vector multiplication. Moreover, the partial derivatives

$$\frac{\partial L}{\partial {\hat{Y}}^{t}} , \frac{\partial \vec{Q}}{\partial \vec{W}} , \frac{\partial {\vec{f}}_{UAF}}{\partial \vec{X}}$$

are reshaped to match the dimensions of \vec{W}.

$$\frac{\partial {\hat{Y}}^{t}}{\partial \vec{W}} = \frac{\partial {\vec{f}}_{UAF}}{\partial \vec{X}} {\vert}_{W {\vec{Q}}^{t + k - 1} + \vec{H}} ⊙ \frac{\partial }{\partial \vec{W}} [ W {\vec{Q}}^{t + k - 1} ] \qquad ( 34 )$$

The Partial derivative of the state vector

$$\frac{\partial \vec{Q}}{\partial \vec{W}}$$

is recursively computed until

$$\frac{\partial {\vec{Q}}^{0}}{\partial \vec{W}}$$

is reached.

$$\frac{\partial }{\partial \vec{W}} [ W {\vec{Q}}^{t + k - 1} ] = {\vec{Q}}^{t + k - 1} + W \frac{\partial {\vec{Q}}^{t + k - 1}}{\partial \vec{W}} \qquad ( 35 )$$

$$\frac{\partial {\vec{Q}}^{t + k - 1}}{\partial \vec{W}} = \frac{\partial {\vec{f}}_{UAF}}{\partial \vec{X}} {\vert}_{W {\vec{Q}}^{t + k - 1 + \vec{H}}} ⊙ \frac{\partial }{\partial \vec{W}} [ W {\vec{Q}}^{t + k - 2} ] \qquad ( 36 )$$

For a simple example, assume an MSE loss function and the equations from the previous subsection

$$J = {( {\hat{Y}}^{0} - {\vec{Y}}^{0} )}^{T} ( {\hat{Y}}^{0} - {\vec{Y}}^{0} ) \qquad ( 37 )$$

$$\frac{\partial J}{\partial \vec{W}} = 2 ( {\hat{Y}}^{0} - {\vec{Y}}^{0} ) ⊙ \frac{\partial {\hat{Y}}^{0}}{\partial \vec{W}} \qquad ( 38 )$$

$${\vec{f}}_{UAF} = \vec{X} , \frac{\partial {\vec{f}}_{UAF}}{\partial \vec{X}} {\vert}_{W {\vec{Q}}^{0} + \vec{H}} = \vec{1} \qquad ( 39 )$$

$$\frac{\partial {\hat{Y}}^{0}}{\partial \vec{W}} = \vec{1} ⊙ [ {\vec{Q}}^{0} + W \frac{\partial \vec{Q}}{\partial \vec{W}} ] \qquad ( 40 )$$

h. Deleting Neural Connections

When transferring between datasets, the dataset size and the number of inputs could decrease. This might create overfitting, resulting in lower performance. The problem can be alleviated by reducing the amount of trainable parameters via deleting neural connections. The smallest weights of the neural network have the least effect on the output of the neural network, and thus they are deleted by finding the indexes of the 5% smallest weights \vec{i}, \vec{j} and setting those elements W(\vec{i}, \vec{j})) to zero. COO matrix element deletion is described in the Supplementary Material Subsection S.3.A. Deleting too many neural connections could cause the network to get stuck at a local minimum. Repeatedly adding and deleting neural connections at every epoch could cause the loss function to oscillate out of the local minimum and to descend into the global minimum.

Algorithm 2 - Deleting neural connections

R ← randomUniform(0.0,1.0);
R ← elemwiseMulti(R,W);
\vec{i}, \vec{j}← argmin(|R|);
W(\vec{i}, \vec{j}) ←0.0;

To overcome the problem, weights are probabilistically deleted such that larger weights still can be removed, but at a much lower probability than the smaller weights. This is implemented in Algorithm 2, where a random matrix R with the same dimensions as the weighted adjacency matrix W is initialized with random uniform numbers between 0.0 and 1.0. Then, the random matrix element-wise multiplies with the weighted adjacency matrix and the result is saved into the random matrix. Elements in the weighted adjacency matrix are set to zero based on the indexes of the 5% smallest values in the random matrix.

i. Deleting Redundant Neurons

When deleting neural connections, non-zero elements in the weighted adjacency matrix W are deleted. However, some neurons are rendered redundant because they have all of their outputs removed but still have input weights. They can be safely deleted without affecting the neural network's output and performance. Useless neurons are detected by looking at the output degrees Dₒᵤₜ(Pᵢ) of neurons Pᵢ and seeing which neurons have no outputs Dₒᵤₜ(Pᵢ)=0. Subsequently, a determination is made as to whether there are any input neural connections to the useless neurons. If the input degrees are greater than zero, then the neurons' input neural connections/weights are removed by setting the elements in row i to zero w_{i,0}=w_{i,1}=w_{i,2}= . . . =w_{i,N-1}=0. Moreover, deleted neurons have their cell positions \vec{P}ᵢ removed from the master list of all neuron positions.

The difference between deleting redundant neurons and dropout is that dropout randomly deletes neurons and neural connections, which changes the outputs of the neural network/layer. On the other hand, deleting redundant neurons does not change the outputs of the neural network because the redundant neurons are not outputting any information into other neurons.

j. Details of Other Models for Comparison

For the CNN model, one CNN layer and two dense layers were used. The CNN layer has 4 channels, and each channel has a 5×1 convolutional filter. Each dense layer contains twice the amount of neurons as the input size. The hidden layers use the LeakyReLU activation function, while the final layer used the identity activation function. For the MLP model, three dense layers were used, where the number of neurons in each layer equals the input size. For the LSTM model, two LSTM layers and one dense layer for the final layer were used. Each LSTM layer has the same number of neurons as the input size. Moreover, the LSTM layers use the tanh activation function, while the dense layer used the identity activation function. Similar to the LSTM model above, the BiLSTM model has the exact same structure, except the LSTM layers are replaced with BiLSTM layers and the dense layers are twice the size to match the BiLSTM layers. For the GCN2 model, it used four graph convolutional layers and two linear graph layers. As an analog to CNN layers, the graph convolutional layers perform convolutions on the input nodes and edges to predict output nodes. Subsequently, the predicted result is formatted by the linear graph layers. Similar to the GCN2 model, the GCN2LSTM model has the exact same structure, but the graph convolutional layers are replaced with graph LSTM layers. Furthermore, tenfold testing was used to ensure reproducibility. In each fold, the networks were initialized with random weights and were trained accordingly. Afterward, each fold was tested independently to obtain the mean absolute error (MAE) and training time standard deviation.

k. Software Framework

An entirely custom software framework for simulating physical neurons and training BNNs was created. The Rust programming language was chosen because it has compile-time code verification to prevent data races, array indexing errors, and other common programming errors. Moreover, Rust's built-in unit testing is used to ensure each function and module produces the correct outputs given the known inputs. To accelerate the code, Arrayfire for Rust, a parallel computing library for CUDA, OpenCL, and OpenMP devices was used. This enables the software framework to run on Nvidia GPUs/CPUs, AMD GPUs/CPUs, Intel GPUs/CPUs, and Xilinx FPGAs.

### V. Example Computing System Implementing an ANN

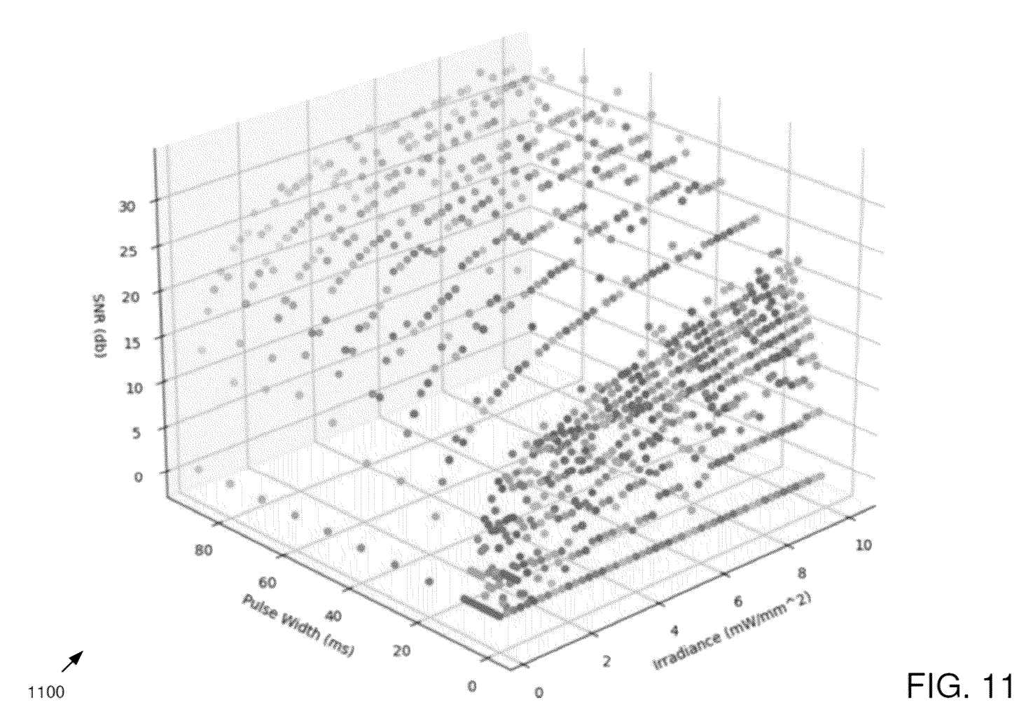

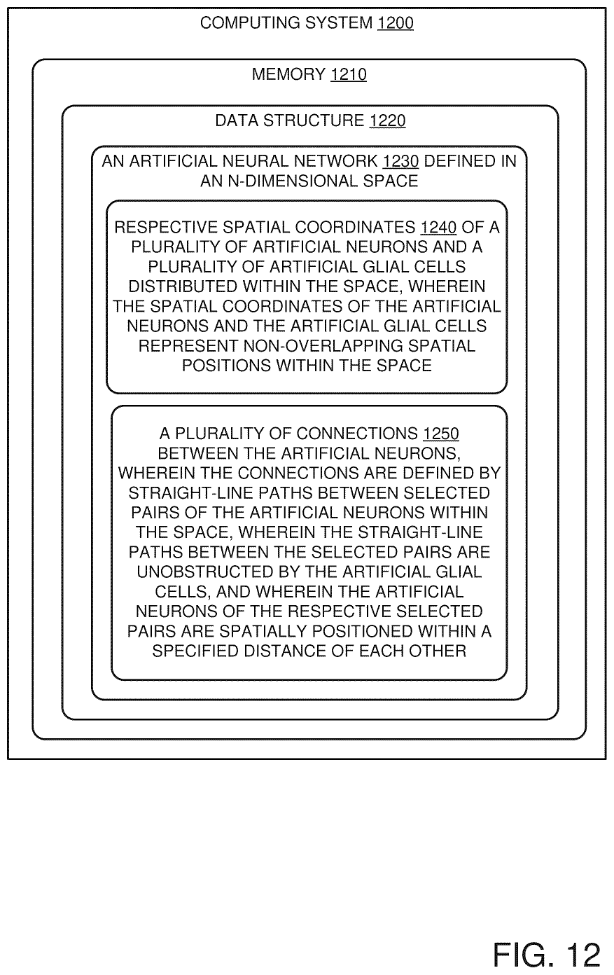

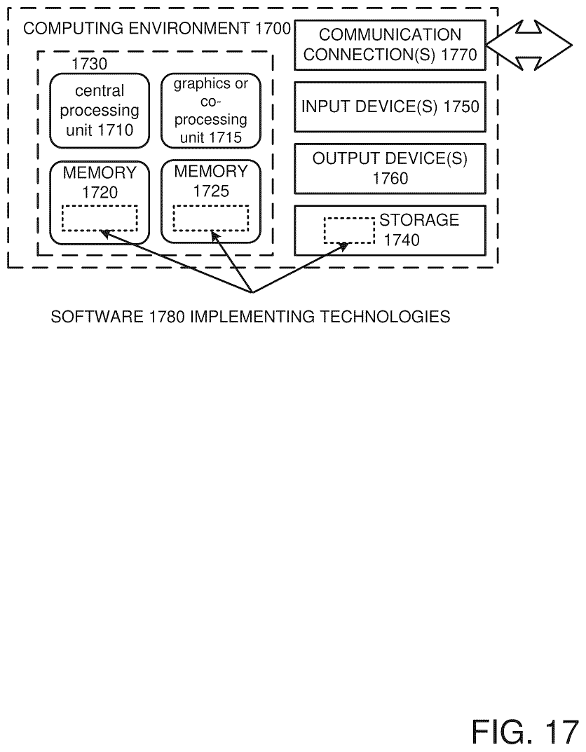

FIG. 12 is a block diagram of an example computing system 1200 implementing an ANN defined in an N-dimensional space in accordance with technologies disclosed herein. In the example, computing system 1200 includes a memory 1210, a data structure 1220, and an ANN 1230; however, other components may also be included in computing system 1200, such as the components depicted in FIG. 17. For example, computing system 1200 can be implemented using hardware such as CPUs, GPUs, or other processing units, along with software frameworks configured for neural network operations.

In the example, memory 1210 is a tangible storage medium within computing system 1200 that stores the data structure 1220, among other data. Memory 1210 can include volatile memory (e.g., RAM) and non-volatile memory (e.g., flash storage or hard drives). The data structure 1220 can also store additional information which is not depicted in FIG. 12.

As shown, the data structure 1220 defines an ANN 1230 in an N-dimensional space. As described herein, the N-dimensional space can be a 1D, 2D, 3D, or higher-dimensional space (e.g., a 3D sphere). The ANN 1230 can be designed to support dynamic reconfiguration for transfer learning via expansion or contraction of the N-dimensional space and scaling of the spatial coordinates of the artificial neurons and the artificial glial cells in proportion to the expansion or contraction. For example, if the N-dimensional space is a 3D sphere which expands in size by 10%, the spatial coordinates (and thus, the spatial positions) of the artificial neurons and the artificial cells can be scaled 10% such that they are positioned 10% further outward in the radial direction.

In the example, the ANN 1230 includes respective spatial coordinates 1240 of a plurality of artificial neurons and a plurality of artificial glial cells distributed within the space; as indicated, the spatial coordinates 1240 represent non-overlapping spatial positions within the space. The artificial neurons can include artificial input neurons, artificial output neurons, and artificial hidden neurons.

The spatial positions represented by the spatial coordinates 1240 of the artificial neurons and the artificial glial cells can be randomly distributed within the N-dimensional space. The random distribution can be a uniform distribution, a statistical distribution, a patterned distribution, or another type of random distribution.

The spatial coordinates of the artificial input neurons can represent spatial positions within a first region of the space, and the spatial coordinates of the artificial output neurons represent spatial positions within a second region of the space that is distinct from the first region. Further, the spatial coordinates of the artificial hidden neurons and the artificial glial cells can represent spatial positions within a third region of the space disposed between the first region and the second region.

In some examples, the spatial coordinates of the artificial input neurons represent spatial positions within an outer region of the space, the spatial coordinates of the artificial output neurons represent spatial positions within a center region of the space, and the spatial coordinates of the artificial hidden neurons and the artificial glial cells represent spatial positions within an interior region of the space disposed between the outer region and the center region. In such examples, the outer region of the space can be an outer surface of the space, and the artificial input neurons can be positioned to occupy a same solid angle of the outer surface of the space, such that the artificial input neurons can be connected to the artificial hidden neurons in the interior region of the space without bias.

The ANN 1230 further includes a plurality of connections 1250 between the artificial neurons. In the example, the connections 1250 are defined by straight-line paths between selected pairs of artificial neurons within the N-dimensional space. The straight-line paths between the selected pairs are unobstructed by the artificial glial cells, thereby ensuring that the connections 1250 are valid and functional.

Further, the artificial neurons of the respective selected pairs are spatially positioned within a specified distance of each other. For example, during a design or setup phase of the ANN 1230, the specified distance can be selected and set by a designer or user. During this phase, each artificial neuron can attempt to form connections with other neurons located within a specified distance (e.g., a Euclidean distance). As described herein, a connection between two artificial neurons located within the specified distance of each other is formed only if no glial cell intersects the straight-line path between them; if a glial cell lies along this path, the connection is blocked and not established.

In some examples, the connections 1250 and associated connection weights are encoded in a sparse weighted adjacency matrix stored in the data structure to optimize memory usage and computational efficiency. In other examples, the connections 1250 and their connection weights can be encoded in a different type of matrix or stored in another manner. As described herein, a sparse weighted adjacency matrix can be used to optimize memory usage and computational efficiency.

Any of the systems herein, including the computing system 1200, can comprise at least one hardware processor and at least one memory coupled to the at least one hardware processor.

The system 1200 can also comprise one or more non-transitory computer-readable media having stored therein computer-executable instructions that, when executed by the computing system, cause the computing system to perform any of the methods described herein.

In practice, the systems shown herein, such as system 1200, can vary in complexity, with additional functionality, more complex components, and the like. Additional components can be included to implement security, redundancy, load balancing, report design, and the like.

The described computing systems can be networked via wired or wireless network connections, including the Internet. Alternatively, systems can be connected through an intranet connection (e.g., in a corporate environment, government environment, or the like).

The system 1200 and any of the other systems described herein can be implemented in conjunction with any of the hardware components described herein, such as the computing systems described below (e.g., processing units, memory, and the like). In any of the examples herein, the data structure 1220, the ANN 1230, and the like can be stored in one or more computer-readable storage media or computer-readable storage devices. The technologies described herein can be generic to the specifics of operating systems or hardware and can be applied in any variety of environments to take advantage of the described features.

### VI. Example Computer-Implemented Methods for Implementing an ANN and Transferring Learning

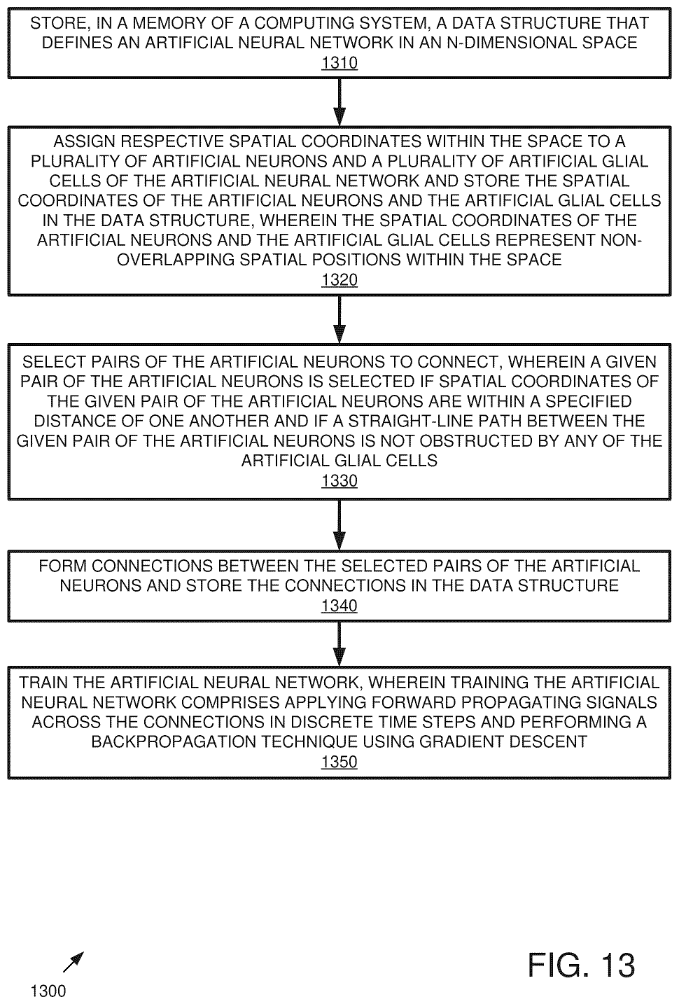

FIG. 13 is a flowchart of an example computer-implemented method 1300 for implementing an ANN and can be performed, for example, by the system of FIG. 12.

In the example, at 1310, the method includes storing, in a memory of a computing system, a data structure that defines an ANN in an N-dimensional space (e.g., data structure 1220 of FIG. 12).

At 1320, the method includes assigning respective spatial coordinates within the space to a plurality of artificial neurons and a plurality of artificial glial cells of the ANN, as well as storing the spatial coordinates of the artificial neurons and the artificial glial cells in the data structure. The spatial coordinates of the artificial neurons and the artificial glial cells represent non-overlapping spatial positions within the space. For example, during a design phase of the ANN, the artificial neurons and the artificial glial cells can be randomly distributed within the space (e.g., assigned random spatial coordinates) and then any intersecting cells can be removed.

At 1330, the method includes selecting pairs of the artificial neurons to connect. A given pair of the artificial neurons is selected if their spatial coordinates lie within a specified distance of one another and if a straight-line path between them is not obstructed by any of the artificial glial cells. This selection process can advantageously support biologically-inspired sparsity while ensuring valid and functional neural connections.

At 1340, the method includes forming connections between the selected pairs of the artificial neurons and storing the connections in the data structure.

At 1350, the method includes training the ANN. The training can include applying forward propagating signals across the connections in discrete time steps and performing a backpropagation technique using gradient descent. The discrete time steps can be synchronous, such that the signals are propagated in synchronous discrete time steps across the artificial neurons.

In some examples, training the ANN further includes performing the backpropagation technique using gradient descent to update one or more of connection weights, artificial neuron biases, and trainable parameters of an activation function implemented by the artificial neurons. Optionally, after the training of the ANN, the method can include removing any of the connections that have connection weights below a predefined threshold connection weight and/or removing artificial neurons that are not connected to other artificial neurons via the connections.

After the training process, the ANN can be applied to perform inference. As described herein, performing inference using the trained ANN can include applying forward propagating signals across the connections in discrete time steps and updating states of the artificial neurons at one or more of the discrete time steps. Similar to the discrete time steps described above with reference to the training phase, the discrete time steps of the inference phase can be synchronous, such that the signals are propagated in synchronous discrete time steps across the artificial neurons.

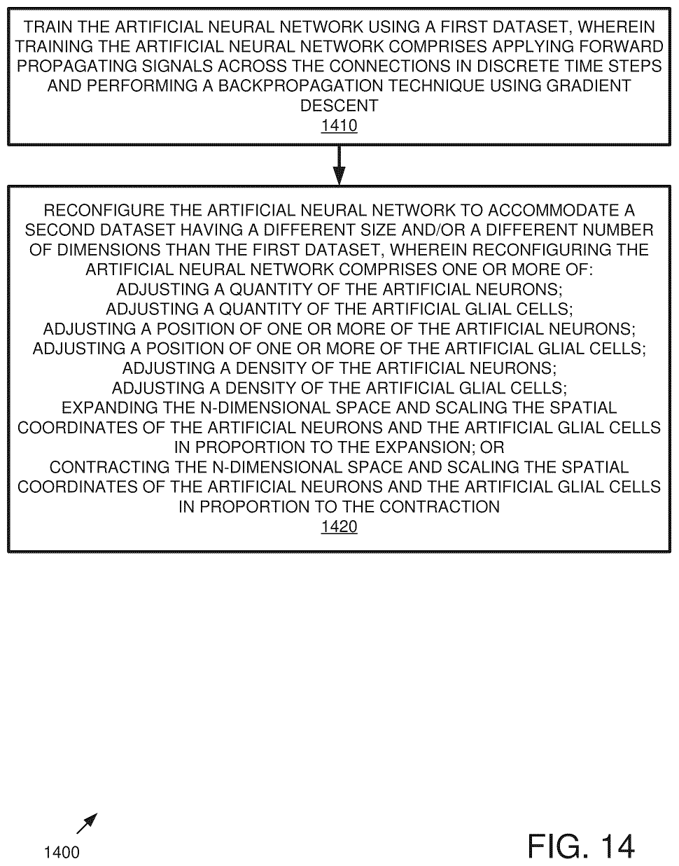

FIG. 14 is a flowchart of an example computer-implemented method 1400 for performing transfer learning using an ANN. Method 1400 can be performed in conjunction with method 1300: for example, method 1400 can be performed after step 1340 of method 1300, such that steps 1410 and 1420 replace step 1350 of method 1300. As described herein, transfer learning is supported by the disclosed ANNs, enabling dynamic reconfiguration of the network through modifications in the number of artificial input neurons, artificial output neurons, artificial hidden neurons, and artificial glial cells. This can include operations such as artificial neuron growth or shrinkage, data densification or sparsification, and the addition or removal of artificial neurons and/or connections between artificial neurons.

At 1410, the method includes training the ANN using a first dataset, wherein training the ANN includes applying forward propagating signals across the connections in discrete time steps and performing a backpropagation technique using gradient descent.

At 1420, the method incudes reconfiguring the ANN to accommodate a second dataset having a different size and/or a different number of dimensions than the first dataset. Reconfiguring the ANN can include one or more of: adjusting a quantity of the artificial neurons; adjusting a quantity of the artificial glial cells; adjusting a position of one or more of the artificial neurons; adjusting a position of one or more of the artificial glial cells; adjusting a density of the artificial neurons; adjusting a density of the artificial glial cells; expanding the N-dimensional space and scaling the spatial coordinates of the artificial neurons and the artificial glial cells in proportion to the expansion; or contracting the N-dimensional space and scaling the spatial coordinates of the artificial neurons and the artificial glial cells in proportion to the contraction.

In some examples, the second dataset has a larger size and/or a larger number of dimensions than the first dataset. In such examples, the N-dimensional space can be expanded to accommodate the second dataset, and reconfiguring the ANN can further include assigning respective spatial coordinates to additional artificial neurons and additional artificial glial cells within the expanded N-dimensional space, where the spatial coordinates of the additional artificial neurons and the additional artificial glial cells represent non-overlapping spatial positions within the space.

Further, in some examples, the second dataset is a concatenation of the first dataset and additional data. In such examples, reconfiguring the ANN can further include relocating the spatial coordinates of the artificial neurons to a first region of the N-dimensional space while retaining the connections, and assigning additional artificial neurons to a second region of the N-dimensional space distinct from the first region.

Furthermore, in some examples, the second dataset has a smaller size and/or a smaller number of dimensions than the first dataset. In such examples, the N-dimensional space can be contracted to accommodate the second dataset. In such examples, reconfiguring the ANN can further include one or more of: removing one or more of the artificial neurons, removing one or more of the artificial glial cells; removing one or more of the connections based on corresponding connection weights; or redistributing one or more of the connections to other pairs of the artificial neurons.

### VII. Machine Learning Models Implementation with Optogenetically Modified Neurons

### 1. Background

State-of-the-art large language models such as GPT-2 and GPT-3 have 1.5 billion and 175 billion trainable parameters respectively. On the other side, LLaMA and LLaMA 2 have 65 billion and 70 billion trainable parameters respectively. These neural networks require thousands of GPUs to train, which in turn consume megawatts to gigawatts of power for long periods of time. Meanwhile, the human brain has 100 trillion connections but only consumes 17 W of power and can learn new skills in a short amount of time. Researchers have exploited the power efficiency of real BNNs to perform various tasks at a significantly lower power. One group of researchers trained human neurons to play a ping pong video game. The game states are translated into electrical pulses and are input into the neurons via multiple electrodes. The rectangular electrodes are arranged in a 2D grid array, where each electrode physically touches a neuron. Moreover, the array of electrodes also receive the output electrical signals of the neurons, which are translated into paddle movements in the game. For training, the researchers repeat the same input patterns over and over again to the neurons. At the same time, the researchers reward the human neurons with electrical stimulus if the neurons output the correct action. This allows the human neurons to recognize the same input patterns and perform the correct action.

Using a grid array of electrodes has many disadvantages. The biological neurons constantly move and change positions. As the array of electrodes relies on physical contact to transmit electrical pulses, the neuron movements break the physical contact with the electrodes. This creates intermittent signal losses, which is not ideal for training neurons. Moreover, the electrodes are made of metals that corrode over time in the cell medium. This also degrades signal integrity and poisons the neurons with heavy metals. The array of electrodes also has to be sterilized or disposed of to prevent diseases from spreading between batches of neurons.

### 2. Example Method for Training Biological Neurons

Optogenetics and calcium imaging can solve the problems above by providing a way to interact with the neurons without any physical contact. In optogenetics, photons can stimulate or inhibit neurons from afar. This eliminates the intermittent physical contact problem and the metal poisoning problem. Moreover, the same setup can be reused without the fear of a disease spreading between batches of neurons. With these tools, BNNs can be trained to perform a variety of tasks.

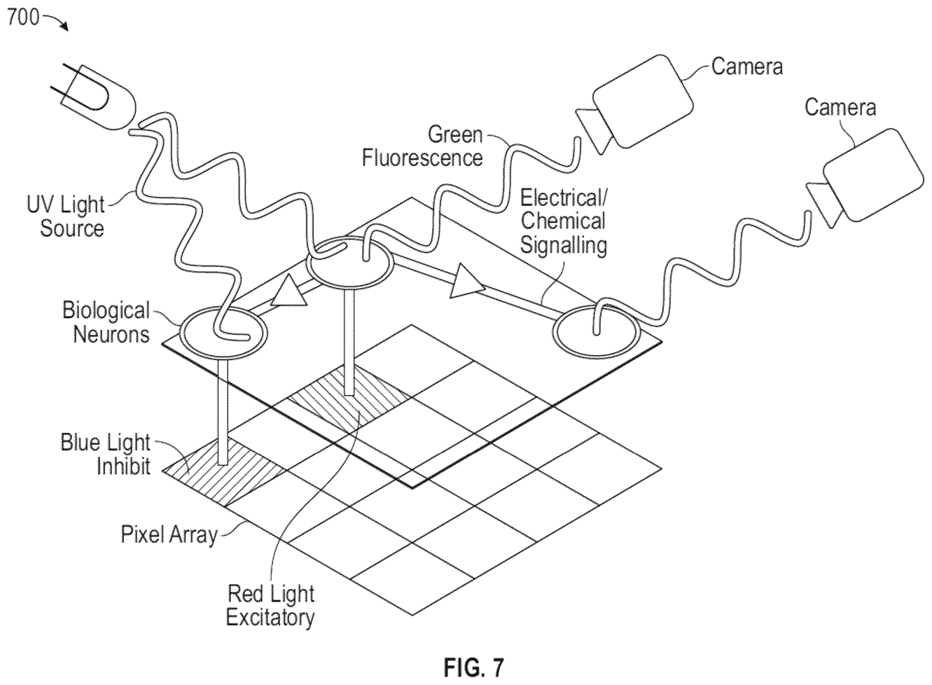

Inspired by the RayBNN model, FIG. 7 shows an example optogenetics setup for training biological neurons. Firstly, the biological neurons are transfected with optogenetic AAVs that control the pumps and channels of the neurons. There are two main types of control over the neurons: excitatory optogenetic genes that increase the probability of neuron firing when exposed to enough photons of a certain wavelength of light (e.g., red light), and inhibitory optogenetic genes that decrease the probability of neuron firing when exposed to enough photons of a certain wavelength of light (e.g., blue light). In some examples, each neuron is genetically transfected with both an excitatory and an inhibitory opsin, enabling bidirectional control using different wavelengths of light. An opsin can also be described as a light-activated protein.

Typically, one wavelength is assigned to excitatory signals and a different wavelength is assigned to inhibitory signals. In the case of excitatory optogenetic genes, if a neuron absorbs enough photons, then the neuron activates the channels and pumps. Upon activation, the neuron outputs an electrical pulse or neurotransmitters to the other neurons. The activation of the pumps and channels also increases levels of certain ions (e.g., Calcium(2+) ion levels) in the somas and axons of the neurons. In the case of inhibitory optogenetic genes, if a neuron absorbs enough photons, then the channels and pumps inhibits the neurons from firing. No matter how much stimulation or excitation the neurons receive, they are not inclined to fire. While inhibited, the ion levels remain low in the neurons.

The excitation and inhibition wavelengths depend on the specific opsin and indicator used. Yellow/blue or blue/red light can be used to control excitatory and inhibitory opsins, whereas red light or near-infrared light can be used to probe neuronal firing (e.g., calcium release). Other combinations of opsins and light wavelengths may also be possible, depending on the choice of AAVs. Alternatively, a single type of opsin (excitatory or inhibitory) may also be used.

Ion imaging, such as calcium imaging, can be performed to measure the output signals of the neurons without any physical contact. For example, in calcium imaging, a change in Calcium(2+) levels indicates high levels of neuronal activity, while no change in Calcium(2+) levels indicates very little neuronal activity. Typically, a UV light with constant power illuminates the sample, while a high-speed camera measures the fluorescent microscopy of the neurons.

There are two main methods for calcium imaging: temporary fluorescent dyes or permanent biosensor AAVs. Temporary fluorescent dyes are taken up by the neurons very quickly. Upon adding the fluorescent dyes to the cell medium, the calcium imaging can begin within 45 mins. However, the temporary fluorescent dyes only last 15 mins at most because the fluorescent dyes decays rapidly under UV light. On the other hand, neurons inoculated with biosensor AAVs have permanent biosensor genes. After waiting a few weeks, the biosensor genes are fully expressed and the calcium imaging experiments can begin. This time, biosensor genes last for the entire lifetime of the individual cell, and it can be carried into daughter cells as well. As a result, biosensor AAVs can survive for months or years.

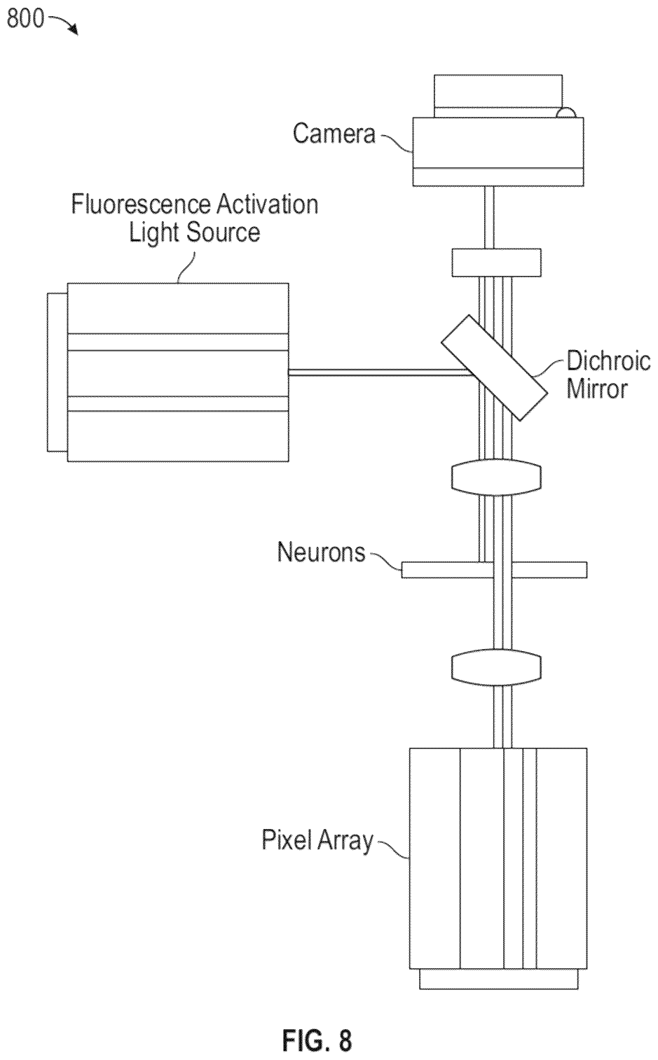

FIG. 8 shows an example hardware setup for training BNNs. For calibrating the setup, the pixel array displays calibration images that consist of ArUco markers and a checkerboard. In practice, a data projector can implement the pixel array by emitting colored pixels to activate inhibitory/excitatory opsins. The ArUco markers are arranged in an evenly spaced 2D grid and each marker has a unique position such as (0,0), (1,0), (0,1), and so on. By reading the positions of multiple markers, the position, rotation, and scale of the high-speed camera's viewport can be determined. Moreover, the camera's lens distortion can be calculated using the edges from the checkerboard image. After calibration, the camera detects the positions of the neurons and their axons. Then, the camera instructs the pixel array to send photons to each neuron's specific location. Red light is used for exciting specific neurons at certain locations, while blue light is used for inhibiting neurons.

Input data from the pixel array to the neurons uses a pulse width modulation scheme. For example, the value “0” can be encoded as a very short pulse width, such as 5 ms and the value “1” can be encoded as a long pulse width, such as 50 ms. This allows for the control of specific neurons because the long pulse widths have a higher probability of neuron firing than shorter pulse widths. Furthermore, the pixel array has fine grain control over the photon intensity. For the case of excitatory optogenetics, increasing the light intensity will increase the probability of neuron firing, while decreasing the light intensity will decrease neuron firing. This will allow the pixel array to precisely control individual neurons for training the network.

In the example, a fluorescence activation light source, a green band pass filter, and a high-speed camera are used to obtain outputs from the neurons. The fluorescence activation light source can be a UV light source with an activation filter, or a source of another type of light that activates fluorescence. The entire neural network is first illuminated with a constant intensity light from the fluorescence activation light source. Whenever a neuron fires or activates, it releases some Calcium(2+) ions. Upon the fluorescent dye detecting the Calcium(2+) ions, it absorbs the light from the fluorescence activation light source and re-emits them as green light. The emission of green light can be detected by a high-speed camera, which in turn indicates the neuron has fired. Furthermore, the light from the fluorescence activation light source, red light, and blue light are filtered out by the green band pass filter to prevent superfluous signals from reaching the high-speed camera and to increase the SNR of the images. In some examples, the high-speed camera is connected to a microscope in order to visualize microscopic samples such as neurons.

In practice, the data projector may be controlled via a computing system, which may include an interface controller (e.g., a single-board computer such as a Raspberry Pi) configured to communicate with other components of the computing system. The computing system may be configured to receive the neuronal topology and signal data from the high-speed camera, which may be optically coupled to a microscope. The high-speed camera may be used to record the spatial positions of the neurons as well as to record neuronal firing signals. The high-speed camera may connect to the computing system via a communication interface (e.g., a USB interface), and the computing system may perform processing and analysis of the data recorded by the high-speed camera. Further, the computing system may be configured to train the BNN to determine optimal model weights, convert the model weights into a color/intensity image, and send the image to the data projector (e.g., via the interface controller). The data projector may then project the image onto the neurons to effect optogenetic stimulation at specific spatial locations.

For setting the weights in a BNN, an ANN can first be trained in a simulation. After optimizing the weights of the ANN, the weights can be translated to the BNN using the following method. For every positive weight in the ANN, red photons can be illuminated onto the equivalent neurons in the BNN. For every negative weight in the ANN, blue photons can be illuminated onto the equivalent neurons in the BNN. Afterwards, the predicted output from the neurons can be compared to the targeted output. Neurons that were expected to fire but did not fire can be illuminated with red photons to increase the probability of firing. Neurons that were expected to not fire but did fire can be illuminated with blue photons to decrease the probability of firing. Moreover, a gradient descent algorithm can be applied to optimize the intensities of the red photons and blue photons. In this way, the BNNs can be trained similarly to ANNs.

### 3. Simulations

### 3.1. Hodgkin-Huxley Neuron Model

The Hodgkin-Huxley model is one of the most widely simulated models in neuroscience.

Created by Alan Hodgkin and Andrew Huxley after analyzing squid neurons, the input to the model is the injected current I_{c}(t) that charges a capacitor Cₘ. The voltage of the capacitor Cₘ is denoted as the membrane voltage Vₘ, where it represents the difference between the interior of the soma and the extracellular medium. αₙ(V), αₘ(V), αₕ(V) represents the rate constant for K+ channel opening, Na+ activation gate opening, and Na+ inactivation gate opening. The rate constants control how much the ions charges can flow out from the capacitor Cₘ.

On the other hand, βₙ(V), βₘ(V), βₕ(V) represents the rate constant for K+ channel closing, Na+ activation gate closing, and Na+ inactivation gate closing. These mathematical functions control the rate limits of the corresponding ion channels to prevent them from going to infinity.

$${α}_{n} ( V ) = \frac{0.02 ( V - 25. )}{- 1. - {e}^{( \frac{( V - 25. )}{9.} )}}$$

$${β}_{n} ( V ) = \frac{- 0.0 \; 02 ( V - 25. )}{1 \text{.0} - {e}^{( \frac{V - 25. )}{9.} )}}$$

$${α}_{m} ( V ) = \frac{0.1 \; 82 ( V + 35. )}{1 \text{.0} - {e}^{( \frac{- 1. ( V + 35. )}{9.0} )}}$$

$${β}_{m} ( V ) = - \frac{- 0.124 ( V + 35. )}{1. - {e}^{( \frac{V + 35. )}{9.} )}}$$

$${α}_{h} ( V ) = 0 \text{.25} {e}^{( \frac{- 1. ( V + 90. )}{12.0} )}$$

$${β}_{h} ( V ) = \frac{0 \text{.25} {e}^{( \frac{V + 62. )}{6.} )}}{{e}^{( \frac{V + 90. )}{12.0} )}}$$

To simulate a single neuron, the algorithm has to solve a system of 4 differential equations, where g_{K}, g_{Na}, g_{L} are K+, Na+, leak maximum conductances controlled by the n, m, h potassium, sodium activation, sodium inactivation gate variables. The purpose of the conductances is to regulate how much the ion charges flow in and out from the capacitance Cₘ based on the membrane potential Vₘ and n, m, h gate variables.

$$\frac{d {V}_{m}}{d t} = \frac{- ( {g}_{K} {n}^{4} ( {V}_{m} - {E}_{K} ) ) - ( {g}_{N a} {m}^{3} h ( {V}_{m} - {E}_{N a} ) ) - ( {g}_{L} ( {V}_{m} - {E}_{L} ) ) + {I}_{c ( t )}}{C}$$

$$\frac{d n}{d t} = {a}_{n} ( {V}_{m} ) ( 1.0 - n ) - {β}_{n} ( {V}_{m} ) n$$

$$\frac{d m}{d t} = {a}_{m} ( {V}_{m} ) ( 1.0 - m ) - {β}_{m} ( {V}_{m} ) m$$

$$\frac{d h}{d t} = {a}_{h} ( {V}_{m} ) ( 1.0 - h ) - {β}_{h} ( {V}_{m} ) h$$

### 3.2. Opsin Simulation

There are many kinds of opsins that allow neurons to be stimulated and inhibited by specific wavelengths and intensities of photons.

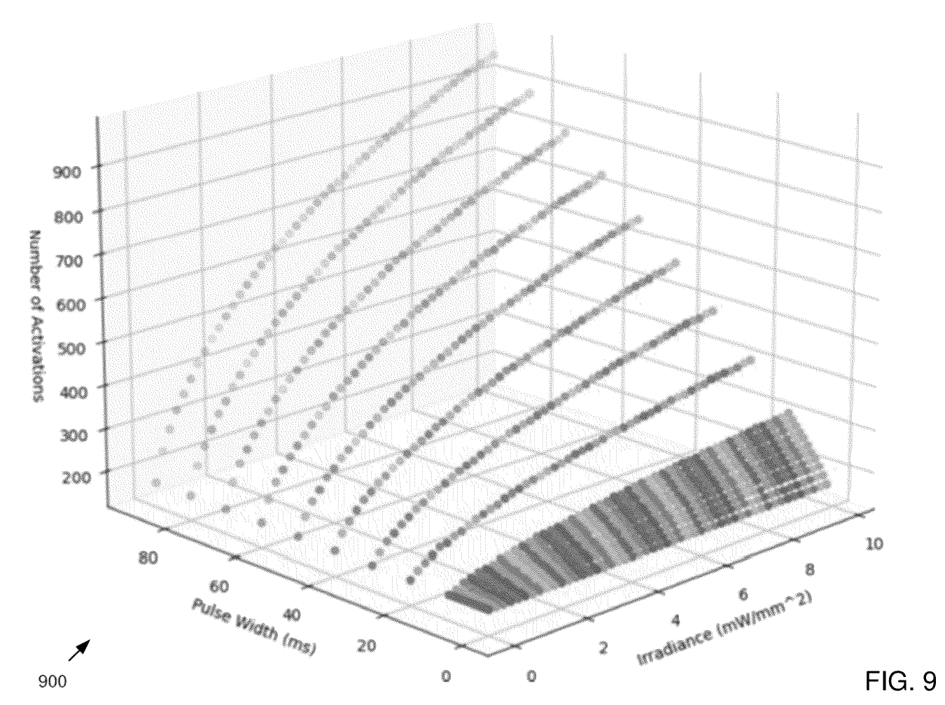

FIG. 9 shows the number of neuron activations versus pulse width and irradiance. As the light irradiance increases, the injected current I_{c}(t) to the neurons increases, which triggers more neuron activations.

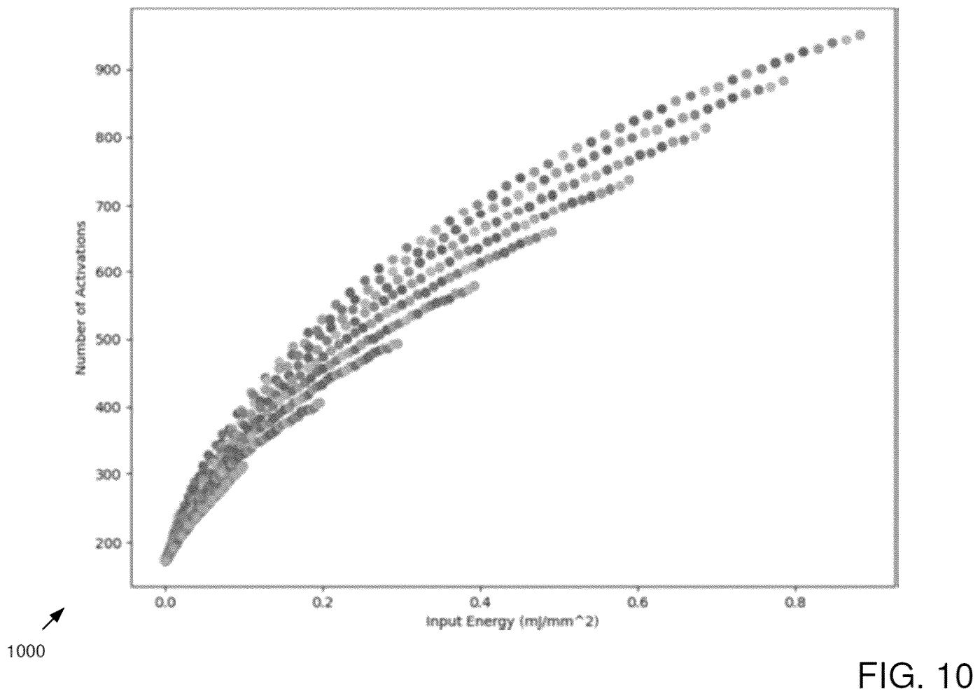

FIG. 10 shows the number of neuron activations versus input energy of the photons. As the input energy increases, the injected current I_{c}(t) to the neurons increases, which triggers more neuron activations.

FIG. 11 shows the signal to noise ratio of the activation versus pulse width and irradiance. Neurons spontaneously fire even if there are no stimulations from the photons. As a result, there is a background noise of random neuron firing. When a strong photon signal is applied to the neurons, it will create a neuron firing pattern above the background noise and that is denoted as the SNR.

### VIII. Example Method for Training Live Biological Neurons to Emulate the Behavior of a Machine Learning Model

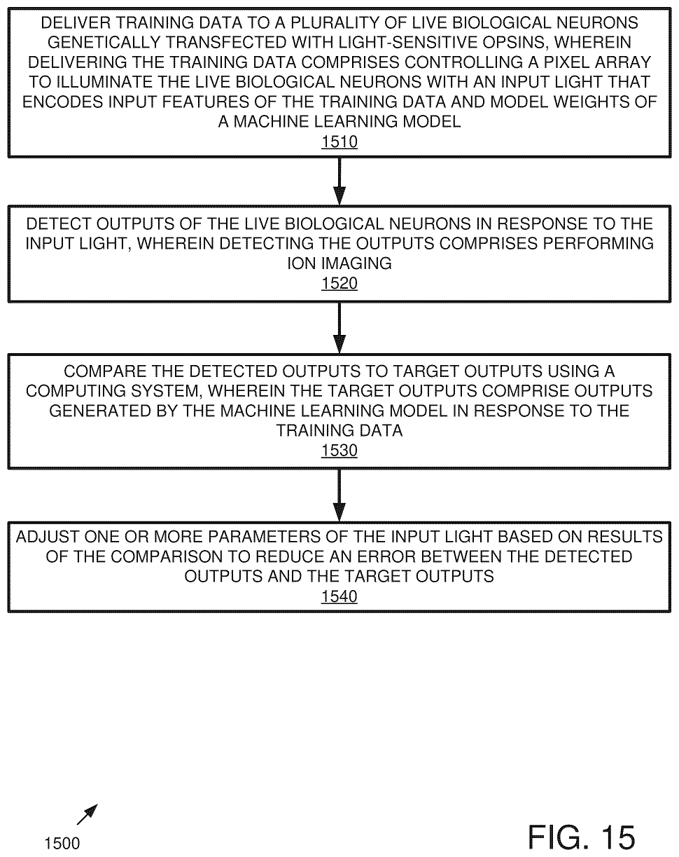

FIG. 15 is a flowchart of an example method 1500 for training live biological neurons to emulate the behavior of a machine learning model. Method 1500 is an example of the optogenetics implementation described herein in which neurons genetically transfected with light-sensitive opsins are used to realize machine learning models, including RayBNN.

In the example, at 1510, the method includes delivering training data to a plurality of live biological neurons genetically transfected with light-sensitive opsins. In some examples, the live biological neurons are genetically transfected with the light-sensitive opsins using optogenetic AAVs.

Delivering the training data can include controlling a pixel array to illuminate the live biological neurons with an input light that encodes input features of the training data and model weights of a machine learning model. For example, model weights and input features can be encoded using light intensity such that one wavelength or color (Color 1) is used to excite neurons, while a different wavelength or color (Color 2) is used to inhibit neuronal activity.

At 1520, the method includes detecting outputs of the live biological neurons in response to the input light. Detecting the outputs can include performing ion imaging. In some examples, output signals are detected via fluorescence emission resulting from neural firing, such as calcium ion release detected through a fluorescence probe. In such examples, performing the ion imaging can include measuring and quantifying fluorescence emitted by the live biological neurons, where the fluorescence is produced in response to ion release from the live biological neurons. The fluorescence can be produced by a biosensor AAV that has been genetically transfected into the live biological neurons, by an ion-sensitive fluorescent dye that has been taken up by the live biological neurons, or in another manner.

At 1530, the detected outputs are compared to target outputs using a computing system. The target outputs can include outputs generated by the machine learning model in response to the training data.

At 1540, the method includes adjusting one or more parameters of the input light based on results of the comparison to reduce an error between the detected outputs and the target outputs. The one or more parameters can include one or more of light intensity, wavelength, and pulse duration. Optionally, variations in the one or more parameters can encode numerical values of the input features or the model weights.

As described herein, training the live biological neurons can produces a trained BNN that emulates the behavior of a machine learning model, such that the trained BNN can be used to perform a computational task. In some examples, the live biological neurons can be trained to emulate the behavior of an ANN defined in a 2D space or a 3D space, such as the RayBNN described herein.

### IX. Example Experimental Results

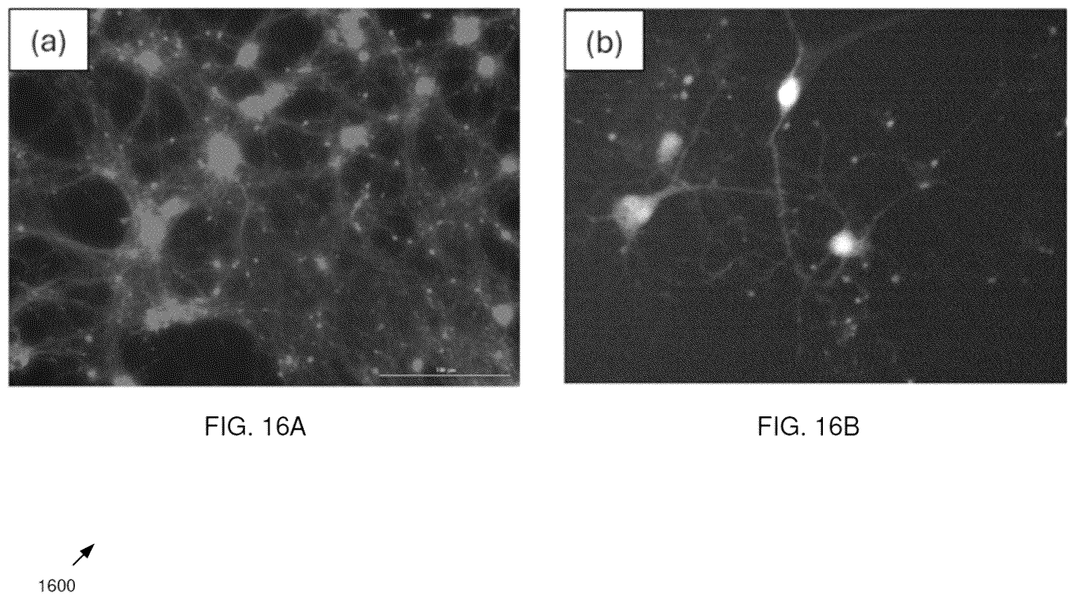

Cortical and hippocampal neurons have been successfully cultured and genetically transfected with opsins using AAV vectors in accordance with disclosed techniques. The optogenetically induced fluorescence in the neurons is clearly observable under the microscope. For example, FIG. 16a is a fluorescence microscopy image showing calcium ion activity in neurons and their network connections captured using a commercial microscope, whereas FIG. 16b is a fluorescence microscopy image showing calcium ion activity in neurons and their network connections captured using the disclosed optogenetic AI control/probe system. Accordingly, the inventors herein have developed the hardware necessary to optically stimulate the neurons and detect their responses.

### X. Example Implementations

Clause 1. A computing system implementing an artificial neural network, the computing system comprising: a memory in the computing system storing a data structure that defines the artificial neural network in an N-dimensional space, wherein the artificial neural network comprises: respective spatial coordinates of a plurality of artificial neurons and a plurality of artificial glial cells distributed within the space, wherein the spatial coordinates of the artificial neurons and the artificial glial cells represent non-overlapping spatial positions within the space; and a plurality of connections between the artificial neurons, wherein the connections are defined by straight-line paths between selected pairs of the artificial neurons within the space, wherein the straight-line paths between the selected pairs are unobstructed by the artificial glial cells, and wherein the artificial neurons of the respective selected pairs are spatially positioned within a specified distance of each other.
Clause 2. The computing system of Clause 1, wherein the artificial neural network is configured to support dynamic reconfiguration for transfer learning via expansion or contraction of the N-dimensional space and scaling of the spatial coordinates of the artificial neurons and the artificial glial cells in proportion to the expansion or contraction.
Clause 3. The computing system of Clause 1 or Clause 2, wherein the artificial neurons comprise artificial input neurons, artificial output neurons, and artificial hidden neurons.
Clause 4. The computing system of Clause 3, wherein: the spatial coordinates of the artificial input neurons represent spatial positions within a first region of the space; the spatial coordinates of the artificial output neurons represent spatial positions within a second region of the space that is distinct from the first region; and the spatial coordinates of the artificial hidden neurons and the artificial glial cells represent spatial positions within a third region of the space disposed between the first region and the second region.
Clause 5. The computing system of Clause 3 or Clause 4, wherein: the spatial coordinates of the artificial input neurons represent spatial positions within an outer region of the space; the spatial coordinates of the artificial output neurons represent spatial positions within a center region of the space; and the spatial coordinates of the artificial hidden neurons and the artificial glial cells represent spatial positions within an interior region of the space disposed between the outer region and the center region.
Clause 6. The computing system of Clause 5, wherein: the outer region of the space comprises an outer surface of the space; and the artificial input neurons are positioned to occupy a same solid angle of the outer surface of the space, such that the artificial input neurons can be connected to the artificial hidden neurons in the interior region of the space without bias.
Clause 7. The computing system of any one of Clauses 1-6, wherein the connections and associated connection weights are encoded in a sparse weighted adjacency matrix stored in the data structure.
Clause 8. The computing system of any one of Clauses 1-7, wherein the spatial positions represented by the spatial coordinates of the artificial neurons and the artificial glial cells are randomly distributed within the N-dimensional space.
Clause 9. The computing system of any one of Clauses 1-8, wherein the N-dimensional space comprises a three-dimensional space.
Clause 10. The computing system of Clause 9, wherein the three-dimensional space comprises a sphere.
Clause 11. A computer-implemented method for implementing an artificial neural network, comprising: storing, in a memory of a computing system, a data structure that defines an artificial neural network in an N-dimensional space; assigning respective spatial coordinates within the space to a plurality of artificial neurons and a plurality of artificial glial cells of the artificial neural network and storing the spatial coordinates of the artificial neurons and the artificial glial cells in the data structure, wherein the spatial coordinates of the artificial neurons and the artificial glial cells represent non-overlapping spatial positions within the space; selecting pairs of the artificial neurons to connect, wherein a given pair of the artificial neurons is selected if spatial coordinates of the given pair of the artificial neurons are within a specified distance of one another and if a straight-line path between the given pair of the artificial neurons is not obstructed by any of the artificial glial cells; forming connections between the selected pairs of the artificial neurons and storing the connections in the data structure; and training the artificial neural network, wherein training the artificial neural network comprises applying forward propagating signals across the connections in discrete time steps and performing a backpropagation technique using gradient descent.
Clause 12. The method of Clause 11, further comprising: performing inference using the trained artificial neural network, wherein performing the inference comprises applying forward propagating signals across the connections in discrete time steps and updating states of the artificial neurons at one or more of the discrete time steps.
Clause 13. The method of Clause 11 or Clause 12, wherein the discrete time steps are synchronous, such that the signals are propagated in synchronous discrete time steps across the artificial neurons.
Clause 14. The method of any one of Clauses 11-13, wherein: training the artificial neural network further comprises performing the backpropagation technique using gradient descent to update one or more of connection weights, artificial neuron biases, and trainable parameters of an activation function implemented by the artificial neurons, and the method further comprises, after training the artificial neural network, performing one or more of the following: removing any of the connections that have connection weights below a predefined threshold connection weight; or removing artificial neurons that are not connected to other artificial neurons via the connections.
Clause 15. The method of any one of Clauses 11-14, further comprising performing transfer learning by reconfiguring the trained artificial neural network, wherein reconfiguring the trained artificial neural network comprises one or more of: adjusting a quantity of the artificial neurons; adjusting a quantity of the artificial glial cells; adjusting a position of one or more of the artificial neurons; adjusting a position of one or more of the artificial glial cells; adjusting a density of the artificial neurons; adjusting a density of the artificial glial cells; expanding the N-dimensional space and scaling the spatial coordinates of the artificial neurons and the artificial glial cells in proportion to the expansion; or contracting the N-dimensional space and scaling the spatial coordinates of the artificial neurons and the artificial glial cells in proportion to the contraction.
Clause 16. The method of Clause 15, wherein the artificial neural network is trained using a first dataset, and wherein the trained artificial neural network is reconfigured to accommodate a second dataset having a different size and/or a different number of dimensions than the first dataset.
Clause 17. One or more non-transitory computer-readable media comprising computer-executable instructions that, when executed by a computing system, cause the computing system to perform operations comprising: storing, in a memory of the computing system, a data structure that defines an artificial neural network in an N-dimensional space; assigning respective spatial coordinates within the space to a plurality of artificial neurons and a plurality of artificial glial cells of the artificial neural network and storing the spatial coordinates of the artificial neurons and the artificial glial cells in the data structure, wherein the spatial coordinates of the artificial neurons and the artificial glial cells represent non-overlapping spatial positions within the space; selecting pairs of the artificial neurons to connect, wherein a given pair of the artificial neurons is selected if spatial coordinates of the given pair of the artificial neurons are within a specified distance of each other and if a straight-line path between the given pair of the artificial neurons is not obstructed by any of the artificial glial cells; forming connections between the selected pairs of the artificial neurons and storing the connections in the data structure; training the artificial neural network using a first dataset, wherein training the artificial neural network comprises applying forward propagating signals across the connections in discrete time steps and performing a backpropagation technique using gradient descent; and reconfiguring the artificial neural network to accommodate a second dataset having a different size and/or a different number of dimensions than the first dataset, wherein reconfiguring the artificial neural network comprises one or more of: adjusting a quantity of the artificial neurons; adjusting a quantity of the artificial glial cells; adjusting a position of one or more of the artificial neurons; adjusting a position of one or more of the artificial glial cells; adjusting a density of the artificial neurons; adjusting a density of the artificial glial cells; expanding the N-dimensional space and scaling the spatial coordinates of the artificial neurons and the artificial glial cells in proportion to the expansion; or contracting the N-dimensional space and scaling the spatial coordinates of the artificial neurons and the artificial glial cells in proportion to the contraction.
Clause 18. The computer-readable media of Clause 17, wherein: the second dataset has a larger size and/or a larger number of dimensions than the first dataset; the N-dimensional space is expanded to accommodate the second dataset; reconfiguring the artificial neural network further comprises assigning respective spatial coordinates to additional artificial neurons and additional artificial glial cells within the expanded N-dimensional space; and the spatial coordinates of the additional artificial neurons and the additional artificial glial cells represent non-overlapping spatial positions within the space.
Clause 19. The computer-readable media of Clause 17 or Clause 18, wherein: the second dataset comprises a concatenation of the first dataset and additional data; and reconfiguring the artificial neural network further comprises: relocating the spatial coordinates of the artificial neurons to a first region of the N-dimensional space while retaining the connections; and assigning additional artificial neurons to a second region of the N-dimensional space distinct from the first region.
Clause 20. The computer-readable media of any one of Clauses 17-19, wherein: the second dataset has a smaller size and/or a smaller number of dimensions than the first dataset; the N-dimensional space is contracted to accommodate the second dataset; and reconfiguring the artificial neural network further comprises one or more of: removing one or more of the artificial neurons; removing one or more of the artificial glial cells; removing one or more of the connections based on corresponding connection weights; or redistributing one or more of the connections to other pairs of the artificial neurons.
Clause 21. A method for training live biological neurons to emulate the behavior of a machine learning model, comprising: delivering training data to a plurality of live biological neurons genetically transfected with light-sensitive opsins, wherein delivering the training data comprises controlling a pixel array to illuminate the live biological neurons with an input light that encodes input features of the training data and model weights of a machine learning model; detecting outputs of the live biological neurons in response to the input light, wherein detecting the outputs comprises performing ion imaging; comparing the detected outputs to target outputs using a computing system, wherein the target outputs comprise outputs generated by the machine learning model in response to the training data; and adjusting one or more parameters of the input light based on results of the comparison to reduce an error between the detected outputs and the target outputs.
Clause 22. The method of Clause 21, wherein the live biological neurons are genetically transfected with the light-sensitive opsins using optogenetic adeno-associated viruses (AAVs).
Clause 23. The method of Clause 21 or Clause 22, wherein: performing the ion imaging further comprises measuring and quantifying fluorescence emitted by the live biological neurons; the fluorescence is produced in response to ion release from the live biological neurons; and the fluorescence is produced by a biosensor AAV that has been genetically transfected into the live biological neurons or an ion-sensitive fluorescent dye that has been taken up by the live biological neurons.
Clause 24. The method of any one of Clauses 21-23, wherein the one or more parameters comprise one or more of light intensity, wavelength, and pulse duration, and wherein variations in the one or more parameters encode numerical values of the input features or the model weights.
Clause 25. The method of any one of Clauses 21-24, wherein training the live biological neurons produces a trained biological neural network that emulates the behavior of the machine learning model, the method further comprising using the trained biological neural network to perform a computational task.
Clause 26. The method of Clause 25, wherein the machine learning model comprises an artificial neural network defined in a two-dimensional space or a three-dimensional space, and wherein the artificial neural network comprises: respective spatial coordinates of a plurality of artificial neurons and a plurality of artificial glial cells distributed within the space, wherein the spatial coordinates of the artificial neurons and the artificial glial cells represent non-overlapping spatial positions within the space; and a plurality of connections between the artificial neurons, wherein the connections are defined by straight-line paths between selected pairs of the artificial neurons within the space, wherein the straight-line paths between the selected pairs are unobstructed by the artificial glial cells, and wherein the artificial neurons of the respective selected pairs are spatially positioned within a specified distance of each other.

### XI. Example Computing Systems

FIG. 17 depicts an example of a suitable computing system 1700 in which the described innovations can be implemented. The computing system 1700 is not intended to suggest any limitation as to scope of use or functionality of the present disclosure, as the innovations can be implemented in diverse computing systems.

With reference to FIG. 17, the computing system 1700 includes one or more processing units 1710, 1715 and memory 1720, 1725. In FIG. 17, this basic configuration 1730 is included within a dashed line. The processing units 1710, 1715 execute computer-executable instructions, such as for implementing the features described in the examples herein. A processing unit can be a general-purpose central processing unit (CPU), processor in an application-specific integrated circuit (ASIC), or any other type of processor. In a multi-processing system, multiple processing units execute computer-executable instructions to increase processing power. For example, FIG. 17 shows a central processing unit 1710 as well as a graphics processing unit or co-processing unit 1715. The tangible memory 1720, 1725 can be volatile memory (e.g., registers, cache, RAM), non-volatile memory (e.g., ROM, EEPROM, flash memory, etc.), or some combination of the two, accessible by the processing unit(s) 1710, 1715. The memory 1720, 1725 stores software 1780 implementing one or more innovations described herein, in the form of computer-executable instructions suitable for execution by the processing unit(s) 1710, 1715.

A computing system 1700 can have additional features. For example, the computing system 1700 includes storage 1740, one or more input devices 1750, one or more output devices 1760, and one or more communication connections 1770, including input devices, output devices, and communication connections for interacting with a user. An interconnection mechanism (not shown) such as a bus, controller, or network interconnects the components of the computing system 1700. Typically, operating system software (not shown) provides an operating environment for other software executing in the computing system 1700, and coordinates activities of the components of the computing system 1700.

The tangible storage 1740 can be removable or non-removable, and includes magnetic disks, magnetic tapes or cassettes, CD-ROMs, DVDs, or any other medium which can be used to store information in a non-transitory way and which can be accessed within the computing system 1700. The storage 1740 stores instructions for the software 1780 implementing one or more innovations described herein.

The input device(s) 1750 can be an input device such as a keyboard, mouse, pen, or trackball, a voice input device, a scanning device, touch device (e.g., touchpad, display, or the like) or another device that provides input to the computing system 1700. The output device(s) 1760 can be a display, printer, speaker, CD-writer, or another device that provides output from the computing system 1700.

The communication connection(s) 1770 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

The innovations can be described in the context of computer-executable instructions, such as those included in program modules, being executed in a computing system on a target real or virtual processor (e.g., which is ultimately executed on one or more hardware processors). Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

For the sake of presentation, the detailed description uses terms like “determine” and “use” to describe computer operations in a computing system. These terms are high-level descriptions for operations performed by a computer and should not be confused with acts performed by a human being. The actual computer operations corresponding to these terms vary depending on implementation.

### XII. Example Computer-Readable Media

Any of the computer-readable media herein can be non-transitory (e.g., volatile memory such as DRAM or SRAM, nonvolatile memory such as magnetic storage, optical storage, or the like) and/or tangible. Any of the storing actions described herein can be implemented by storing in one or more computer-readable media (e.g., computer-readable storage media or other tangible media). Any of the things (e.g., data created and used during implementation) described as stored can be stored in one or more computer-readable media (e.g., computer-readable storage media or other tangible media). Computer-readable media can be limited to implementations not consisting of a signal.

Any of the methods described herein can be implemented by computer-executable instructions in (e.g., stored on, encoded on, or the like) one or more computer-readable media (e.g., computer-readable storage media or other tangible media) or one or more computer-readable storage devices (e.g., memory, magnetic storage, optical storage, or the like). Such instructions can cause a computing system to perform the method. The technologies described herein can be implemented in a variety of programming languages.

### XIII. Example Implementations

Although the operations of some of the disclosed methods are described in a particular, sequential order for convenient presentation, such manner of description encompasses rearrangement, unless a particular ordering is required by specific language set forth herein. For example, operations described sequentially can in some cases be rearranged or performed concurrently.

### XIV. Example Alternatives

The technologies from any example can be combined with the technologies described in any one or more of the other examples. In view of the many possible embodiments to which the principles of the disclosed technology can be applied, it should be recognized that the illustrated embodiments are examples of the disclosed technology and should not be taken as a limitation on the scope of the disclosed technology. Rather, the scope of the disclosed technology includes what is covered by the scope and spirit of the following claims.

### Supplementary Material

### 5.1. Background on Central Nervous System

Unlike ANNs, the human central nervous system (CNS) [S1] dynamically adapts to changing sensory input and evolving objectives. The CNS can compensate for neuron loss due to aging, infections, and injuries by rearranging the neural structure. Moreover, it can create new neurons to increase memory capacity and to learn new skills. Glial cells and neuron cells make up the majority of the CNS, where there are approximately 100 billion glial cells and 100 billion neurons [S2].

Neurons play a huge role in cognitive functions as they are responsible for processing stimulus from sensory input. There are two primary modes of signaling between neurons: electrical signaling and chemical signaling [S3]. The electrical signals are shaped like Gaussian pulses, of which the peak voltage and the pulse width are fixed. Information is encoded in the frequency and the timings of the pulses. Mild stimulus produces low-frequency pulses, while intense stimulus produces high-frequency pulses. Electrical pulses travel_much faster than chemical signals, and thus electrical signals are used for fast responses like motor functions. However electrical signals have very low bandwidth, as they can only operate on a single channel between two neurons. On the other hand, chemical signals like neurotransmitters have a very high bandwidth. Over 200 different neurotransmitters have been discovered [S4] and each neurotransmitter is semi-independent of the other neurotransmitters. This is similar to having 200 independent communication channels between two neurons. Furthermore, electrical pulses can trigger chemical signals and chemical signals can trigger electrical pulses, which leads to many different combinations of interactions.

Neurons have a very complex structure consisting of axons, axon branches, axon terminals, synapses, dendrites, and soma [S5]. Each neuron has only one axon that ranges from 100 μm to 80,000 μm [S6]. However, each axon can split into multiple axon branches, where each axon branch connects two or more neurons. They are also responsible for carrying electrical pulses and neurotransmitters between the neurons. To ensure the transmitted signals do not degrade, the insides of the axons are made out of a low-impedance conductor, while the outsides are wrapped by high-impedance glial cells. On average, there are around 1 to 11 axon branches per neuron [S7], which means each neuron is connected to somewhere between 1 and 11 other neurons. When forming new neural connections, the axon begins by walking in random directions [S8]. Subsequently, the axon might grow branches to search for other neurons in parallel. Glial cells and debris might block the axon. Therefore, the axon has to maneuver around glial cells and debris to reach other neurons. Every neuron releases trace amounts of neurotransmitters to its local area. Upon detecting the local presence of neurotransmitters, the axon branch will follow the traces and connect to the excreting neuron, forming a new neural connection. The probability of a new connection forming depends on the shortest unblocked path between two neurons and the neuron growth factor. Shorter paths between two neurons increase the probability of new connections, while longer paths between neurons decrease the probability of new connections. In early childhood, the neuron growth factor is very high so many new neural connections form. In adulthood, the neuron growth factor is low, and unused axons/axon branches are retracted or eliminated by glial cells. However, new neural connections continuously form throughout the CNS's lifespan.

At the end of each axon branch, multiple axon terminals connect to multiple dendrites.

Each dendrite can have from 1,000 to 10,000 postsynaptic receptors [S9] with each receptor pertaining to a unique neurotransmitter. All dendrites connect to the soma, which is the cell body of the neuron. Functionally, the soma acts as a capacitor that stores the net charge from every postsynaptic receptor [S10] and it has a diameter ranging from 10 μm to 50 μm [S7]. Assuming the extracellular fluid that surrounds all cells in the CNS has a voltage of 0 mV, the soma's voltage is measured relative to the extracellular fluid. Each soma starts with a resting potential of −70 mV. If a neurotransmitter excites the neuron, then the net positive charge and the voltage of the soma increases. If a neurotransmitter inhibits the neuron, then the net positive charge and the voltage of the soma decreases. Every neuron has a unique threshold voltage that controls the firing of that specific neuron. If the voltage of the soma exceeds the threshold voltage, then the neuron fires a 40 mV electrical pulse into the axon. Afterwards, the voltage of the soma drops down to the resting potential.

Glial cells [S111] perform a variety of functions such as guiding newborn neurons into their specific location, supporting and holding neurons in their place, insulating neurons from each other and the extracellular fluid, synchronizing groups of neurons, controlling the abundance of neurotransmitters, repairing neurons, and removing dead neurons. When neurons are born, they have to migrate to their specific region of the CNS. The migration process is guided by glial cells and neurotransmitters [S12]. However, neurons may get misled by other random factors such as infection and debris.

Newborn neurons begin by attaching themselves to radial glial cells and travel alongside glial cells until the neurons reach their approximate destination. Stuck neurons might stay attached to radial glial cells, while other neurons might detach from radial glial cells partway to follow traces of neurotransmitters emitted from older neurons. The rest of the neurons might get lost or die in the process.

As the CNS ages, radial glial cells specialize into astrocytes, oligodendrocytes, microglia, and other glial cells [S11]. Astrocytes hold the neurons in their place and connect them to the blood supply, while simultaneously controlling the concentration of neurotransmitters by breaking them down in the extracellular fluid. Furthermore, astrocytes can synchronize groups of neuron firings by inhibiting individual neurons. Another type of glial cell, the oligodendrocyte, has the unique function of insulating the axon of neurons in the process called myelination [S13]. This is done to prevent the neurotransmitters and electric charges from leaking out into the extracellular fluid. All neurons start without myelination. However, as time progresses, more and more neurons are myelinated to improve the signal integrity and power efficiency of the CNS.

All glial cells can undergo cell division throughout the organism's lifespan to replace damaged or dead cells [S11]. On the other hand, most neurons cannot undergo cell division after adulthood, so they are irreplaceable in the event of a neuron death. As a result, the total number of neurons and neuron connections always decreases after adulthood, in contrast to a stable total number of glial cells.

### S.2. Feature Comparison of Related Models

Some transfer learning methods keep the neural network constant across various datasets, while other methods significantly modify the neural network structure to adapt to new problems. The adaptations can be used to overcome changes in the input dimensions or changes in the problem's complexity level. Neural network architectures can be tuned by hand, but they are tedious and slow. However, neural evolution and automatic machine learning (AutoML) can automatically tune and optimize neural networks for new datasets, allowing for faster transfer learning applications. In Ref [S17], researchers developed a recurent neural network (RNN) for neural architecture search and transfer learning. To achieve the best result for a specific task, its task embedding is fed into the RNN. Afterwards, the RNN predicts the optimal neural network embedding that contains hyperparameters such as the number ofhidden layers, the sizes ofCNN kernels, dropout rates, and the types of activation functions. For solving similar tasks, transfer learning is employed by feeding the closest pre-trained task embedding into the RNN and reloading the RNN's state to that task's solved state. That way, the RNN can learn from previously solved tasks to get the best performance for the current task. In the end, the RNN controller reduced training time and computational resources by utilizing transfer learning.

In Ref [S18], researchers used knee-guided evolutionary algorithm (KGEA) [S23] and evolutionary network pruning for evolving and transferring CNNs. Staffing with a neural network template such as VGG-16 [S24], they transferred some of the layers of VGG-16 to a new network using genotypes and neuron pruning. The genotypes encode the number of CNN layers, the number of dense layers, and the dropout rate.

SUPPLEMENTARY TABLE 1
Feature Comparison of Related Models

| | | Hyper- | | | Physical | Raytraced | Unique |
|---|---|---|---|---|---|---|---|
| | Transfer | parameter | Neural | Sparse | 3D Neuron | Neural | Activation |
| Model | Learning | Tuning | Pruning | Matrices | Positions | Connections | Functions |
| HDNN-TL | Yes | No | No | No | No | No | No |
| [S14] | | | | | | | |
| Sparse | No | No | Yes | Yes | No | No | No |
| Convolutional | | | | | | | |
| Neural | | | | | | | |
| Networks | | | | | | | |
| [S15] | | | | | | | |
| Training | No | No | Yes | Yes | No | No | No |
| Sparse | | | | | | | |
| Neural | | | | | | | |
| Networks | | | | | | | |
| [S16] | | | | | | | |
| Transfer | Yes | Yes | Yes | No | No | No | No |
| Learning | | | | | | | |
| with Neural | | | | | | | |
| AutoML | | | | | | | |
| [S17] | | | | | | | |
| EvoNAS- | Yes | Yes | Yes | No | No | No | No |
| TL [S18] | | | | | | | |
| SaMuNet | No | Yes | Yes | No | No | No | No |
| [S19] | | | | | | | |
| NeuCube | No | Yes | Yes | No | Yes | No | No |
| [S20] | | | | | | | |
| HyperNEA | Yes | Yes | Yes | No | Yes | No | No |
| T [S21] | | | | | | | |
| DES- | Yes | Yes | Yes | No | Yes | No | No |
| HyperNEA- | | | | | | | |
| T [S22] | | | | | | | |
| RayBNN | Yes | Yes | Yes | Yes | Yes | Yes | Yes |

Moreover, the genotypes dictate which layers are discarded, fixed (not trained), and fine-tuned (trained) in the new neural network. In the first stage, KGEA executes a neural architecture search to find the optimal network by continuously evolving the genotypes and selecting the best genotypes with the highest performance-to-network size ratio. For the second stage, neural pruning is activated to disable individual CNN filters and individual neurons in the dense layers. By utilizing transfer learning in neural evolution, it saves training time because the networks are not trained from scratch.

Aside from transfer learning, there are many research articles focusing on neural evolution/AutoML alone. Xue, et al. [S19] created a novel genetic algorithm for evolving CNNs that makes use of candidate offspring generation strategies (COGS). Firstly, a population of random genotypes is created, where each genotype encodes the building blocks of a CNN in sequential order. Each CNN block contains different CNN filters, connection skips, and dropout rates. Secondly, the fittest individuals are bred together, and the mutation operations modify the offspring's genotypes. Afterwards, the best offspring are selected for the next population and the process repeats itself. This evolutionary pressure pushes the population towards the optimal CNN. Thirdly, COGS is used to find the best mutation operations by analyzing which operations produce the fittest individuals. Similar to the above, the best mutation operations generate the next population of mutation operations.

Real BNNs naturally make use of transfer learning to survive changing environments. For example, severed starfish can regrow their limbs and regain control over them, even though many neurons and supporting cells were removed in the process. A person born without any arms can manipulate robotic arms to pick up objects, even though they have never operated an arm before [S25, S26]. There are many classes of ANNs that strive to mimic biological systems. One such class is the spiking neural networks (SNNs) [S27], which achieves the same performance with less computational resources and better power efficiency. SNNs use fixed amplitude Gaussian pulses to communicate between neurons, where the information is encoded in the delay between pulses or the frequency of the pulse train. Moreover, the numerous pulse trains are not guaranteed to reach the receiving neuron at the same time. As a result, the receiving neuron has to store past information in its memory for it to fire at the correct time. Training SNNs requires highly granular time simulations and adjusting the threshold voltages of neurons. In particular, researchers in [S20] created a 3D SNN by arranging neurons in an ordered cube lattice. Short-distance neural connections are generated based on the small-world radius, where every neuron within the radius is sparsely connected as a small-world network [S28]. On the other hand, long-distance connections (LDC) are randomly assigned based on the LDC probability. NeuCube has many applications in precisely modelling EEGs and functional magnetic resonance imaging (fMRI) of human subjects. For the hardware side, SNNs are widely synthesized into application-specific integrated circuits and state-of-the-art neuromorphic hardware. Ref. [S29], showcases a 6-layer spiking CNN with bounded reified linear unit activation function for CIFAR-10 image classification. The design is physically fabricated onto 2 memristive layers, where each layer has a 5×5 grid of memristive cells. Each cell encodes the weight value as the resistance, and they are accessed using bit lines and word lines. The M-SNN achieves 86% training accuracy with 25 pW total power consumption and 200 ps latency.

Compositional pattern-producing networks (CPPNs) [S30, S31] are a class of neural networks that use neuron positions to determine the neural connections and their respective weight values. For example, to find the weight between neuron 0 and neuron 1, neuron 0's position vector [x₀, y₀, z₀] and neuron 1's position vector [x₁, y₁, z₁] are fed into the CPPN. The input positions go through a series of computations based on the CPPN's phenotypes and output the weight value between those neurons. Afterwards, the process is repeated for all combinations of two neurons to get the weight matrices of the neural network. HyperNEAT [S21, S22, S32] algorithms go further by evolving the CPPNs to the optimal configuration using genetic algorithms. When the CPPN changes, its corresponding network structure and the weights change alongside it.

### S.3. Implementation Details of the Proposed ANNs

### S.3.A. CSR Matrices

CSR matrices are used to store the weighted adjacency matrix W because they are space efficient for sparse matrices and are fast for matrix multiplication. Typically, a CSR matrix consists of a nonzero value vector \vec{W}ᵥₐₗᵤₑ ∈ [symbol] ^{N}^{ᵥ}^{×1}, a row index vector \vec{W}_{row} ∈ [symbol] ₀^{(N+1)×1} and a column index vector \vec{W}_{col} ∈ [symbol] ₀^{N}^{ᵥ}^{×1}.

$${\vec{W}}_{value} = [ \begin{matrix}{v}_{0} \\ {v}_{1} \\ ⋮ \\ {v}_{{N}_{v} - 1}\end{matrix} ] , {\vec{W}}_{row} = [ \begin{matrix}{r}_{0} \\ {r}_{1} \\ ⋮ \\ {r}_{N}\end{matrix} ] , {\vec{W}}_{col} = [ \begin{matrix}{c}_{0} \\ {c}_{1} \\ ⋮ \\ {c}_{{N}_{v} - 1}\end{matrix} ] \qquad ( S1 )$$

The row index vector \vec{W}_{row} gives the start index rᵢ and the end index rᵢ₊₁ of a row i that corresponds to a segment on the nonzero value vector \vec{W}ᵥₐₗᵤₑ(rᵢ: rᵢ₊₁−1) and on the column index vector \vec{W}_{col}(rᵢ: rᵢ₊₁−1). Moreover, the nonzero value vector \vec{W}ᵥₐₗᵤₑ stores the values of the nonzero elements, where Nᵥ is the number of nonzero elements. The column index vector \vec{W}_{col} stores the column indexes of the nonzero value vector. While CSR matrices are used for computing forward pass and backward pass, COOrdinate format (COO) matrices are used to add and delete new weights/neural connections.

### S.3.B. COO Matrices

COO matrices are much more efficient than CSR for adding and deleting weights/neural connections because individual weights/neural connections can be manipulated more easily. The main feature in COO matrices is that row indices, column indices, and value vectors have the same dimensions.

$${\vec{W}}_{value} = [ \begin{matrix}{v}_{0} \\ {v}_{1} \\ ⋮ \\ {v}_{{N}_{v} - 1}\end{matrix} ] , {\vec{W}}_{row} = [ \begin{matrix}{r}_{0} \\ {r}_{1} \\ ⋮ \\ {r}_{{N}_{v} - 1}\end{matrix} ] , {\vec{W}}_{col} = [ \begin{matrix}{c}_{0} \\ {c}_{1} \\ ⋮ \\ {c}_{{N}_{v} - 1}\end{matrix} ] \qquad ( S2 )$$

For example, if v₅ representing a neural connection needs to be deleted, then v₅ is removed from \vec{W}ᵥₐₗᵤₑ, r₅ is removed from \vec{W}_{row}, and c₅ is removed from \vec{W}_{col}. In another example, if v₉ representing a brand-new weight needs to be added, then v₉ is inserted into \vec{W}ᵥₐₗᵤₑ after v₈, r₉ is inserted into \vec{W}_{row} after r₈, and c₉ is inserted into \vec{W}_{col} after c₈. If multiple weights/neural connections need to be added, then they are appended to the end and the corresponding vectors are sorted to ensure they have the correct order from v₀,v₁,v₂ to v_{N}_{ᵥ}₋₁.

### S.4. Transfer Learning Network Evolution Animation

An animation [S33] details the transfer learning evolution of the RayBNN on the Alcala dataset, where every λ represents a different training dataset. On the top left, the 3D positions of the cells and the connections between neurons are plotted. On the top right, each neuron's unique UAF is plotted as a function of input. On the bottom left, the weighted adjacency matrix that represents the weights of the neural connections between the neurons is shown. The sparse matrix has bigger dimensions than needed to account for the growth of the neural network. Having a larger sparse matrix does not hurt the performance as the zero elements are not saved or used in the computations. Additionally, some space is also reserved for the input neurons, so there is a space between the two blocks of matrices. On the bottom right, the weighted adjacency graph displays the degree of separation between the neurons.

### S.5. Listing of Supplementary Material

The following materials are hereby incorporated by reference.
[S1] Cooke, S. F., Bliss, T. V.: Plasticity in the human central nervous system. Brain 129(7), 1659-1673 (2006)
[S2] Bartheld, C. S.: Myths and truths about the cellular composition of the human brain: A review of influential concepts. Journal of Chemical Neuroanatomy 93, 2-15 (2018)
[S3] Trevathan, J. K., Yousefi, A., Park, H. O., Bartoletta, J. J., Ludwig, K. A., Lee, K. H., Lujan, J.L.: Computational modeling of neurotransmitter release evoked by electrical stimulation: nonlinear approaches to predicting stimulation-evoked dopamine release. ACS Chemical Neuroscience 8(2), 394-410 (2017)
[S4] Arumugasamy, S. K., Chellasamy, G., Gopi, S., Govindaraju, S., Yun, K.: Current advances in the detection of neurotransmitters by nanomaterials: An update. TrAC Trends in Analytical Chemistry 123, 115766 (2020)
[S5] Fletcher, T. L., De Camilli, P., Banker, G.: Synaptogenesis in hippocampal cultures: evidence indicating that axons and dendrites become competent to form synapses at different stages of neuronal development. Journal of Neuroscience 14(11), 6695-6706 (1994)
[S6] Caminiti, R., Carducci, F., Piervincenzi, C., Battaglia-Mayer, A., Confalone, G., Visco-Comandini, F., Pantano, P., Innocenti, G. M.: Diameter, length, speed, and conduction delay of callosal axons in macaque monkeys and humans: comparing data from histology and magnetic resonance imaging diffusion tractography. Journal of Neuroscience 33(36), 14501-14511 (2013)
[S7] Fiala, J. C., Harris, K. M.: Dendrite structure. Dendrites 2, 1-11 (1999)
[S8] Lewis Jr, T. L., Courchet, J., Polleux, F.: Cellular and molecular mechanisms underlying axon formation, growth, and branching. Journal of Cell Biology 202(6), 837-848 (2013)
[S9] Hawkins, J., Ahmad, S.: Why neurons have thousands of synapses, a theory of sequence memory in neocortex. Frontiers in Neural Circuits 10, 23 (2016)
[S10] Burkitt, A. N.: A review of the integrate-and-fire neuron model: I. Homogeneous synaptic input. Biological Cybernetics 95(1), 1-19 (2006)
[S11] De Vries, G. H., Boullerne, A. I.: Glial cell lines: an overview. Neurochemical Research 35(12), 1978-2000 (2010)
[S12] Ayala, R., Shu, T., Tsai, L.-H.: Trekking across the brain: the journey of neuronal migration. Cell 128(1), 29-43 (2007)
[S13] Herbert, A. L., Monk, K. R.: Advances in myelinating glial cell development. Current Opinion in Neurobiology 42, 53-60 (2017)
[S14] Zhang, R., et al.: Hybrid deep neural network using transfer learning for EEG motor imagery decoding. Biomedical Signal Processing and Control 63, 102144 (2021)
[S15] Liu, B., Wang, M., Foroosh, H., Tappen, M., Pensky, M.: Sparse convolutional neural networks. Proceedings of the IEEE conference on Computer Vision and Pattern Recognition, 806-814 (2015)
[S16] Srinivas, S., Subramanya, A., Venkatesh Babu, R.: Training sparse neural networks. Proceedings of the IEEE Conference on Computer Vision and Pattern Recognition Workshops, 138-145 (2017)
[S17] Wong, C., Houlsby, N., Lu, Y., Gesmundo, A.: Transfer learning with neural AutoML. Advances in Neural Information Processing Systems 31 (2018)
[S18] Wen, Y.-W., Peng, S.-H., Ting, C.-K.: Two-stage evolutionary neural architecture search for transfer learning. IEEE Transactions on Evolutionary Computation 25(5), 928-940 (2021)
[S19] Xue, Y., Wang, Y., Liang, J., Slowik, A.: A self-adaptive mutation neural architecture search algorithm based on blocks. IEEE Computational Intelligence Magazine 16(3), 67-78 (2021)
[S20] Tan, C., Sarlija, M., Kasabov, N.: Spiking neural networks: Background, recent development and the NeuCube architecture. Neural Processing Letters 52(2), 1675-1701 (2020)
[S21]D'Ambrosio, D. B., Gauci, J., Stanley, K. O.: HyperNEAT: The first five years. Growing Adaptive Machines, 159-185 (2014)
[S22] Tenstad, A., Haddow, P. C.: DES-HyperNEAT: Towards multiple substrate deep ANNs. Congress on Evolutionary Computation (CEC), 2195-2202 (2021). IEEE
[S23] Zhou, Y., Yen, G. G., Yi, Z.: A knee-guided evolutionary algorithm for compressing deep neural networks. IEEE Transactions on Cybernetics 51(3), 1626-1638 (2019)
[S24] Simonyan, K., Zisserman, A.: Very deep convolutional networks for large-scale image recognition. arXiv preprint arXiv:1409.1556 (2014)
[S25] Maimon-Mor, R. O., Makin, T. R.: Is an artificial limb embodied as a hand?Brain decoding in prosthetic limb users. PLOS Biology 18(6), 3000729 (2020)
[S26] Meng, J., Zhang, S., Bekyo, A., Olsoe, J., Baxter, B., He, B.: Noninvasive electroencephalogram based control of a robotic arm for reach and grasp tasks. Scientific Reports 6(1), 38565 (2016)
[S27] Tavanaei, A., Ghodrati, M., Kheradpisheh, S. R., Masquelier, T., Maida, A.: Deep learning in spiking neural networks. Neural Networks 111, 47-63 (2019)
[S28] Barrat, A., Weigt, M.: On the properties of small-world network models. The European Physical Journal B-Condensed Matter and Complex Systems 13(3), 547-560 (2000)
[S29] An, H., Al-Mamun, M. S., Orlowski, M. K., Yi, Y.: A three-dimensional (3D) memristive spiking neural network (M-SNN) system. 2021 22nd International Symposium on Quality Electronic Design (ISQED), 337-342 (2021). IEEE
[S30] Stanley, K. O.: Compositional pattern producing networks: A novel abstraction of development. Genetic Programming and Evolvable Machines 8(2), 131-162 (2007)
[S31] Schrum, J., Volz, V., Risi, S.: CPPN2GAN: Combining compositional pattern producing networks and gans for large-scale pattern generation. Proceedings of the 2020 Genetic and Evolutionary Computation Conference, 139-147 (2020)
[S32] Merrild, J., Rasmussen, M. A., Risi, S.: HyperNTM: evolving scalable neural turing machines through HyperNEAT. International Conference on the Applications of Evolutionary Computation, 750-766 (2018). Springer
[S33] Yuen, B., Dong, X., Lu, T.: Supplementary Movie 1 for A 3D Ray Traced Biological Neural Network Learning Model. Nature Communications (2024). Nature Publishing Group. https://static-content.springer.com/esm/art %3A10.1038%2Fs41467-024-48747-7/MediaObjects/41467_2024_48747_MOESM4_ESM.mp4

What is claimed is:

1. A computing system implementing an artificial neural network, the computing system comprising:
a memory in the computing system storing a data structure that defines the artificial neural network in an N-dimensional space, wherein the artificial neural network comprises:
respective spatial coordinates of a plurality of artificial neurons and a plurality of artificial glial cells distributed within the space, wherein the spatial coordinates of the artificial neurons and the artificial glial cells represent non-overlapping spatial positions within the space; and
a plurality of connections between the artificial neurons, wherein the connections are defined by straight-line paths between selected pairs of the artificial neurons within the space, wherein the straight-line paths between the selected pairs are unobstructed by the artificial glial cells, and wherein the artificial neurons of the respective selected pairs are spatially positioned within a specified distance of each other.

2. The computing system of claim 1, wherein the artificial neural network is configured to support dynamic reconfiguration for transfer learning via expansion or contraction of the N-dimensional space and scaling of the spatial coordinates of the artificial neurons and the artificial glial cells in proportion to the expansion or contraction.

3. The computing system of claim 1, wherein the artificial neurons comprise artificial input neurons, artificial output neurons, and artificial hidden neurons.

4. The computing system of claim 3, wherein:
the spatial coordinates of the artificial input neurons represent spatial positions within a first region of the space;
the spatial coordinates of the artificial output neurons represent spatial positions within a second region of the space that is distinct from the first region; and
the spatial coordinates of the artificial hidden neurons and the artificial glial cells represent spatial positions within a third region of the space disposed between the first region and the second region.

5. The computing system of claim 3, wherein:
the spatial coordinates of the artificial input neurons represent spatial positions within an outer region of the space;
the spatial coordinates of the artificial output neurons represent spatial positions within a center region of the space; and
the spatial coordinates of the artificial hidden neurons and the artificial glial cells represent spatial positions within an interior region of the space disposed between the outer region and the center region.

6. The computing system of claim 5, wherein:
the outer region of the space comprises an outer surface of the space; and
the artificial input neurons are positioned to occupy a same solid angle of the outer surface of the space, such that the artificial input neurons can be connected to the artificial hidden neurons in the interior region of the space without bias.

7. The computing system of claim 1, wherein the connections and associated connection weights are encoded in a sparse weighted adjacency matrix stored in the data structure.

8. The computing system of claim 1, wherein the spatial positions represented by the spatial coordinates of the artificial neurons and the artificial glial cells are randomly distributed within the N-dimensional space.

9. The computing system of claim 1, wherein the N-dimensional space comprises a three-dimensional space.

10. The computing system of claim 9, wherein the three-dimensional space comprises a sphere.

11. A computer-implemented method for implementing an artificial neural network, comprising:
storing, in a memory of a computing system, a data structure that defines an artificial neural network in an N-dimensional space;
assigning respective spatial coordinates within the space to a plurality of artificial neurons and a plurality of artificial glial cells of the artificial neural network and storing the spatial coordinates of the artificial neurons and the artificial glial cells in the data structure, wherein the spatial coordinates of the artificial neurons and the artificial glial cells represent non-overlapping spatial positions within the space;
selecting pairs of the artificial neurons to connect, wherein a given pair of the artificial neurons is selected if spatial coordinates of the given pair of the artificial neurons are within a specified distance of one another and if a straight-line path between the given pair of the artificial neurons is not obstructed by any of the artificial glial cells;
forming connections between the selected pairs of the artificial neurons and storing the connections in the data structure; and
training the artificial neural network, wherein training the artificial neural network comprises applying forward propagating signals across the connections in discrete time steps and performing a backpropagation technique using gradient descent.

12. The method of claim 11, further comprising:
performing inference using the trained artificial neural network, wherein performing the inference comprises applying forward propagating signals across the connections in discrete time steps and updating states of the artificial neurons at one or more of the discrete time steps.

13. The method of claim 11, wherein the discrete time steps are synchronous, such that the signals are propagated in synchronous discrete time steps across the artificial neurons.

14. The method of claim 11, wherein:
training the artificial neural network further comprises performing the backpropagation technique using gradient descent to update one or more of connection weights, artificial neuron biases, and trainable parameters of an activation function implemented by the artificial neurons, and
the method further comprises, after training the artificial neural network, performing one or more of the following:
removing any of the connections that have connection weights below a predefined threshold connection weight; or
removing artificial neurons that are not connected to other artificial neurons via the connections.

15. The method of claim 11, further comprising performing transfer learning by reconfiguring the trained artificial neural network, wherein reconfiguring the trained artificial neural network comprises one or more of:
adjusting a quantity of the artificial neurons;
adjusting a quantity of the artificial glial cells;
adjusting a position of one or more of the artificial neurons;
adjusting a position of one or more of the artificial glial cells;
adjusting a density of the artificial neurons;
adjusting a density of the artificial glial cells;
expanding the N-dimensional space and scaling the spatial coordinates of the artificial neurons and the artificial glial cells in proportion to the expansion; or
contracting the N-dimensional space and scaling the spatial coordinates of the artificial neurons and the artificial glial cells in proportion to the contraction.

16. The method of claim 15, wherein the artificial neural network is trained using a first dataset, and wherein the trained artificial neural network is reconfigured to accommodate a second dataset having a different size and/or a different number of dimensions than the first dataset.

17. One or more non-transitory computer-readable media comprising computer-executable instructions that, when executed by a computing system, cause the computing system to perform operations comprising:
storing, in a memory of the computing system, a data structure that defines an artificial neural network in an N-dimensional space;
assigning respective spatial coordinates within the space to a plurality of artificial neurons and a plurality of artificial glial cells of the artificial neural network and storing the spatial coordinates of the artificial neurons and the artificial glial cells in the data structure, wherein the spatial coordinates of the artificial neurons and the artificial glial cells represent non-overlapping spatial positions within the space;
selecting pairs of the artificial neurons to connect, wherein a given pair of the artificial neurons is selected if spatial coordinates of the given pair of the artificial neurons are within a specified distance of each other and if a straight-line path between the given pair of the artificial neurons is not obstructed by any of the artificial glial cells;
forming connections between the selected pairs of the artificial neurons and storing the connections in the data structure;
training the artificial neural network using a first dataset, wherein training the artificial neural network comprises applying forward propagating signals across the connections in discrete time steps and performing a backpropagation technique using gradient descent; and
reconfiguring the artificial neural network to accommodate a second dataset having a different size and/or a different number of dimensions than the first dataset, wherein reconfiguring the artificial neural network comprises one or more of:
adjusting a quantity of the artificial neurons;
adjusting a quantity of the artificial glial cells;
adjusting a position of one or more of the artificial neurons;
adjusting a position of one or more of the artificial glial cells;
adjusting a density of the artificial neurons;
adjusting a density of the artificial glial cells;
expanding the N-dimensional space and scaling the spatial coordinates of the artificial neurons and the artificial glial cells in proportion to the expansion; or
contracting the N-dimensional space and scaling the spatial coordinates of the artificial neurons and the artificial glial cells in proportion to the contraction.

18. The computer-readable media of claim 17, wherein:
the second dataset has a larger size and/or a larger number of dimensions than the first dataset;
the N-dimensional space is expanded to accommodate the second dataset;
reconfiguring the artificial neural network further comprises assigning respective spatial coordinates to additional artificial neurons and additional artificial glial cells within the expanded N-dimensional space; and
the spatial coordinates of the additional artificial neurons and the additional artificial glial cells represent non-overlapping spatial positions within the space.

19. The computer-readable media of claim 17, wherein:
the second dataset comprises a concatenation of the first dataset and additional data; and
reconfiguring the artificial neural network further comprises:
relocating the spatial coordinates of the artificial neurons to a first region of the N-dimensional space while retaining the connections; and
assigning additional artificial neurons to a second region of the N-dimensional space distinct from the first region.

20. The computer-readable media of claim 17, wherein:
the second dataset has a smaller size and/or a smaller number of dimensions than the first dataset;
the N-dimensional space is contracted to accommodate the second dataset; and
reconfiguring the artificial neural network further comprises one or more of:
removing one or more of the artificial neurons;
removing one or more of the artificial glial cells;
removing one or more of the connections based on corresponding connection weights; or
redistributing one or more of the connections to other pairs of the artificial neurons.

21. A method for training live biological neurons to emulate the behavior of a machine learning model, comprising:
delivering training data to a plurality of live biological neurons genetically transfected with light-sensitive opsins, wherein delivering the training data comprises controlling a pixel array to illuminate the live biological neurons with an input light that encodes input features of the training data and model weights of a machine learning model;
detecting outputs of the live biological neurons in response to the input light, wherein detecting the outputs comprises performing ion imaging;
comparing the detected outputs to target outputs using a computing system, wherein the target outputs comprise outputs generated by the machine learning model in response to the training data; and
adjusting one or more parameters of the input light based on results of the comparison to reduce an error between the detected outputs and the target outputs.

22. The method of claim 21, wherein the live biological neurons are genetically transfected with the light-sensitive opsins using optogenetic adeno-associated viruses (AAVs).

23. The method of claim 21, wherein:
performing the ion imaging further comprises measuring and quantifying fluorescence emitted by the live biological neurons;
the fluorescence is produced in response to ion release from the live biological neurons; and
the fluorescence is produced by a biosensor AAV that has been genetically transfected into the live biological neurons or an ion-sensitive fluorescent dye that has been taken up by the live biological neurons.

24. The method of claim 21, wherein the one or more parameters comprise one or more of light intensity, wavelength, and pulse duration, and wherein variations in the one or more parameters encode numerical values of the input features or the model weights.

25. The method of claim 21, wherein training the live biological neurons produces a trained biological neural network that emulates the behavior of the machine learning model, the method further comprising using the trained biological neural network to perform a computational task.

26. The method of claim 25, wherein the machine learning model comprises an artificial neural network defined in a two-dimensional space or a three-dimensional space, and wherein the artificial neural network comprises:
respective spatial coordinates of a plurality of artificial neurons and a plurality of artificial glial cells distributed within the space, wherein the spatial coordinates of the artificial neurons and the artificial glial cells represent non-overlapping spatial positions within the space; and
a plurality of connections between the artificial neurons, wherein the connections are defined by straight-line paths between selected pairs of the artificial neurons within the space, wherein the straight-line paths between the selected pairs are unobstructed by the artificial glial cells, and wherein the artificial neurons of the respective selected pairs are spatially positioned within a specified distance of each other.
